(19) United States
(12) Patent Application Publication
(10) Pub. No.: US 2013/0117105 A1
(43) Pub. Date: May 9, 2013

(54) ANALYZING AND DISTRIBUTING BROWSING FUTURES IN A GESTURE BASED USER INTERFACE

(71) Applicants: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(72) Inventors: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(21) Appl. No.: 13/598,475

(22) Filed: Aug. 29, 2012

Related U.S. Application Data
(63) Continuation-in-part of application No. 13/251,046, filed on Sep. 30, 2011.
Application No. 13/251,046 is a continuation-in-part of application No. 13/269,466, filed on Oct. 7, 2011.
Application No. 13/269,466 is a continuation-in-part of application No. 13/278,680, filed on Oct. 21, 2011.
Application No. 13/278,680 is a continuation-in-part of application No. 13/284,673, filed on Oct. 28, 2011.
Application No. 13/284,673 is a continuation-in-part of application No. 13/284,688, filed on Oct. 28, 2011.
Application No. 13/284,688 is a continuation-in-part of application No. 13/330,371, filed on Dec. 19, 2011.
Application No. 13/330,371 is a continuation-in-part of application No. 13/361,126, filed on Jan. 30, 2012.
Application No. 13/361,126 is a continuation-in-part of application No. 13/595,827, filed on Aug. 27, 2012.

(51) Int. Cl. G06Q 30/02

(52) U.S. Cl. CPC G06Q 30/0251
USPC 705/14.52; 705/14.49; 705/14.53

(57) ABSTRACT

Methods, systems, and techniques for presenting auxiliary content and information regarding browsing and/or navigation futures to be used in a gesture-based user interface are provided. Example embodiments provide a Gesture Based Content Presentation System (GBCPS), which enables a gesture-based user interface to offer to one or more sponsors of content information regarding a next content to be examined by a user related to a portion of electronic input that has been indicated by a received gesture. In overview, the GBCPS allows a portion (e.g., an area, part, etc.) of electronically presented content to be dynamically indicated by a gesture. The GBCPS examines the indicated portion in conjunction with potentially a set of (e.g., one or more) factors to determine a next content and distributes information to potential sponsors. Once auxiliary content is received or determined, it is then presented to the user when the next content is navigated to.

### TECHNICAL FIELD

The present disclosure relates to methods, techniques, and systems for providing a gesture-based system and, in particular, to methods, techniques, and systems for presenting auxiliary content such as advertising based upon gestured input.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 13/251,046, entitled GESTURE BASED NAVIGATION TO AUXILIARY CONTENT, filed 30 Sep. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/269,466, entitled PERSISTENT GESTURELETS, filed 7 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/278,680, entitled GESTURE BASED CONTEXT MENUS, filed 21 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/284,673, entitled GESTURE BASED SEARCH SYSTEM, filed 28 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/284,688, entitled GESTURE BASED NAVIGATION SYSTEM, filed 28 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/330,371, entitled PRESENTING AUXILIARY CONTENT IN A GESTURE-BASED SYSTEM, filed 19 Dec. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/361,126, entitled PRESENTING OPPORTUNITIES FOR COMMERCIALIZATION IN A GESTURE BASED USER INTERFACE, filed 30 Jan. 2012, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/595,827, entitled OFFERING OCCASIONS FOR OPPORTUNITIES FOR COMMERCIALIZATION IN A GESTURE-BASED USER INTERFACE, filed 27 Aug. 2012, which is currently co-pending, or is an application of which a currently co-pending application is entitled to the benefit of the filing date.

### BACKGROUND

As massive amounts of information continue to become progressively more available to users connected via a network, such as the Internet, a company intranet, or a proprietary network, it is becoming increasingly more difficult for a user to find particular information that is relevant, such as for a task, information discovery, or for some other purpose. Typically, a user invokes one or more search engines and provides them with keywords that are meant to cause the search engine to return results that are relevant because they contain the same or similar keywords to the ones submitted by the user. Often, the user iterates using this process until he or she believes that the results returned are sufficiently close to what is desired. The better the user understands or knows what he or she is looking for, often the more relevant the results. Thus, such tools can often be frustrating when employed for information discovery where the user may or may not know much about the topic at hand.

Different search engines and search technology have been developed to increase the precision and correctness of search results returned, including arming such tools with the ability to add useful additional search terms (e.g., synonyms), rephrase queries, and take into account document related information such as whether a user-specified keyword appears in a particular position in a document. In addition, search engines that utilize natural language processing capabilities have been developed.

In addition, it has becoming increasingly more difficult for a user to navigate the information and remember what information was visited, even if the user knows what he or she is looking for. Although bookmarks available in some client applications (such as a web browser) provide an easy way for a user to return to a known location (e.g., web page), they do not provide a dynamic memory that assists a user from going from one display or document to another, and then to another. Some applications provide “hyperlinks,” which are cross-references to other information, typically a document or a portion of a document. These hyperlink cross-references are typically selectable, and when selected by a user (such as by using an input device such as a mouse, pointer, pen device, etc.), result in the other information being displayed to the user. For example, a user running a web browser that communicates via the World Wide Web network may select a hyperlink displayed on a web page to navigate to another page encoded by the hyperlink. Hyperlinks are typically placed into a document by the document author or creator, and, in any case, are embedded into the electronic representation of the document. When the location of the other information changes, the hyperlink is “broken” until it is updated and/or replaced. In some systems, users can also create such links in a document, which are then stored as part of the document representation.

Even with advancements, searching, navigating, and presenting the morass of information is oft times still a frustrating user experience.

### BRIEF DESCRIPTION OF THE DRAWINGS

FIG. 1A is a screen display of example gesture based input identifying an entity and/or an action performed by an example Gesture Based Content Presentation System (GBCPS) or process.

FIG. 1B is a screen display of a presentation of example gesture based auxiliary content determined by an example Gesture Based Content Presentation System or process.

FIG. 1C is a screen display of an animated overlay presentation as shown over time of an example gesture based auxiliary content determined by an example Gesture Based Content Presentation System or process.

FIGS. 1D1-1D8 are example screen displays of a sliding pane overlay sequence shown over time for presenting auxiliary content by an example Gesture Based Content Presentation System or process.

FIGS. 1E1-1E2 are example screen displays of a shared presentation construct for presenting auxiliary content by an example Gesture Based Content Presentation System or process.

FIG. 1F is an example screen display of a separate presentation construct for presenting auxiliary content by an example Gesture Based Content Presentation System or process.

FIG. 1G is a block diagram of an example environment for presenting auxiliary content using an example Gesture Based Content Presentation System or process.

FIG. 2 is an example block diagram of components of an example Gesture Based Content Presentation System.

FIG. 3.1-3.108 are example flow diagrams of example logic for processes for presenting auxiliary content based upon gestured input as performed by example embodiments.

FIG. 4 is an example block diagram of a computing system for practicing embodiments of a Gesture Based Content Presentation System.

### DETAILED DESCRIPTION

Embodiments described herein provide enhanced computer- and network-based methods, techniques, and systems for analyzing and distributing information regarding browsing futures in a gesture based input system. Browsing futures include the prediction, analysis, and/or statistical likelihood that a user will navigate, explore, examine, or browse to a particular location (e.g., website, document, page, presentation, and the like). Example embodiments provide a Gesture Based Content Presentation System (GBCPS), which enables a gesture-based user interface to determine (e.g., find, locate, generate, designate, define, predict, or cause to be found, located, generated, designated, defined, predicted or the like) the next content a user is likely to examine (e.g., the next website page, data, code, image, text, etc.) that the user is likely to navigate to (e.g., explore, browse, etc.) based upon the user's gestured input and possibly other information, such as context, past history, similarity to actions by other users, and the like. The GBCPS then disseminates (e.g., distributes, forwards, sends, communicates) information regarding the likely (e.g., predicted) next content to be examined to various sponsors of content (such as publishers, advertisers, web portal owners, and the like) so that they can provide auxiliary (e.g., supplemental additional etc.) content that relates to the likely next content. This auxiliary content is then presented (e.g., displayed, played sound for, drawn, and the like) as appropriate when the GBCPS detects that the user has actually navigated to the predicted next content.

Auxiliary content may include any type of content that relates to the gestured input. Content may include, for example, a word, phrase, spoken utterance, image, video, pattern, and/or other audio signal. It may provide future interesting information, locations to visit (physically or virtually), advertisements, and the like. In some examples, the auxiliary content relates to an opportunity for commercialization so that content such as advertisements can be targeted to the predicted next content. The distributed information provided to the sponsors allows the auxiliary content (e.g., the opportunity to commercialization) to take into account aspects that truly target the content to the user, the context, the next context, or other characteristics of the situation. For example, if the user has gestured a pair of skis, then the GBCPS can predict, for example, the statistical likelihood based upon similar users in similar situations, overall behavior of the system, the user's social network, etc. what the next likely website the user would navigate to—say a buyer's comparison website or a portal where many brands are available with the desire to research buying a pair of skis. A sponsor that publishes the website “evo.com” may desire to put up an advertisement showing the different skis relevant to what it knows about the user (such as gender, geographic location, etc.) so that ads for relevant skis can be shown to the user.

An opportunity for commercialization may include any kind of opportunity, including, for example, different types of advertising, interactive computing games and/or entertainment that may result in a purchase or offer for purchase, bids, bets, competitions, and the like. The content associated with an opportunity for commercialization may include any type of content including, for example, text, images, sound, or the like. Further, the content may be provided by any sponsor of the opportunity for commercialization such as an advertiser, a manufacturer, a publisher, etc. Also, the content may be provided directly or indirectly; for example, sponsor supplied content may be provided by a third party to the sponsor such as from an ad server, a third party with specific user, demographic, or contextual knowledge, and/or another sponsor. In addition, the sponsor may be the same as the publisher of the original presented content where the gestured input was made.

For example, if a user is currently browsing a replay of a sports event such as the Olympic games, and suddenly gestures to a pair of shoes that a winning athlete is sporting, then the GBCPS can distribute the information (after analyzing to determine the next predicted content) to one or more sponsors that can or would like to present a (hopefully) relevant opportunity for commercialization. For example, the GBCPS may determine that the next likely website the user would visit is Nike because it is a sponsor of the Olympic games. The GBCPS may then distribute (in near real time, for example) this information to Nike, or pull prior information from Nike stored in a library for presentation at this point, so that Nike can provide all kinds of additional interesting information such as other environments and uses for the shoes that may be attractive to that particular user. Because the information from Nike is being presented in a known particularly relevant context, the GBCPS can charge accordingly. Charging may be in forms other than money, such as trades for future time, etc.

As stated, the GBCPS allows a portion (e.g., an area, part, or the like) of electronically presented content to be dynamically indicated by a gesture. The gesture may be provided in the form of some type of pointer, for example, a mouse, a touch sensitive display, a wireless device, a human body part, a microphone, a stylus, and/or a pointer that indicates a word, phrase, icon, image, or video, or may be provided in audio form. In some embodiments the indicated portion represents (e.g., indicates, displays, presents, etc.) a product and/or service that a user is observing (e.g., viewing, hearing, realizing, etc.). The GBCPS then examines the indicated portion and potentially a set of (e.g., one or more) factors to determine the next content that the user is likely to browse, examine, explore, navigate to, etc.

The GBCPS may determine the next content to be examined in a variety of manners. For example, using statistical modeling, prediction, analysis, Bayesian networks, etc., the GBCPS can analyze where the user is next likely to navigate to in the system. This may also involve taking into account other users with similar behaviors, for example other users with similar prior navigation histories, purchase histories or the like or may take into account the browsing, purchasing or other behaviors of users within the user's known social networks. Any type of collaborative filtering may be employed.

In other examples, the GBCPS needs to disambiguate what the user is trying to do. For example, it may not be clear from a gesture what the user is actually trying to explore. The user's prior navigation history may be used disambiguate between possible products and/or services indicated by a gesture. For example, a gesture of a particular model of truck may not convey whether opportunities for commercialization are more appropriately targeted to trucks generally, other truck models, or parts for that particular truck. However, in combination with the user's prior navigation history, the GBCPS may be able to determine that the user has been looking for automotive parts by the time the user performs a gesture and thereafter offer occasions for opportunities for commercialization that are related to automotive part for that model truck (e.g., advertisements for truck parts for that model.)

The determination of the next content to be examined is based upon content contained in (e.g., entity or action identified by) the portion of the presented electronic content indicated by the gestured input as well as possibly one or more of a set of factors. Content may include, for example, a word, phrase, spoken utterance, image, video, pattern, and/or other audio signal. Also, the portion may be formed from contiguous or composed of separate non-contiguous parts, for example, a title with a disconnected sentence. In addition, the indicated portion may represent the entire body of electronic content presented to the user. For the purposes described herein, the electronic content may comprise any type of content that can be presented for gestured input, including, for example, text, a document, music, a video, an image, a sound, or the like.

As stated, the GBCPS may incorporate information from a set of factors (e.g., criteria, state, influencers, things, features, and the like) in addition to the content contained in the indicated portion to determine a next content to be examined by the user. The set of factors may include such things as context surrounding or otherwise relating to the indicated portion (as indicated by the gesture), such as other text, audio, graphics, and/or objects within the presented electronic content; some attribute of the gesture itself, such as size, direction, color, how the gesture is steered (e.g., smudged, nudged, adjusted, and the like); presentation device capabilities, for example, the size of the presentation device, whether text or audio is being presented; prior device communication history, such as what other devices have recently been used by this user or to which other devices the user has been connected; time of day; and/or prior history associated with the user, such as prior search history, navigation history, purchase history, and/or demographic information (e.g., age, gender, location, contact information, or the like). For example, the set of factors may indicate that the user is Japanese and so would prefer an auxiliary content targeted to a Japanese product or culture, such as an advertisement for a Japanese beer. In addition, information from a context menu, such as a selection of a menu item by the user, may be used to assist the GBCPS in determining a next content to be examined.

The ability to use the context of the gesture, aspects of the gesture itself, and/or other factors to determine the next content to be examined by the user can result in more targeted types of opportunities, more clearly associated with the intended product and/or service indicated by the gestured input. Accordingly, search engines, advertising agencies, third party advertising servers, and/or publishers of content can potentially provide better pricing structures, for example, for opportunities for commercialization (such as advertisements), since they will be able to better predict content targeted to the user in the particular presentation context.

Once the next content to be examined by the user is determined, the GBCPS can distribute (e.g., send, communicate, forward, push, etc.) information to one or more sponsors of auxiliary content that may be interested in the information to supply auxiliary content. The information may include any kind of representation of data regarding the gestured input, its identified entity(ies) or action(s), or available context. For example, the GBCPS may communicate to one or more sponsors that are somehow related to what the user gestured that the user is female, accessing a computer from the Northwest, and is looking for information regarding shoes. Sponsors such as an outdoors supplier may wish to know this in order to provide potentially both information on shoes and various places to visit to use them.

The GBCPS then receives auxiliary content (which may be an opportunity for commercialization or some kind of supplement content) from one or more of these sponsors. Note that receipt of the auxiliary may occur before the relevant gestured input and stored in, for example, a library of possible auxiliary content for the GBCPS to use when and if the associated entity or action is gestured. Alternatively, the action or action may be gestured first and the GBCPS engaged in obtaining auxiliary content in near real-time to sponsors who wish to “compete” for the opportunity to present.

Once the GBCPS detects that the user has navigated to the determined next content, then the GBCPS presents the received auxiliary content from one or more of the sponsors on a presentation device (e.g., a display, a speaker, electronic reader, or other output device). For example, if the GBCPS has received auxiliary content corresponding to an indicated (e.g., gestured) portion, then the advertisement may be presented to the user (textually, visually, and/or via audio) instead of or in conjunction with the already presented content—the representation of the product and/or service. Presenting the auxiliary content may also involve “navigating,” such as by changing the user's focus to new content indicated by the received auxiliary content. The received auxiliary content may be represented by anything, including, for example, a web page, computer code, electronic document, electronic version of a paper document, a purchase or an offer to purchase a product or service, social networking content, and/or the like. The “auxiliary” content is auxiliary in that it is additional, supplemental, or somehow related to what has been gestured by the user and/or the next predicted content.

In some embodiments the received auxiliary content may be provided by entities other that those responsible for initially presenting the indicated product and/or service. This may allow, for example, competitors to present competing opportunities for commercialization or supplement content such as competing advertisements for a gestured indicated product and/or service when the underlying presented content is published by an entity that also sponsors the indicated product and/or service. In some scenarios, the indicated gestured portion is represented by a persistent data structure such as a URL (e.g., a gesturelet) and this gesturelet may be associated with one or more opportunities for commercialization through a purchase process analogous to techniques used to bid on or purchase keywords from search engines. Instead, entities may purchase and/or bid on gesturelets in order to associate the intended opportunity for commercialization (e.g., an advertisement of a product attributable to the entity) with a gestured representation of a product. In addition, in some embodiments, the original presenter of the indicated product and/or service (e.g., the publisher) may be given an opportunity to “counter-bid” on the gesturelet to insure that no competing opportunities for commercialization are presented. Other bidding and/or purchase arrangements are possible.

The determined auxiliary content may be presented to the user in conjunction with an identified entity such as a product and/or service, for example, by use of an overlay; in a separate presentation element (e.g., window, pane, frame, or other construct) such as a window juxtaposed to (e.g., next to, contiguous with, nearly up against) the presented electronic content; and/or, as an animation, for example, a pane that slides in to partially or totally obscure the presented electronic content. With animated presentations, artifacts of the movement may be also presented on the screen (e.g., window or object borders that appear to move, flashing text or images, or the like). In some examples, separate presentation constructs (e.g., windows, panes, frames, etc.) are used, each for some purpose, e.g., one presentation construct for the presented electronic content containing the indicated portion, another presentation construct for advertising or other opportunities for commercialization from the publisher of the presented electronic content, and another presentation construct for competing advertisements or other opportunities for commercialization, such as presenting information on better, faster, or cheaper opportunities. In some examples, a user may opt in or out of receiving the advertising and fewer presentation constructs may be presented. Other methods of presenting the auxiliary content and layouts are contemplated.

### Gesture Based Content Presentation System Overview

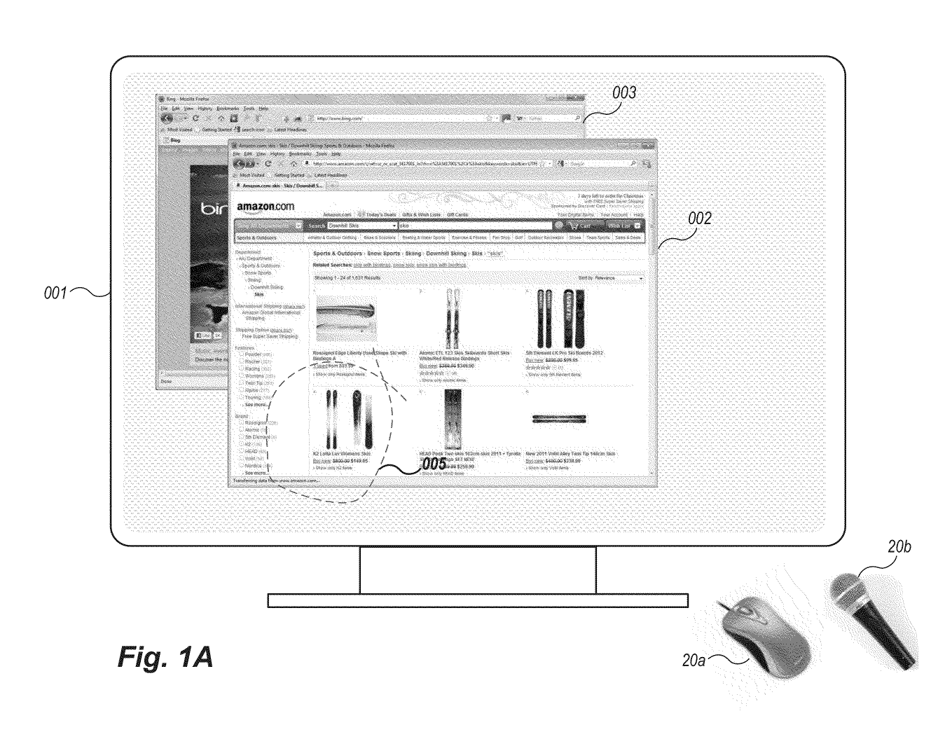

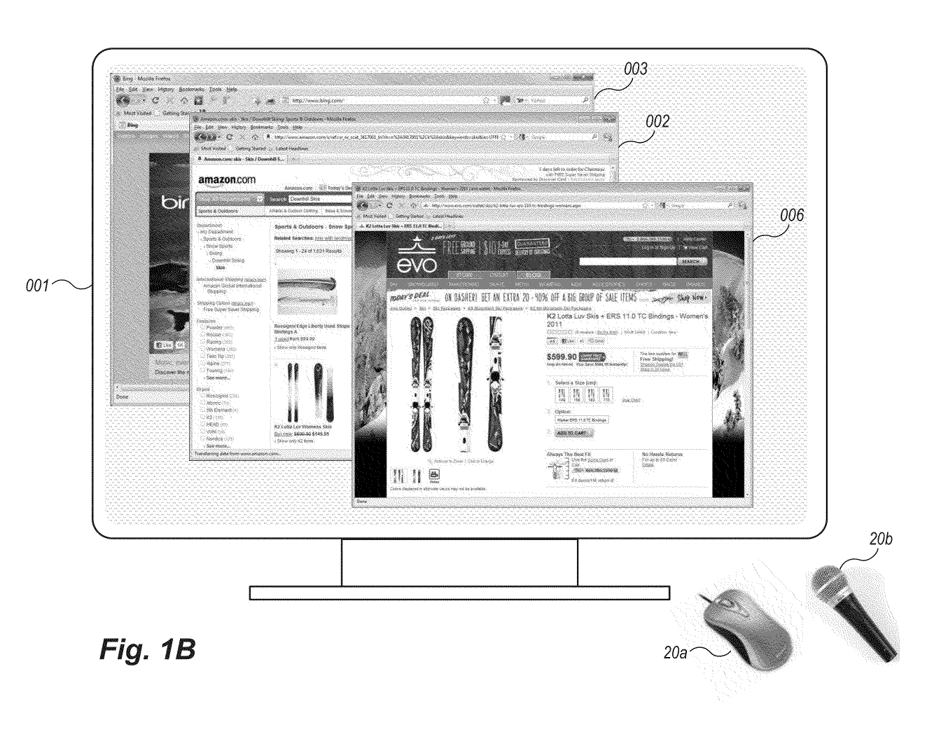

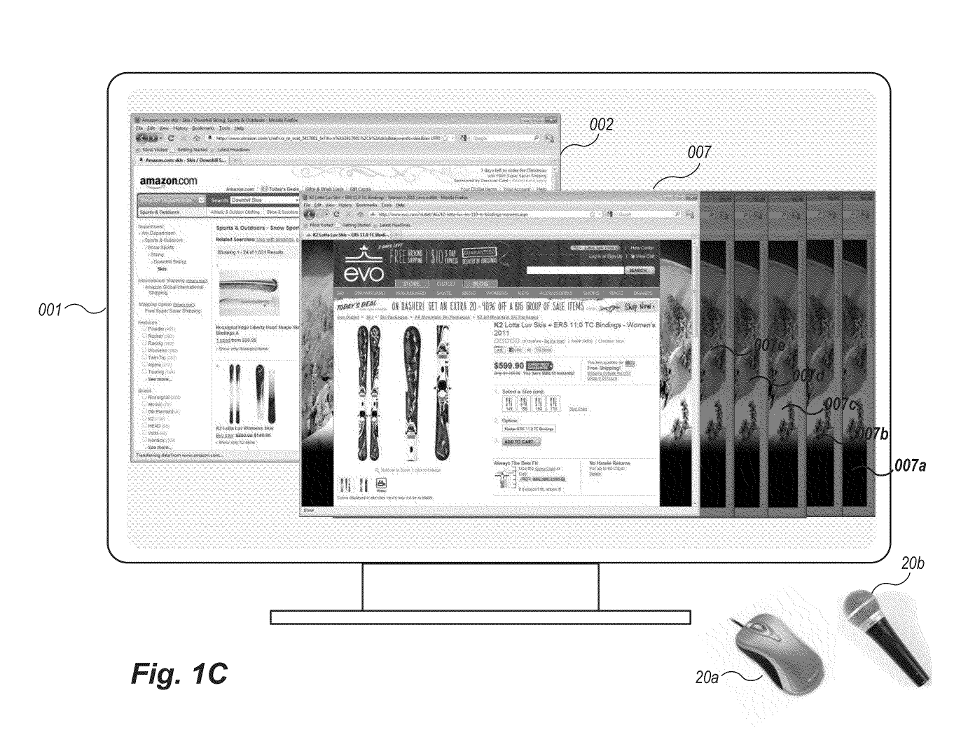

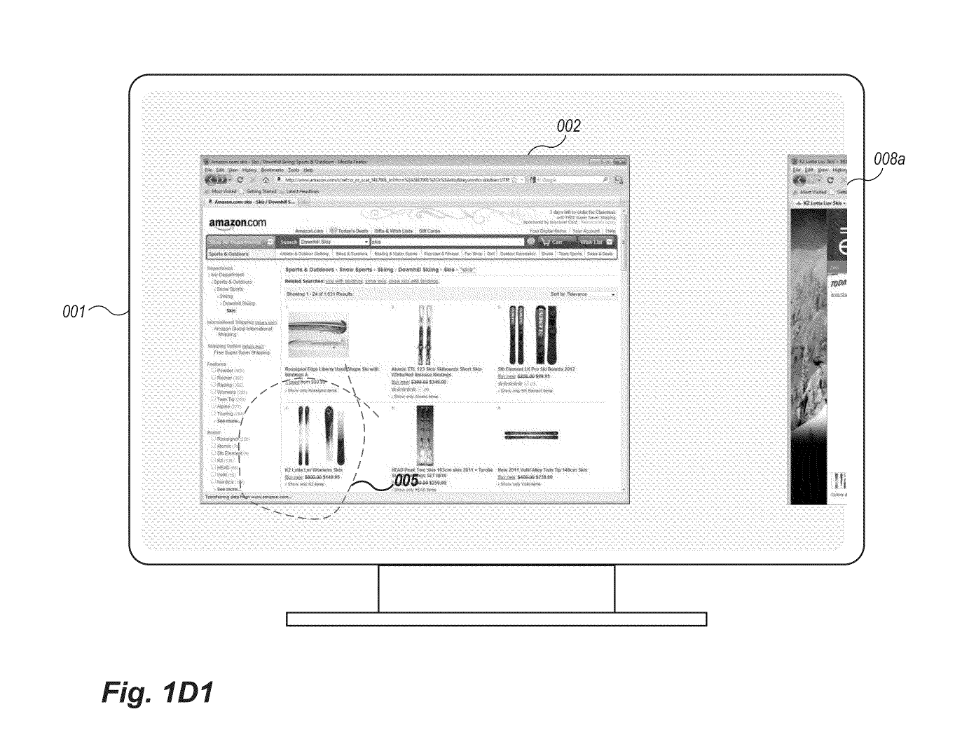

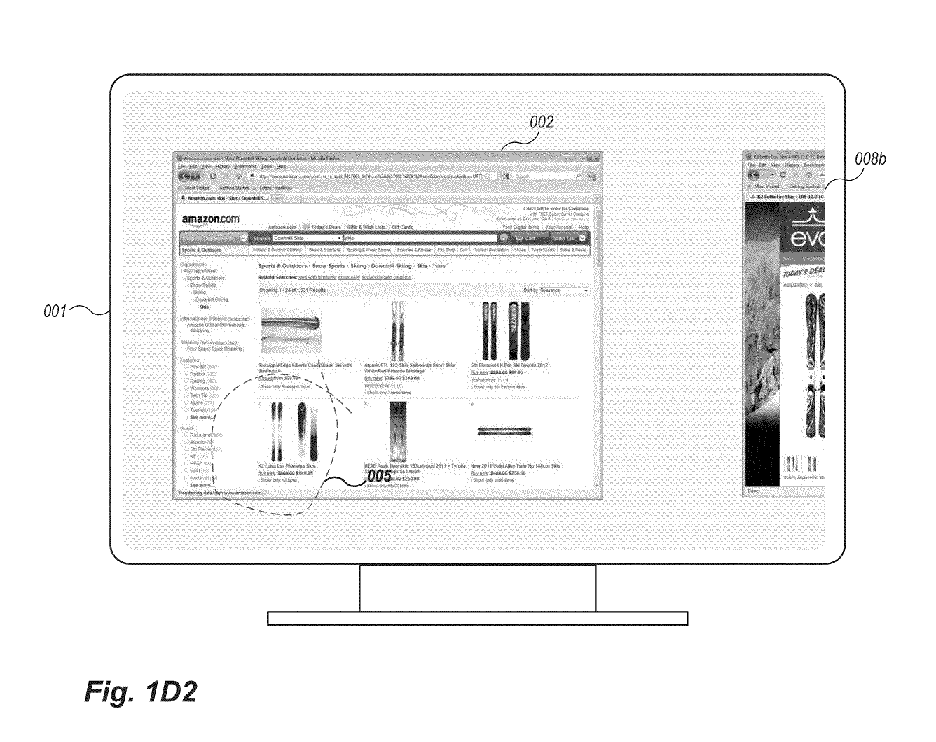

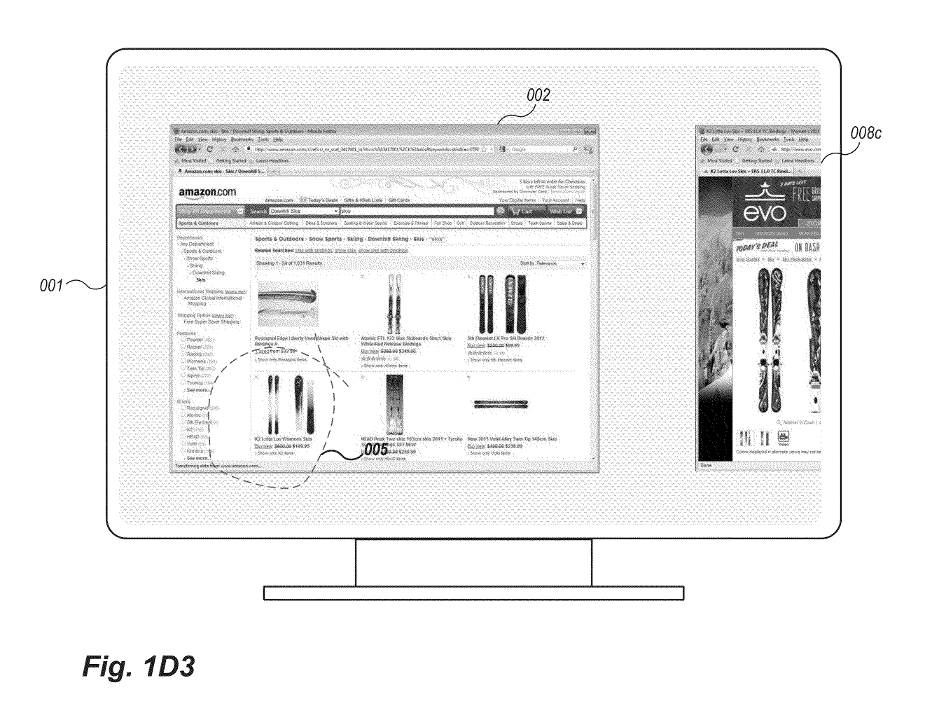

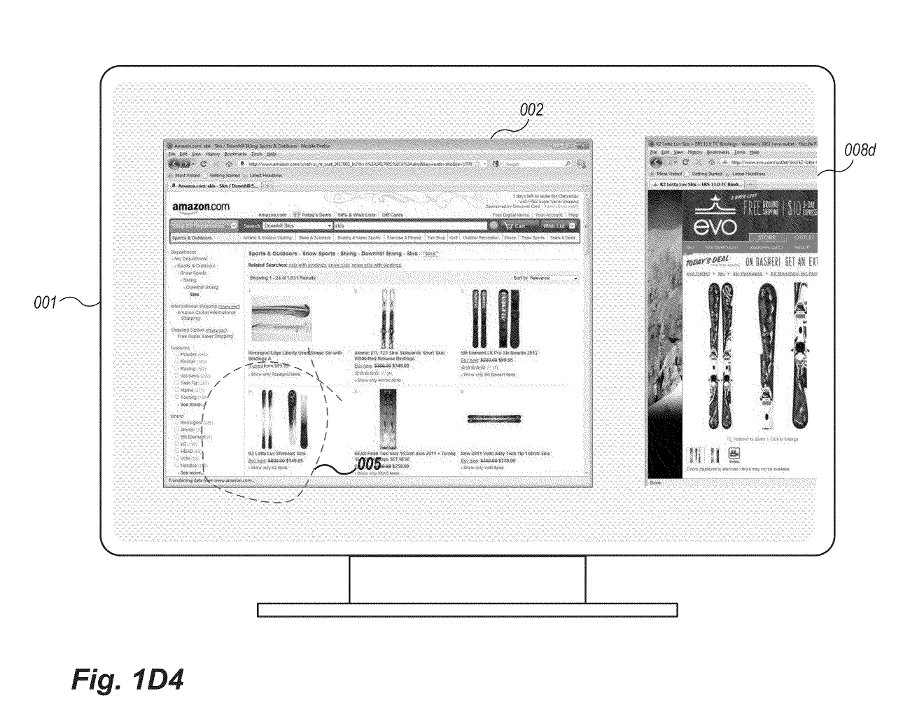

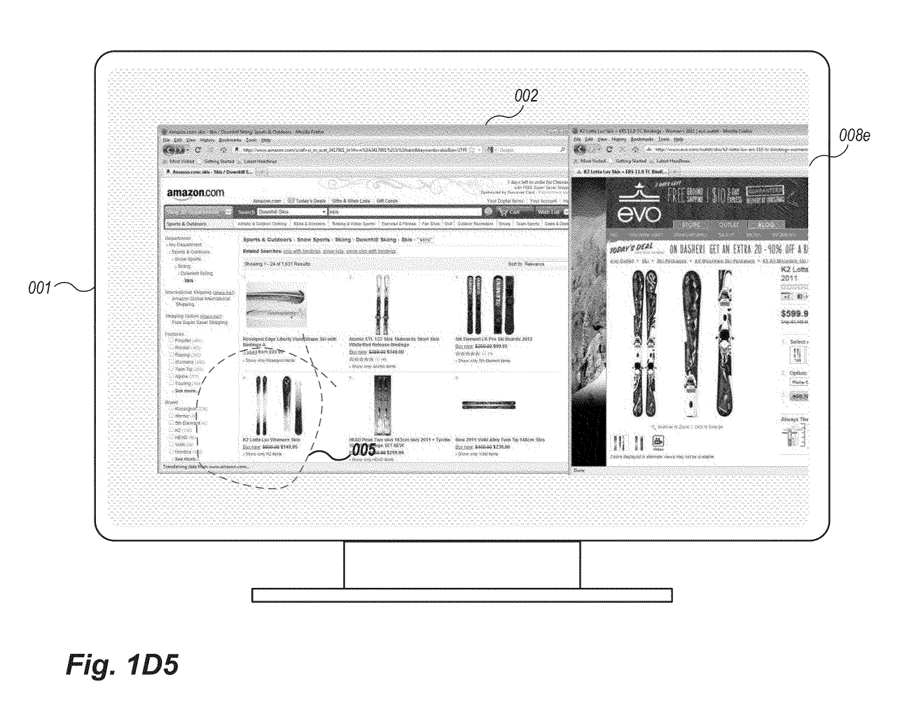

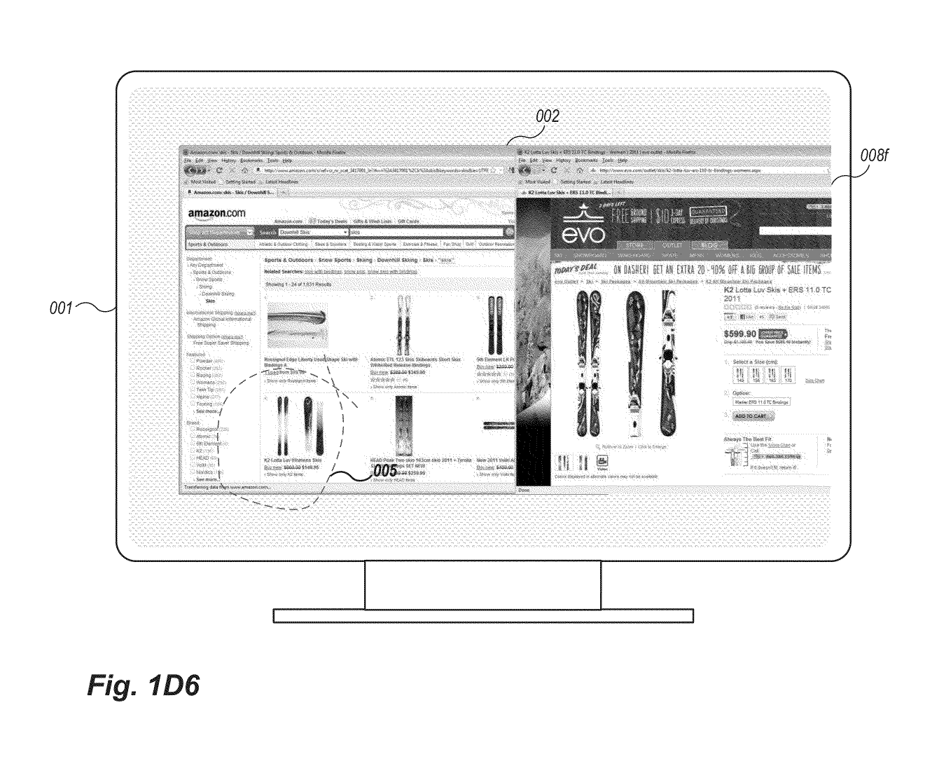

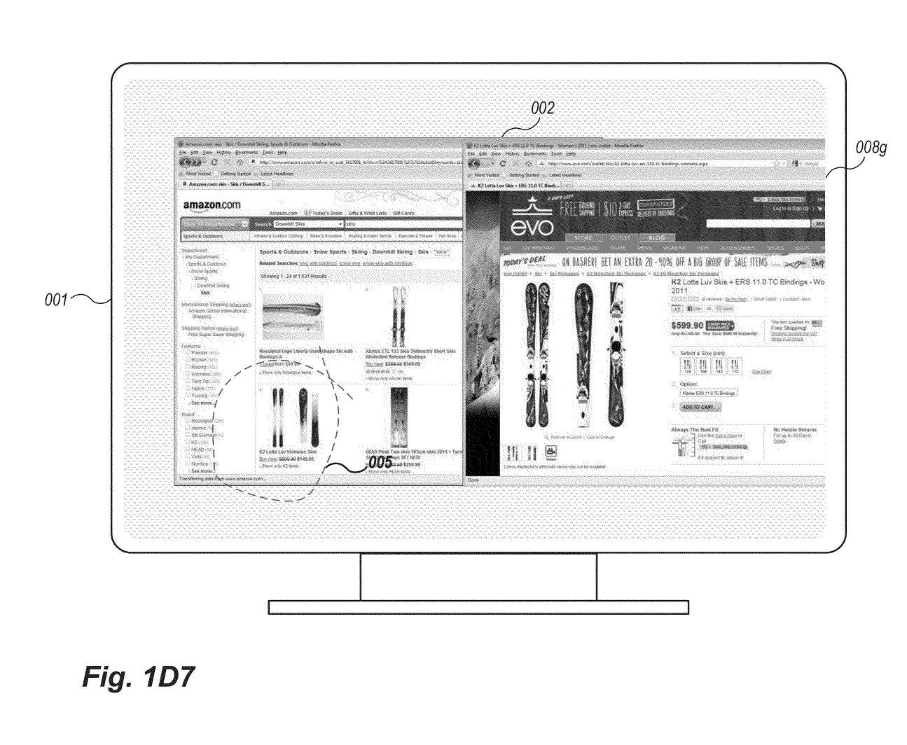

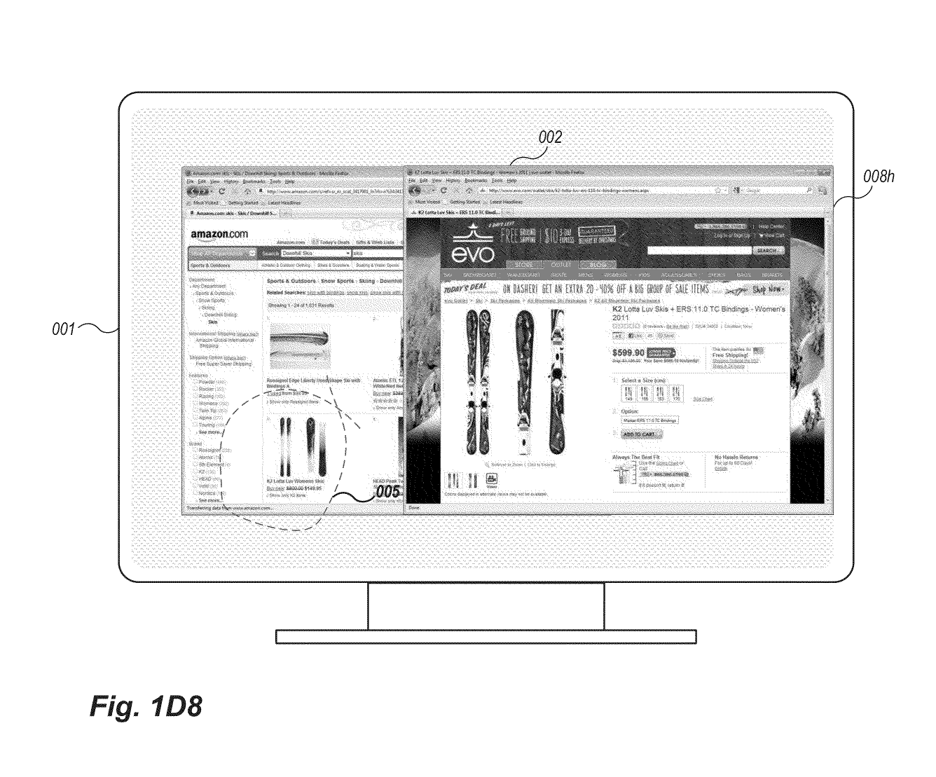

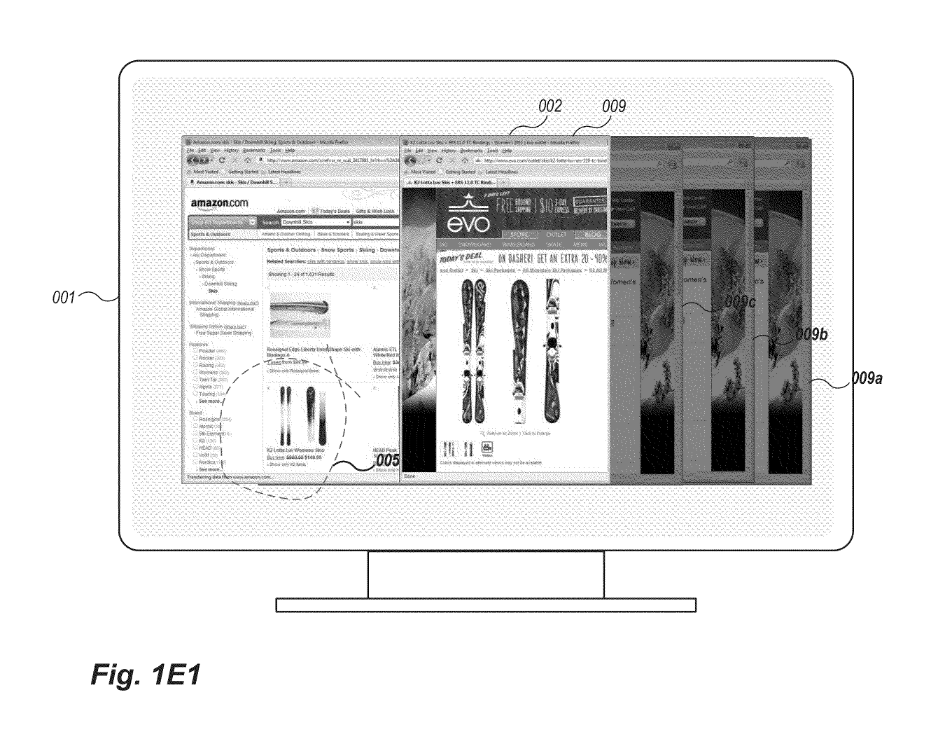

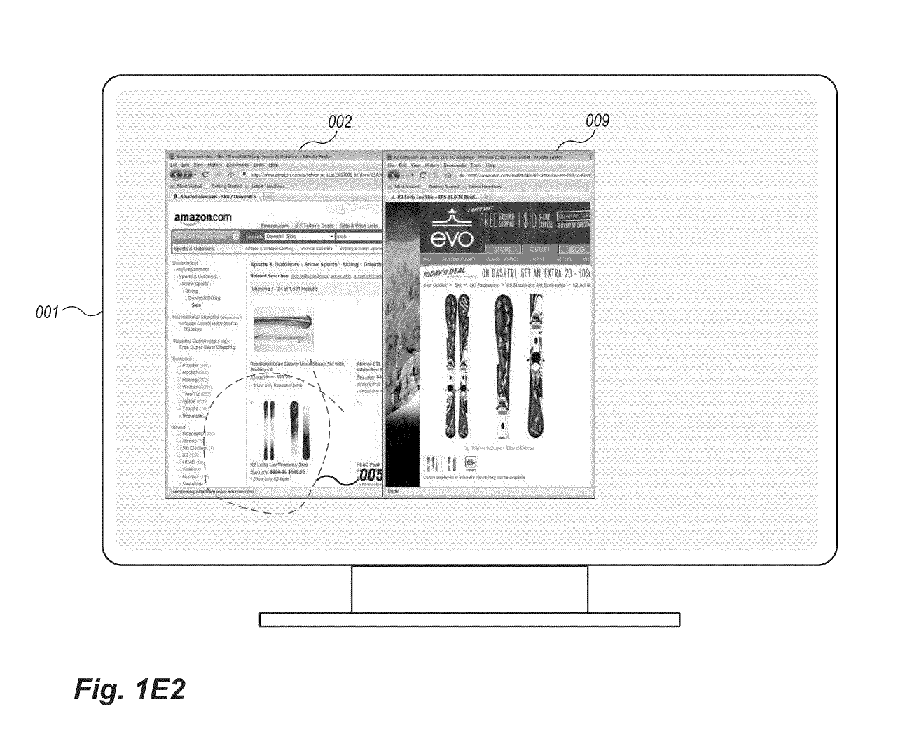

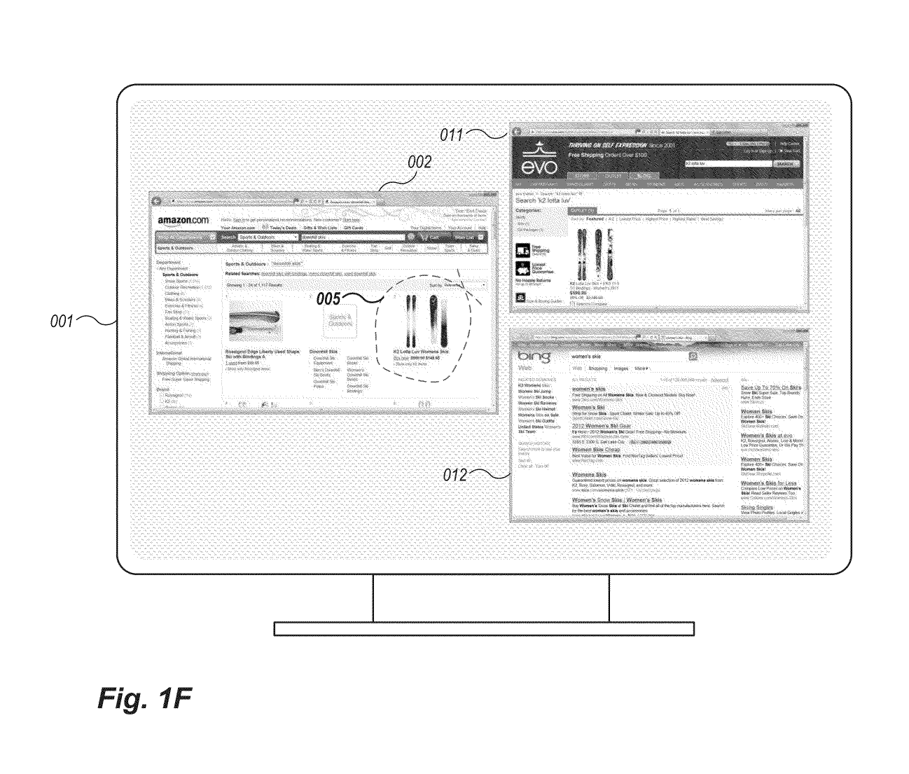

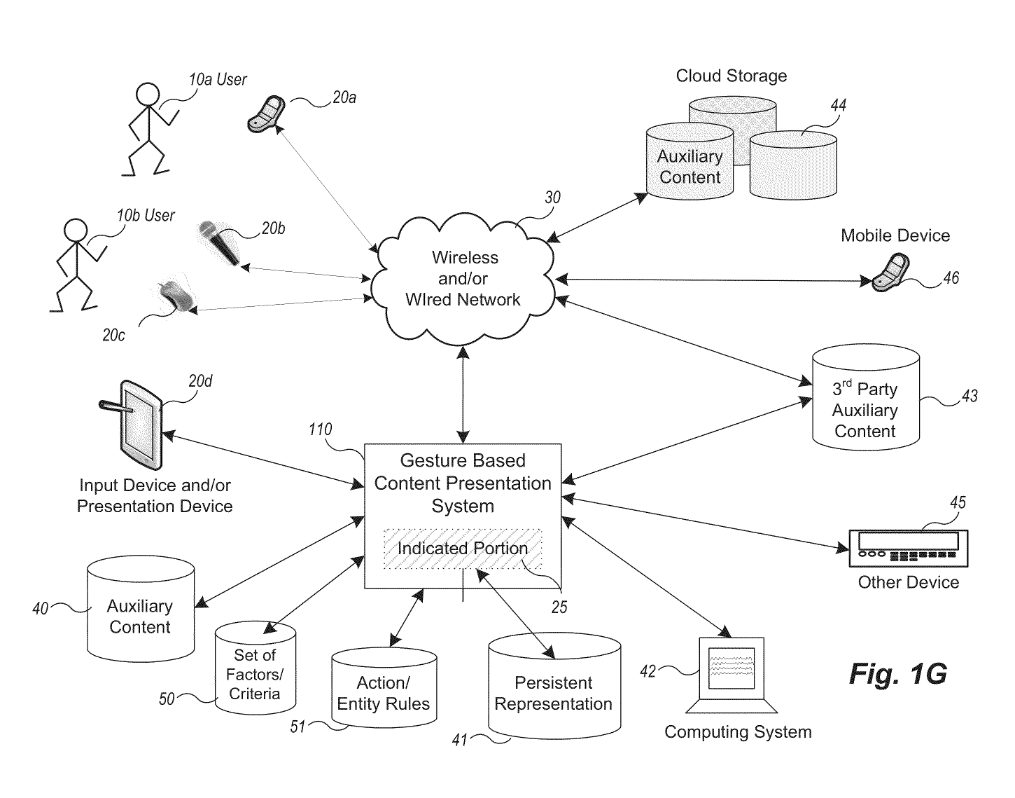

FIG. 1A is a screen display of example gesture based input identifying a product and/or service performed by an example Gesture Based Content Presentation System (GBCPS) or process. In FIG. 1A, a presentation device, such as computer display screen 001, is shown presenting two windows with electronic content, window 002 and window 003. The user (not shown) utilizes an input device, such as mouse 20a and/or a microphone 20b, electronic display or appliance (not shown), to indicate a gesture (e.g., gesture 005) to the GBCPS. The GBCPS, as will be described in detail elsewhere herein, determines to which portion of the electronic content displayed in window 002 the gesture 005 corresponds, potentially including what type of gesture. In the example illustrated, gesture 005 was created using the mouse device 20a and represents a closed path (shown in red) that is not quite a circle or oval that indicates that the user is interested in the entity representing “K2 Lotta Luv Womens' skis,” a representation of a product published by the website “Amazon.com.” The gesture may be a circle, oval, closed path, polygon, or essentially any other shape recognizable by the GBCPS. The gesture may indicate content that is contiguous or non-contiguous. Audio may also be used to indicate some area of the presented content, such as by using an uttered word, phrase, sound, and/or direction (e.g., command, order, directional command, or the like). Other embodiments provide additional ways to indicate input by means of a gesture. The GBCPS can be fitted to incorporate any technique for providing a gesture that indicates some area or portion (including any or all) of the presented content. In some embodiments, the GBCPS highlights or otherwise demarcates the text and/or image and/or action to which gesture 005 is determined to correspond.

In the example illustrated, the GBCPS determines from the indicated portion (the representation of the product and/or offer) and one or more factors, such as the user's prior navigation history, that the user may be interested in more detailed information or purchasing the product represented by the indicated portion. In this case, the GBCPS determines presenting advertisements on ski related products is likely appropriate and distributes information about a user's next content to be examined to that third parties, such as “evo.com.” In other examples, different ways to determine to whom to distribute information about the next content are accommodated, including bidding dynamically, in advance, using an advertising server such as a third party advertising server, through competitions, by the publisher itself (in this case Amazon.com”), and/or the like. In this example, the GBCPS determines that the user typically wants to see an advertisement when a product is displayed and accordingly distributes information to suppliers of relevant commercialization opportunities.

Using a set of factors associated with the user, the content, the input device, the presentation device, or the like, the GBCPS can determine whether the user would prefer certain types of advertisements to be presented when the example gesture 005 is determined. For example, the user may be more interested in similar skis, better prices for this exact pair of skis, bindings for these skis, etc. The more the GBCPS can determine relevant advertisements or other opportunities for commercialization, the more likely the user can engage in a rewarding experience and the more likely the opportunity for commercialization will be successful.

FIG. 1B is a screen display of a presentation of example gesture based auxiliary content determined by an example Gesture Based Content Presentation System or process. In this example, the auxiliary content is an opportunity for commercialization, an advertisement, from “evo.com” presented on the web page 006 for the same skis originally presented in window 002. This content is shown as an overlay 006 over at least one of the windows 002 on the presentation device 001 that contains the represented product and/or service from the presented electronic content upon which the gesture was indicated.

For the purposes of this description, an “entity” is any person, organization, place, or thing, or a representative of the same, such as by an icon, image, video, utterance, etc. An “action” is something that can be performed, for example, as represented by a verb, an icon, an utterance, or the like.

The opportunity for commercialization presented on web page 006 may be presented in ways other than as a single overlay over window 002. For example, FIG. 1C is a screen display of an animated overlay presentation as shown over time of an example gesture based auxiliary content determined by an example Gesture Based Content Presentation System or process. In FIG. 1C, the same web page 007 is shown coming into view over time as an overlay using animation techniques. According to this presentation, the windows 007a-007f are intended to show the window 007 as would be presented in prior moments in time as the window 007 is brought into focus from the right side of presentation screen 001. For example, the window in position 007a moves to the position 007b, then 007c, and the like, until the window reaches its desired position as shown as window 007. In the example shown, a shadow of the window continues to be displayed as an artifact on the screen at each position 007a-007f, however this is not necessary and in other examples no artifacts may remain. The artifacts (e.g., window shadows) may be helpful to the user in perceiving the animation.

FIGS. 1D1-1D8 are example screen displays of a sliding pane overlay sequence shown over time for presenting auxiliary content by an example Gesture Based Content Presentation System. They illustrate an animation for presenting auxiliary content over time (here an advertisement) as sliding in from the side of the presentation screen 001 (here from the right hand side) until the window with the auxiliary content reaches its destination (as window 008h) as an overlay on top of the presented electronic content in window 002. As time progresses from earliest to latest, as shown from FIG. 1D1 in sequence to 1D8, the window 008x(where x is a-h) moves closer and closer onto the presented content where the gesture was made. Eventually, the auxiliary content in window 008f-008h is shown covering up more and more of the gestured portion. In other examples, when the pane slides in from the side of the screen, the portion of the electronic content in window 002 indicating the gestured portion (as shown by gesture 005) always remains visible. Sometimes this is accomplished by not moving the presentation construct with the auxiliary content as far over the presentation of the gestured portion. In other instances, the window 002 is readjusted (e.g., scrolled, the content repositioned, etc.) to maintain both display of the gestured portion and the auxiliary content. Other animations and non-animations of presenting auxiliary content using overlays and/or additional presentation constructs are possible.

FIGS. 1E1-1E2 are example screen displays of a shared presentation construct for presenting auxiliary content by an example Gesture Based Content Presentation System or process. In this example, as the presentation construct 009 with auxiliary content is moved onto the presentation construct 002 that presents the gestured input over time (sequence of constructs 009a-009c), the construct 009 is readjusted so that it is (e.g., fully or mostly) contained in the presentation construct 002 as illustrated in FIG. 1E2. In the example shown, the presentation construct 002 is effectively “split” (evenly or not) between the originally published content containing the gesture in window 002 and the auxiliary content in window 009. Other examples may split the real estate differently between, for example, an advertisement for a product and the representation of the product. Also, in some examples, artifacts from the presentation constructs (here windows 009a-009c in FIG. 1E1) are shown and in others they are not (for example, in FIG. 1E2).

FIG. 1F is an example screen display of a separate presentation construct for presenting auxiliary content by an example Gesture Based Content Presentation System or process. In this example, the auxiliary content is shown in a presentation construct 011 separate from the published content containing the gesture in window 002. An additional presentation construct 012 may be available to present further opportunities for commercialization or supplemental information. In some examples, one or more of the presentation constructs 002, 011, and 012 are adjacent to one another (not shown). In others, as shown in FIG. 1F they are separated.

In one such example, a presentation construct such as window 011 is reserved for advertisements of products and/or services that are indicated by gestures to enable a user to “opt-in” to advertising. In such systems the GBCPS does not present advertising if the user has not indicated a desire (such as by not opening the “advertising” window 011). Such as system may present what may be termed “voluntary” advertising or opportunities for commercialization. Other arrangements with other numbers and/or types of presentation constructs are contemplated.

FIG. 1G is a block diagram of an example environment for presenting auxiliary content using an example Gesture Based Content Presentation System (GBCPS) or process. One or more users 10a, 10b, etc. communicate to the GBCPS 110 through one or more networks, for example, wireless and/or wired network 30, by indicating gestures using one or more input devices, for example a mobile device 20a, an audio device such as a microphone 20b, or a pointer device such as mouse 20c or the stylus on table device 20d (or for example, or any other input device, such as a keyboard of a computer device, an electronic control panel, display, or appliance, or a human body part, not shown). For the purposes of this description, the nomenclature “*” indicates a wildcard (substitutable letter(s)). Thus, user 20* may indicate a device 20a or a device 20b. The one or more networks 30 may be any type of communications link, including for example, a local area network or a wide area network such as the Internet.

Many different mechanisms for causing an auxiliary content to be presented can be accommodated, for example, a “single-click” of a mouse button following the gesture, a command via an audio input device such as microphone 20b, a secondary gesture, etc. Or in some cases, the determination and presentation is initiated automatically as a direct result of the gesture—without additional input—for example, as soon as the GBCPS determines the gesture is complete.

For example, once the user has provided gestured input, the GBCPS 110 will determine to what portion of the presented content the gesture corresponds. In some embodiments, the GBCPS 110 may take into account other factors in addition to the indicated portion of the presented content. The GBCPS 110 determines the indicated portion 25 to which the gesture-based input corresponds, and then, based upon the indicated portion 25, and possibly a set of factors 50, (and, in the case of a context menu, based upon a set of action/entity rules 51) determines the next predicted content and distributes information accordingly to one or more sponsors. Then, the GBCPS 110 may consult some sort of library for stored auxiliary content to present when the next content is navigated to or receives auxiliary content in near real-time. Once the auxiliary content is determined (e.g., indicated, linked to, referred to, obtained, or the like) the GBCPS 110 presents the auxiliary content.

The set of factors (e.g., criteria) 50 may be dynamically determined, predetermined, local to the GBCPS 110, or stored or supplied externally from the GBCPS 110 as described elsewhere. This set of factors may include a variety of aspects, including, for example: context of the indicated portion of the presented content, such as other words, symbols, and/or graphics nearby the indicated portion, the location of the indicated portion in the presented content, syntactic and semantic considerations, etc.; attributes of the user, for example, prior search, purchase, and/or navigation history, demographic information, and the like; attributes of the gesture, for example, direction, size, shape, color, steering, and the like; previous setup information such as previously stored associations resulting from bids, competitions, etc., and other criteria, whether currently defined or defined in the future. In this manner, the GBCPS 110 allows presentation of auxiliary content to become “tailored” to the product and/or service and/or the user as much as the system is tuned.

Representations and/or indications of the auxiliary content (for example, data structures storing information about such opportunities) may be stored local to the GBCPS 110, for example, in auxiliary content data repository 40 associated with a computing system running the GBCPS 110, or may be stored or available externally, for example, from another computing system 42, from third party content 43 (e.g., a 3^{rd} party advertising system, external content, a social network, etc.) from auxiliary content stored using cloud storage 44, from another device 45 (such as from a settop box, NV component, etc.), from a mobile device connected directly or indirectly with the user (e.g., from a device associated with a social network associated with the user, etc.), and/or from other devices or systems not illustrated. Third party content 43 is demonstrated as being communicatively connected to both the GBCPS 110 directly and/or through the one or more networks 30. Although not shown, various of the devices and/or systems 42-46 also may be communicatively connected to the GBCPS 110 directly or indirectly. The auxiliary content containing or representing the opportunity for commercialization may be any type of content and, for example, may include another document, an image, an audio snippet, an audio visual presentation, an advertisement, an opportunity for commercialization such as a bid, a product offer, a service offer, or a competition, and the like. Once the GBCPS 110 obtains the auxiliary content to present, the GBCPS 110 causes it to be presented on a presentation device (e.g., presentation device 20d) associated with the user.

The GBCPS 110 illustrated in FIG. 1G may be executing (e.g., running, invoked, instantiated, or the like) on a client or on a server device or computing system. For example, a client application (e.g., a web application, web browser, other application, etc.) may be executing on one of the presentation devices, such as tablet 20d. In some examples, some portion or all of the GBCPS 110 components may be executing as part of the client application (for example, downloaded as a plug-in, active-x component, run as a script or as part of a monolithic application, etc.). In other examples, some portion or all of the GBCPS 110 components may be executing as a server (e.g., server application, server computing system, software as a service, etc.) remotely from the client input and/or presentation devices 20a-d.

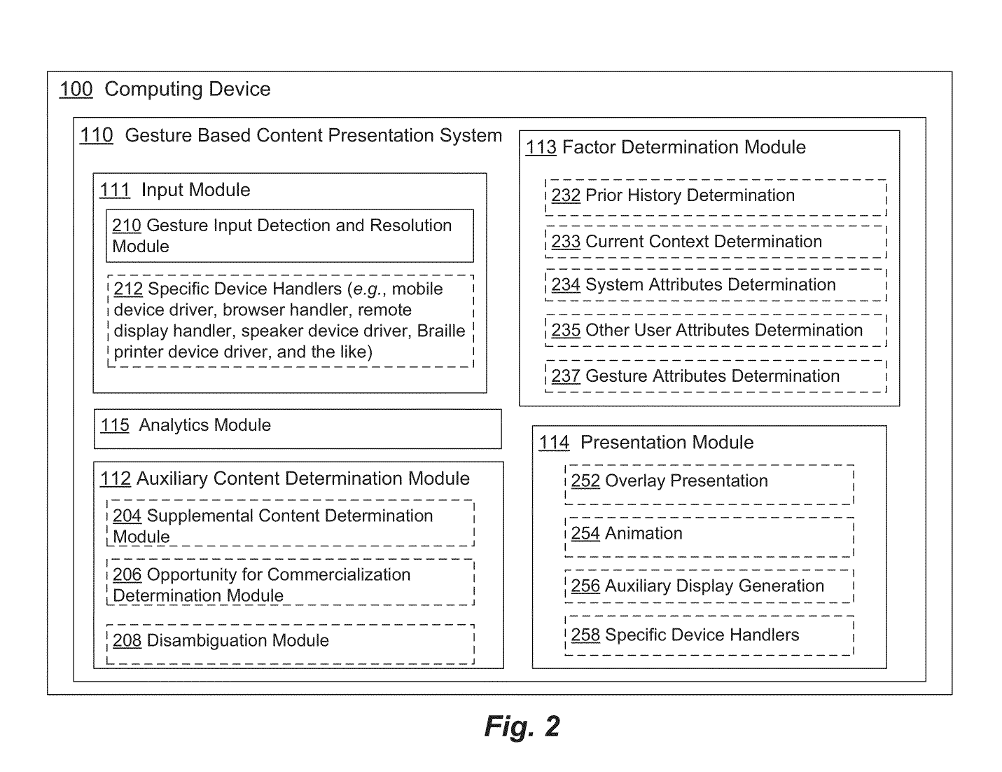

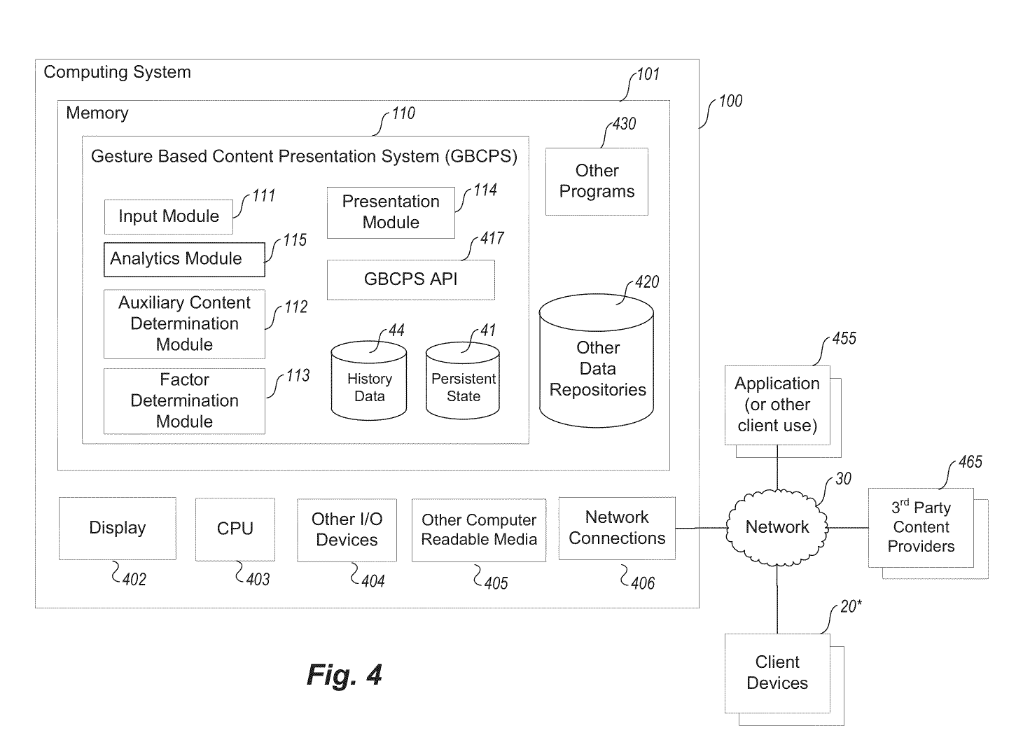

FIG. 2 is an example block diagram of components of an example Gesture Based Content Presentation System. In example GBCPSes such as GBCPS 110 of FIG. 1G, the GBCPS comprises one or more functional components/modules that work together to automatically present auxiliary content based upon gestured input. For example, a Gesture Based Content Presentation System 110 may reside in (e.g., execute thereupon, be stored in, operate with, etc.) a computing device 100 programmed with logic to effectuate the purposes of the GBCPS 110. As mentioned, a GBCPS 110 may be executed client side or server side. For ease of description, the GBCPS 110 is described as though it is operating as a server. It is to be understood that equivalent client side modules can be implemented. Moreover, such client side modules need not operate in a client-server environment, as the GBCPS 110 may be practiced in a standalone environment or even embedded into another apparatus. Moreover, the GBCPS 110 may be implemented in hardware, software, or firmware, or in some combination. In addition, although auxiliary content is typically presented on a client presentation device such as devices 20*, the auxiliary content may be implemented server-side or some combination of both. Details of the computing device/system 100 are described below with reference to FIG. 4.

In an example system, a GBCPS 110 comprises an input module 111, an auxiliary content determination module 112, a factor determination module 113, and a presentation module 114. In some embodiments the GBCPS 110 comprises additional and/or different modules as described further below.

Input module 111 is configured and responsible for determining the gesture and an indication of an area (e.g., a portion) of the presented electronic content indicated by the gesture. In some example systems, the input module 111 comprises a gesture input detection and resolution module 210 to aid in this process. The gesture input detection and resolution module 210 is responsible for determining, using different techniques, for example, pattern matching, parsing, heuristics, syntactic and semantic analysis, etc. to what portion of presented content a gesture corresponds and what word, phrase, image, audio clip, etc. is indicated. In some example systems, the input module 111 is configured to include specific device handlers 212 (e.g., drivers) for detecting and controlling input from the various types of input devices, for example devices 20*. For example, specific device handlers 212 may include a mobile device driver, a browser “device” driver, a remote display “device” driver, a speaker device driver, a Braille printer device driver, and the like. The input module 111 may be configured to work with and or dynamically add other and/or different device handlers.

The gesture input detection and resolution module 210 may be further configured to include a variety of modules and logic (not shown) for handling a variety of input devices and systems. For example, gesture input detection and resolution module 210 may be configured to handle gesture input by way of audio devices and/or a to handle the association of gestures to graphics in content (such as an icon, image, movie, still, sequence of frames, etc.). In addition, in some example systems, the input module 111 may be configured to include natural language processing to detect whether a gesture is meant to indicate a word, a phrase, a sentence, a paragraph, or some other portion of presented electronic content using techniques such as syntactic and/or semantic analysis of the content. In some example systems, the input module 111 may be configured to include gesture identification and attribute processing for handling other aspects of gesture determination such as determining the particular type of gesture (e.g., a circle, oval, polygon, closed path, check mark, box, or the like) or whether a particular gesture is a “steering” gesture that is meant to correct, for example, an initial path indicated by a gesture; a “smudge” which may have its own interpretation such as extend the gesture “here;” the color of the gesture, for example, if the input device supports the equivalent of a colored “pen” (e.g., pens that allow a user can select blue, black, red, or green); the size of a gesture (e.g., whether the gesture draws a thick or thin line, whether the gesture is a small or large circle, and the like); the direction of the gesture (up, down, across, etc.); and/or other attributes of a gesture.

Other modules and logic may be also configured to be used with the input module 111.

Auxiliary content determination module 112 is configured and responsible for determining auxiliary content and for determining auxiliary content to be presented upon detection of the user navigating to the next content. As explained earlier, determining which auxiliary content to present may be based upon the context—the portion indicated by the gesture and potentially a set of factors (e.g., criteria, properties, aspects, or the like) that help to define context. Thus, the auxiliary content determination module 112 may invoke the factor determination module 113 to determine the one or more factors to use to assist in determining auxiliary content to present. The factor determination module 113 may comprise a variety of implementations corresponding to different types of factors, for example, modules for determining prior history associated with the user, current context, gesture attributes, system attributes, bid history, or the like.

In some cases, for example, when the portion of content indicated by the gesture is ambiguous or not clear by the indicated portion itself, the auxiliary content determination module 112 may utilize logic (not shown) to help disambiguate the indicated portion of content. In addition, based upon the indicated portion of content and the set of factors, more than auxiliary content may be identified to be presented when the user navigates to the next content. If this is the case, then the opportunity for commercialization determination module 112 may use the disambiguation logic to select an auxiliary content to present. The disambiguation logic may utilize syntactic and/or semantic aids, user selection, default values, and the like to assist in the determination of an opportunity for commercialization.

In some example systems, the auxiliary content determination module 112 is configured to determine (e.g., find, establish, select, realize, resolve, establish, etc.) auxiliary content that best matches the gestured input and/or the next predicted content. Best match may include auxiliary content that is, for example, most related syntactically or semantically, closest in “proximity” however proximity is defined (e.g., an advertisement that has been shown to a relative of the user or the user's social network), most often presented given the represented product and/or service indicated by the gesture, and the like. Other definitions for determining what auxiliary content best relates to the next content can be incorporated by the GBCPS.

The auxiliary content determination module 112 may be further configured to include a variety of different modules and/or logic to aid in this determination process. For example, the auxiliary content determination module 112 may be configured to include one or more of an supplemental content determination module 204, an opportunity for commercialization determination module 206 and a disambiguation module 208. These modules may be used to determine different types of auxiliary content, for example, encyclopedic information, dictionary definitions, bidding opportunities, computer-assisted competitions, advertisements, games, purchase and/or offers for products or services, interactive entertainment, or the like, that can be associated with the product and/or service represented by the gestured input and/or the next content to be examined. For example, as shown in FIG. 1G, auxiliary content may be provided by a variety of sources including from local storage, over a network (e.g., wide area network such as the Internet, a local area network, a proprietary network, an Intranet, or the like), from a known source provider, from third party content (available, for example from cloud storage or from the provider's repositories), or the like. In some systems, a third party advertisement provider system is used that is configured to accept queries for advertisements (“ads”) such as using keywords, to output appropriate advertising content.

The auxiliary content determination module 112 may be further configured to determine other types of supplemental content using the supplemental content determination module 204. The supplemental content determination module 204 may be configured to determine other content that somehow relates to (e.g., associated with, supplements, improves upon, corresponds to, has the opposite meaning from, etc.) the gestured input

Other modules and logic may be also configured to be used with the auxiliary content determination module 112.

As mentioned, the auxiliary content determination module 112 may invoke the factor determination module 113 to determine the one or more factors to use to assist in determining which auxiliary content is associated with the next content. The factor determination module 113 may be configured to include a prior history determination module 232, a current context determination module 233, a system attributes determination module 234, other user attributes determination module 235, and/or a gesture attributes determination module 237. Other modules may be similarly incorporated.

In some example systems, the prior history determination module 232 is configured to determine (e.g., find, establish, select, realize, resolve, establish, etc.) prior histories associated with the user and/or the product and/or service represented by the gestured input and is configured to include modules/logic to implement such. For example, the prior history determination module 232 may be configured to determine demographics (such as age, gender, residence location, citizenship, languages spoken, or the like) associated with the user. The prior history determination module 232 also may be configured determine a user's prior purchases. The purchase history may be available electronically, over the network, may be integrated from manual records, or some combination. In some systems, these purchases may be product and/or service purchases. The prior history determination module 232 may be configured to determine a user's prior searches for product and/or service. Such records may be stored locally with the GBCPS 110 or may be available over the network 30 or using a third party service, etc. The prior history determination module 232 also may be configured to determine how a user navigates through his or her computing system so that the GBCPS 110 can determine aspects such as navigation preferences, commonly visited content (for example, commonly visited websites or bookmarked items), what prior content has been viewed, etc.

In some example systems, the current context determination module 233 is configured to provide determinations of attributes regarding what the user is viewing, the underlying content, context relative to other containing content (if known), whether the gesture has selected a word or phrase that is located with certain areas of presented content (such as the title, abstract, a review, and so forth).

In some example systems, the system attributes determination module 234 is configured to determine aspects of the “system” that may provide influence or guidance (e.g., may inform) the determination of the portion of content indicated by the gestured input. These may include, for example, aspects of the GBCPS 110, aspects of the system that is executing the GBCPS 110 (e.g., the computing system 100), aspects of a system associated with the GBCPS 110 (e.g., a third party system), network statistics, and/or the like.

In some example systems, the other user attributes determination module 235 is configured to determine other attributes associated with the user not covered by the prior history determination module 232. For example, a user's social connectivity data may be determined by module 235. For example, a list of products and/or services purchased and/or offered to members of the user's social network may provide insights for what this user may like.

In some example systems, the gesture attributes determination module 237 is configured to provide determinations of attributes of the gesture input, similar or different from those described relative to input module 111 for determining to what content a gesture corresponds. Thus, for example, the gesture attributes determination module 237 may provide information and statistics regarding size, length, shape, color, and/or direction of a gesture.

Other modules and logic may be also configured to be used with the factor determination module 113.

In some embodiments, the GBCPS uses context menus, for example, to allow a user to modify a gesture or to assist the GBCPS is inferring what auxiliary content is appropriate. In such a case, a context menu handling module (not shown) may be configured to process and handle menu presentation and input. It may be configured to include an items determination logic for determining what menu items to present on a particular menu, input handling logic for providing an event loop to detect and handle user selection of a menu item, viewing logic to determine what kind of “view” (as in a model/view/controller—MVC—model) to present (e.g., a pop-up, pull-down, dialog, interest wheel, and the like) and a presentation logic for determining when and what to present to the user and to determine auxiliary content to present that is associated with a selection. In some embodiments, rules for actions and/or entities may be provided to determine what to present on a particular menu.

Once auxiliary content is determined, the GBCPS 110 uses the presentation module 114 to present the determined auxiliary content. The GBCPS 110 forwards (e.g., communicates, sends, pushes, etc.) an indication of the auxiliary content to the presentation module 114 to cause the presentation module 114 to present the (content associated with the) auxiliary content or cause another device to present it. The auxiliary content may be presented in a variety of manners, including via visual display, audio display, via a Braille printer, electronic reader, etc., and using different techniques, for example, overlays, slide-ins, panes, animation, etc.

The presentation module 115 may be configured to include a variety of other modules and/or logic. For example, the presentation module 115 may be configured to include an overlay presentation module 252 for determining how to present the determined auxiliary content in an overlay manner on a presentation device such as tablet 20d. Overlay presentation module 252 may utilize knowledge of the presentation devices to decide how to integrate the auxiliary content as an “overlay” (e.g., covering up a portion or all of the underlying presented content). For example, when the GBCPS 110 is run as a server application that serves web pages to a client side web browser, certain configurations using “html” commands or other tags may be used.

Presentation module 115 also may be configured to include an animation module 254. In some example systems, for example as described in FIGS. 1C, 1D1-1D8, and 1E1, the auxiliary content may be “moved in” from one side or portion of a presentation device in an animated manner. For example, the auxiliary content may be placed in a pane (e.g., a window, frame, pane, etc., as appropriate to the underlying operating system or application running on the presentation device) that is moved in from one side of the display onto the content previously shown. Other animations can be similarly incorporated.

Presentation module 115 also may be configured to include an auxiliary display generation module 256 for generating a new graphic or audio construct to be presented in conjunction with the content already displayed on the presentation device. In some systems, the new content is presented in a new window, frame, pane, or other auxiliary display construct.

Presentation module 115 also may be configured to include specific device handlers 258, for example, device drivers configured to communicate with mobile devices, remote displays, speakers, electronic readers, Braille printers, and/or the like as described elsewhere. Other or different presentation device handlers may be similarly incorporated.

Also, other modules and logic may be also configured to be used with the presentation module 115.

Although the techniques of a Gesture Based Content Presentation System (GBCPS) are generally applicable to any type of gesture-based system, the phrase “gesture” is used generally to imply any type of physical pointing type of gesture or audio equivalent. In addition, although the examples described herein often refer to online electronic content such as available over a network such as the Internet, the techniques described herein can also be used by a local area network system or in a system without a network. In addition, the concepts and techniques described are applicable to other input and presentation devices. Essentially, the concepts and techniques described are applicable to any environment that supports some type of gesture-based input.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a Gesture Based Content Presentation System (GBCPS) to be used for providing presentation of auxiliary content based upon gestured input. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic or code flow, different logic, or the like. Thus, the scope of the techniques and/or components/modules described are not limited by the particular order, selection, or decomposition of logic described with reference to any particular routine.

### Example Processes

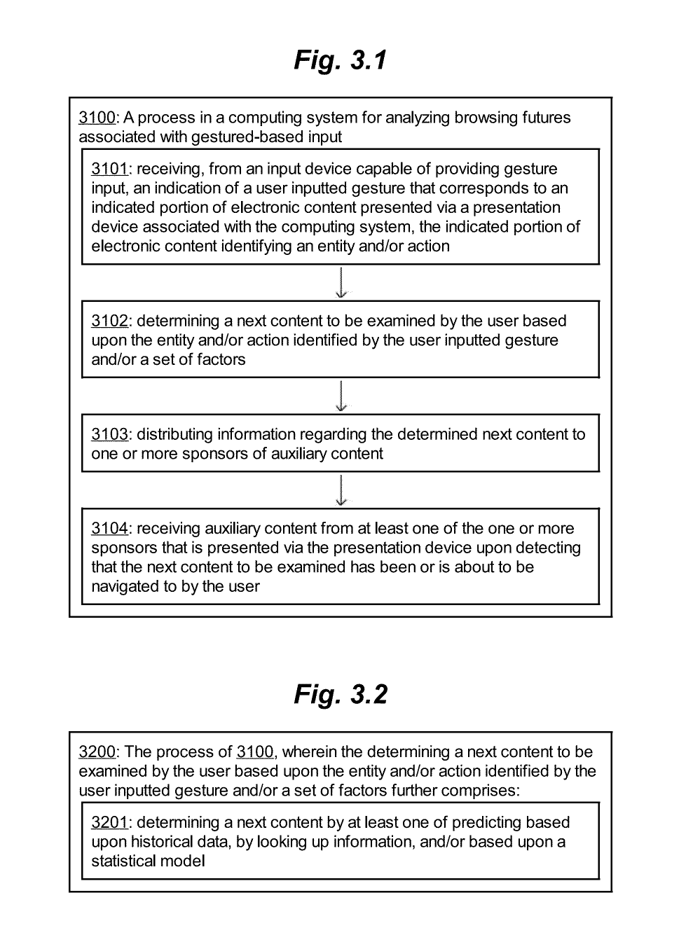

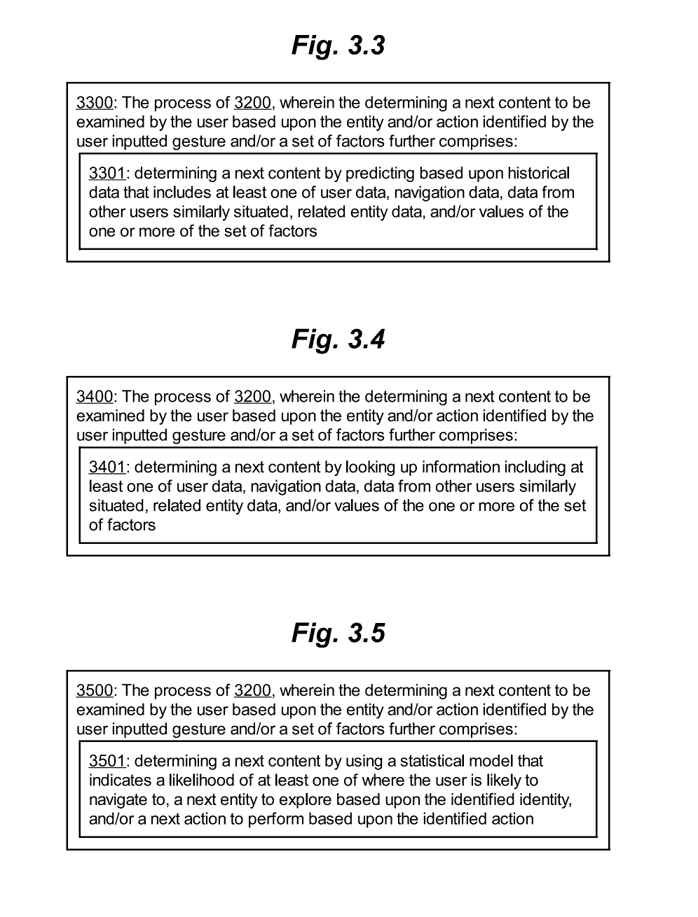

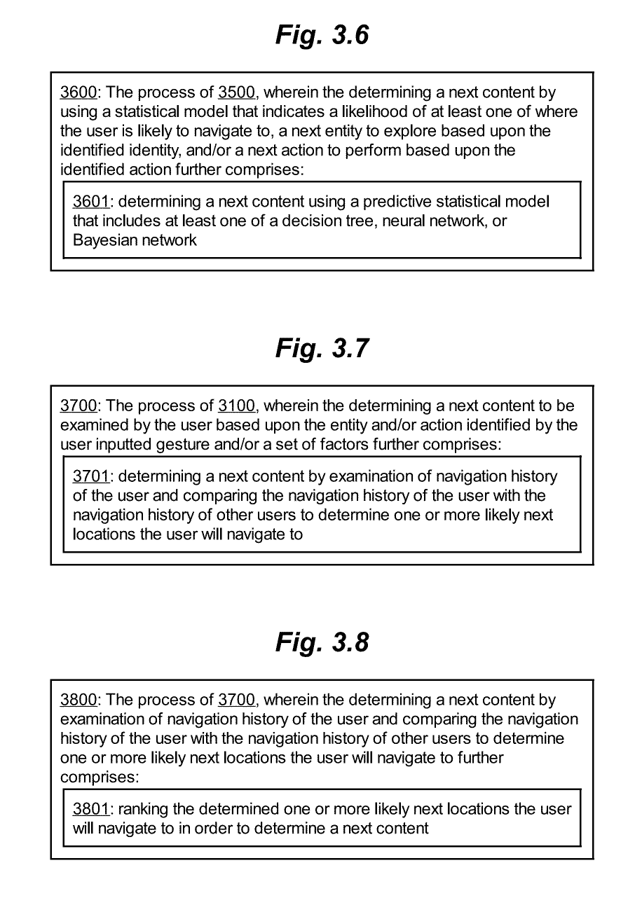

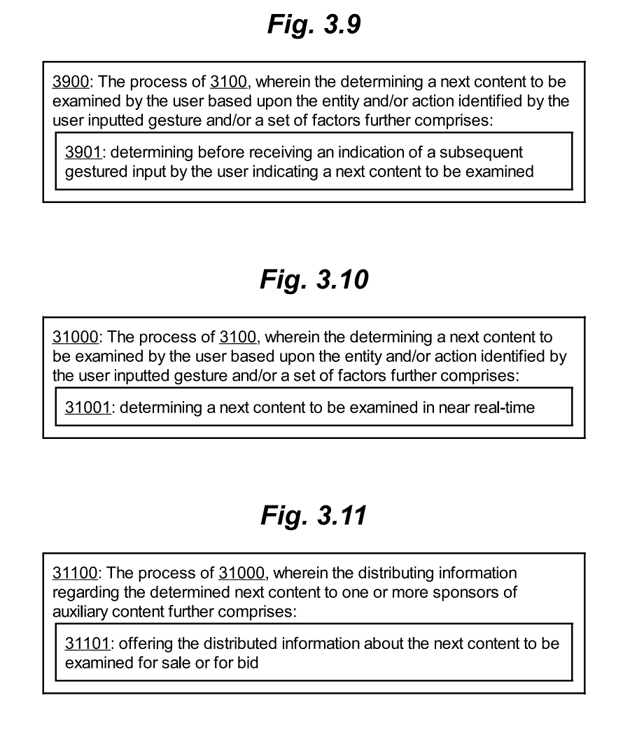

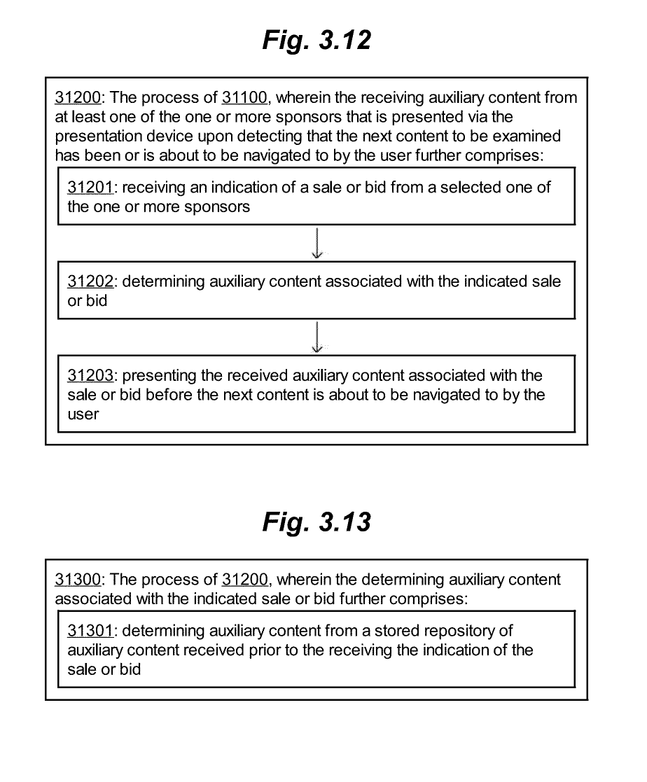

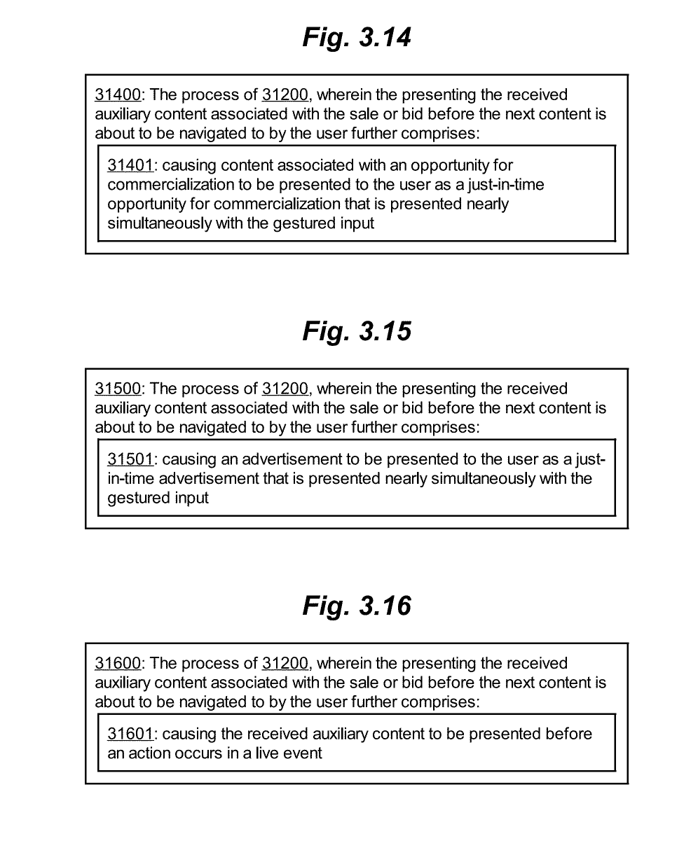

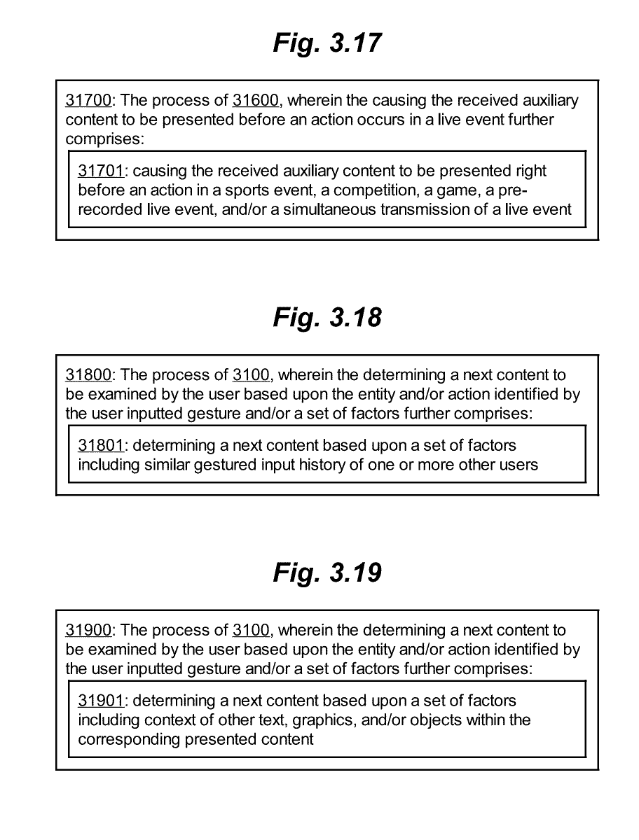

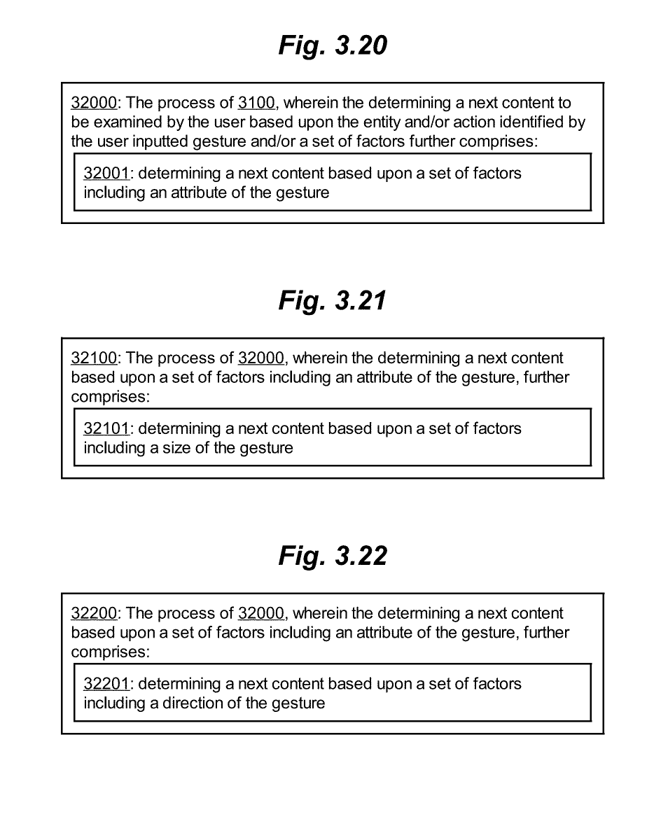

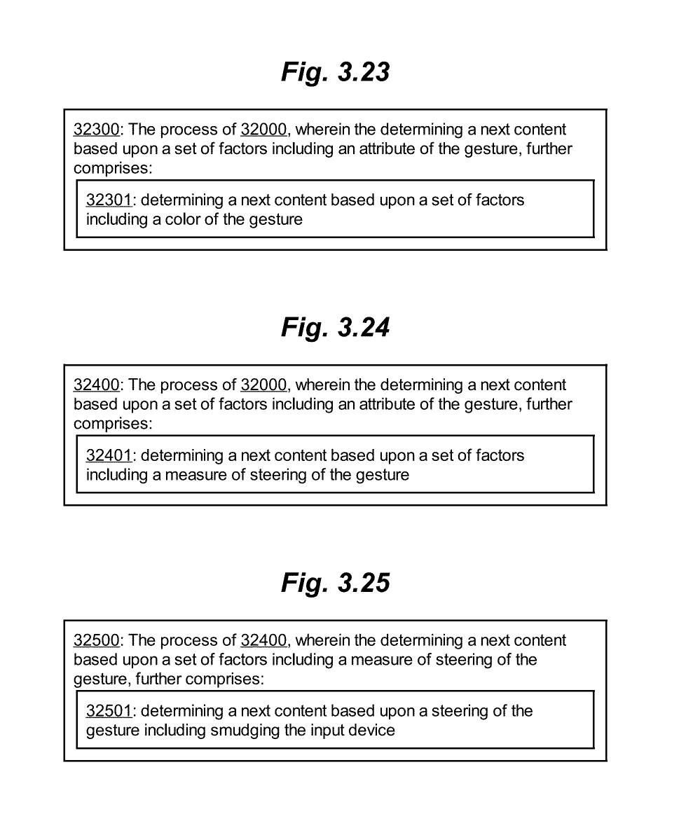

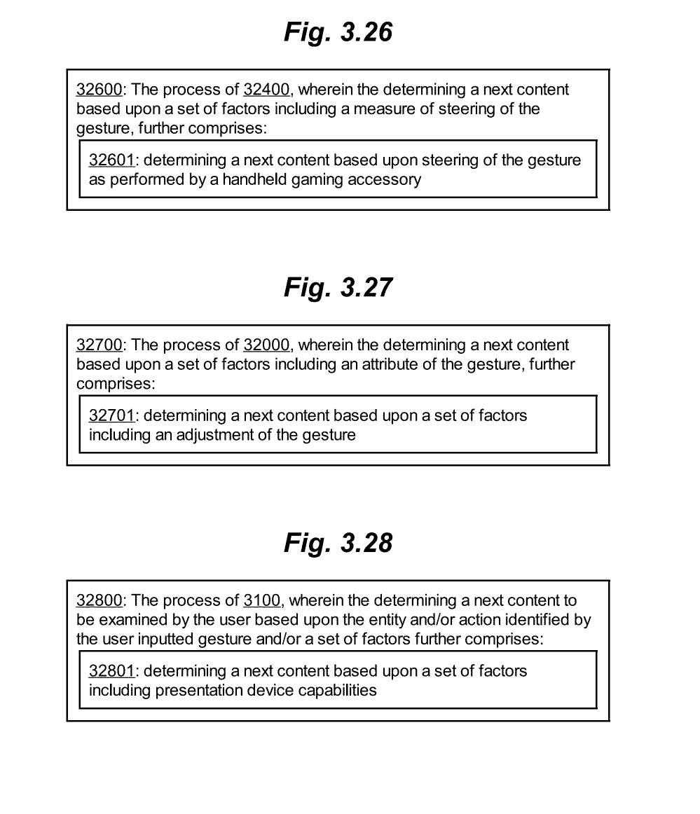

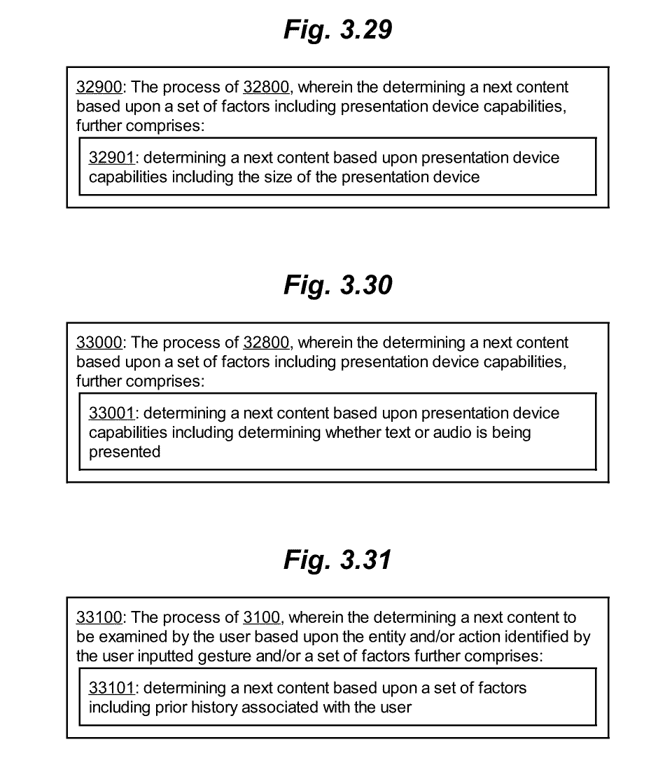

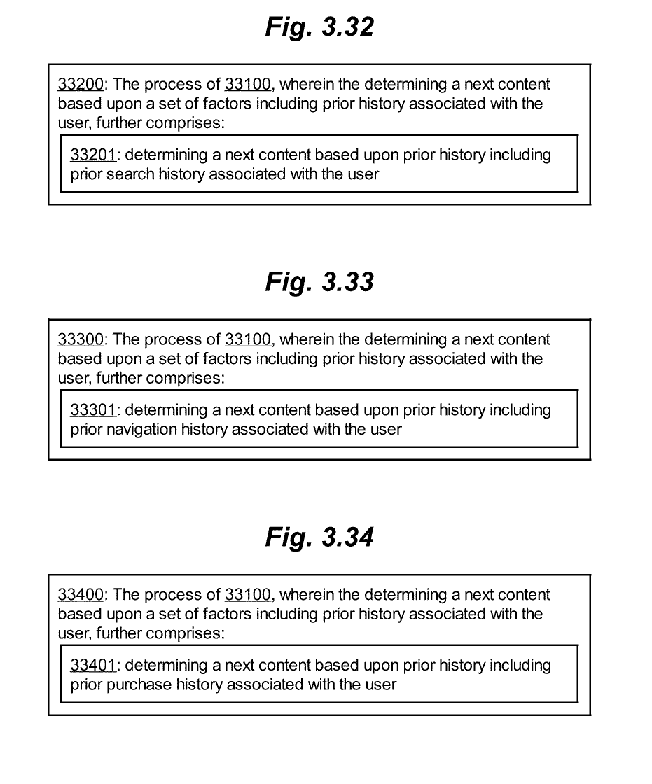

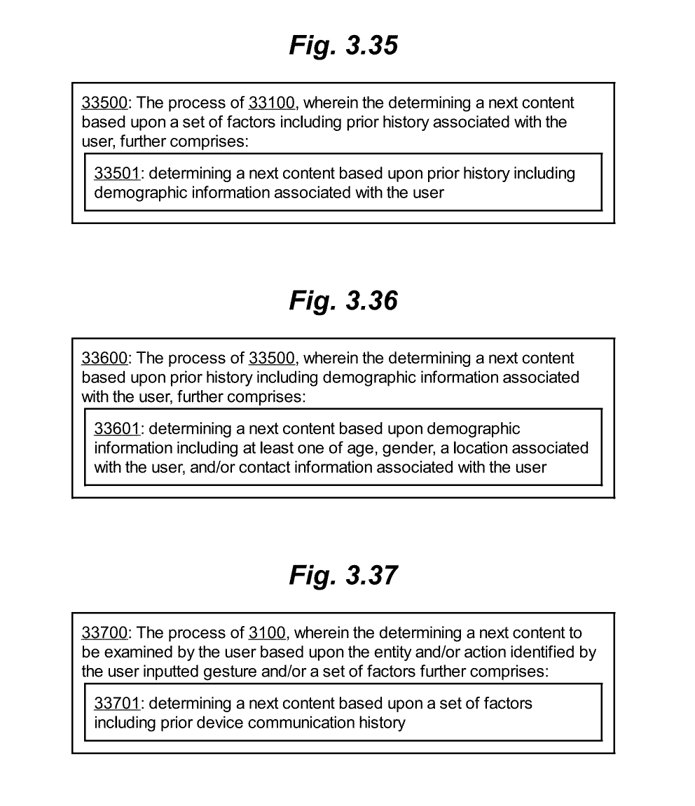

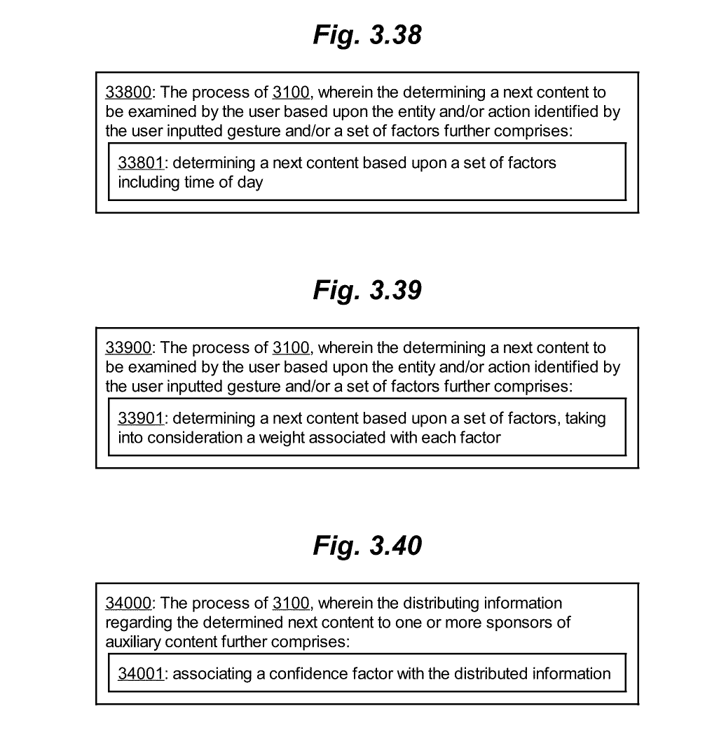

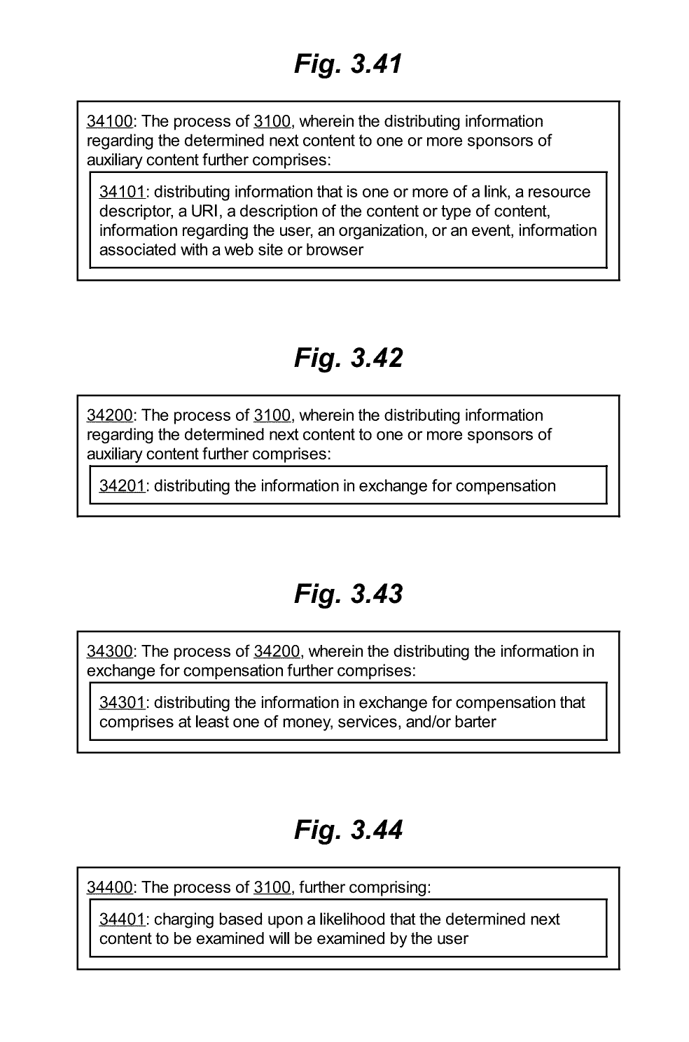

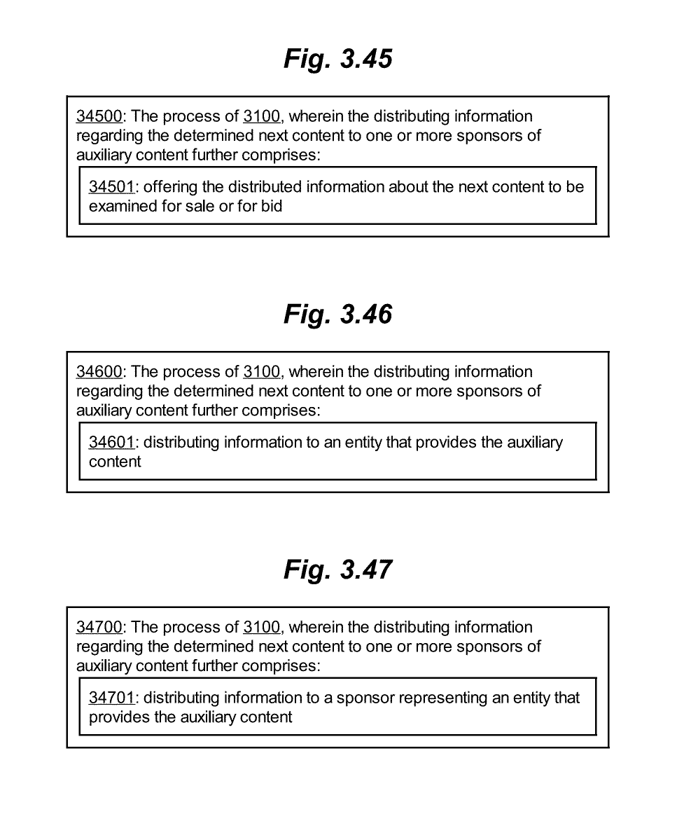

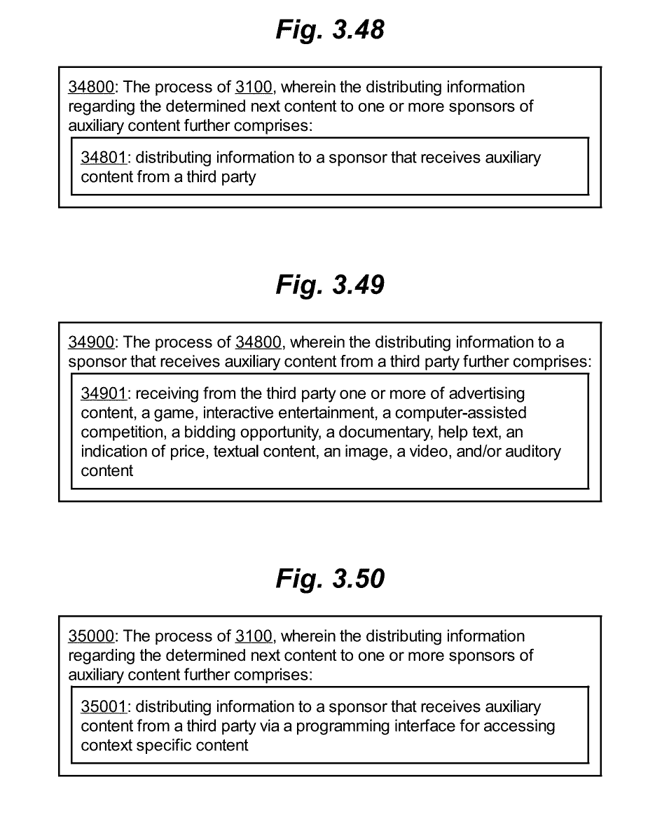

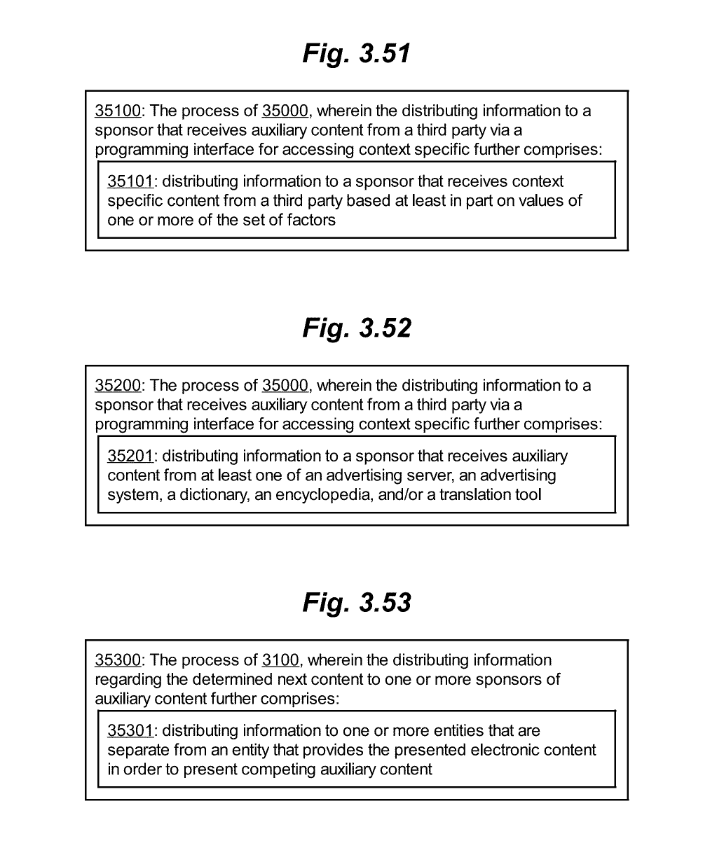

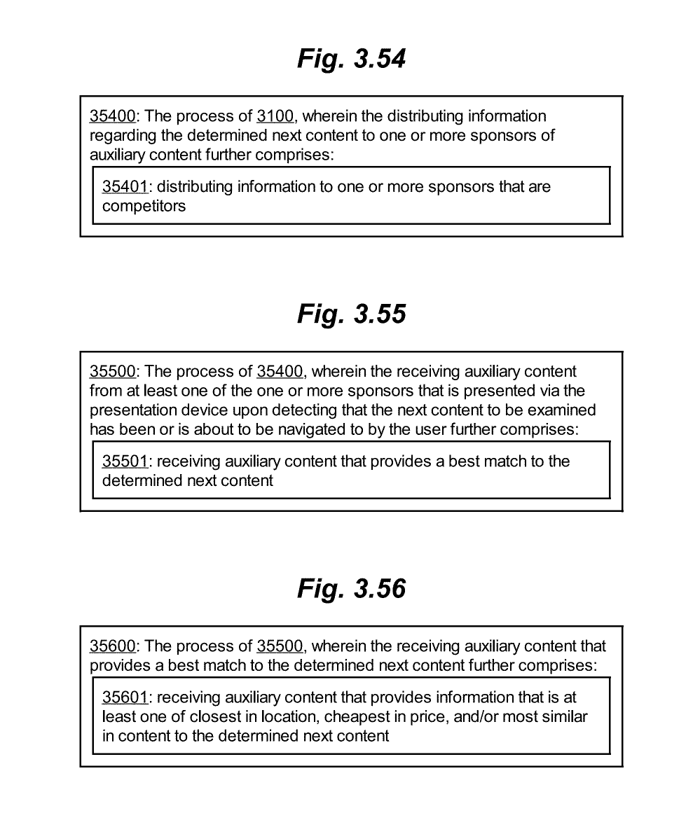

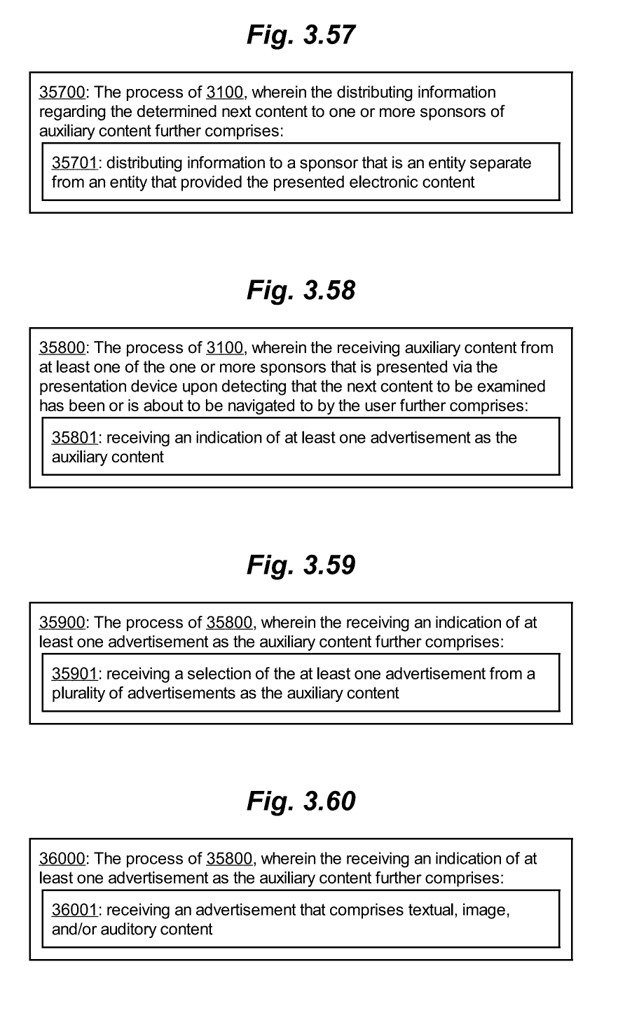

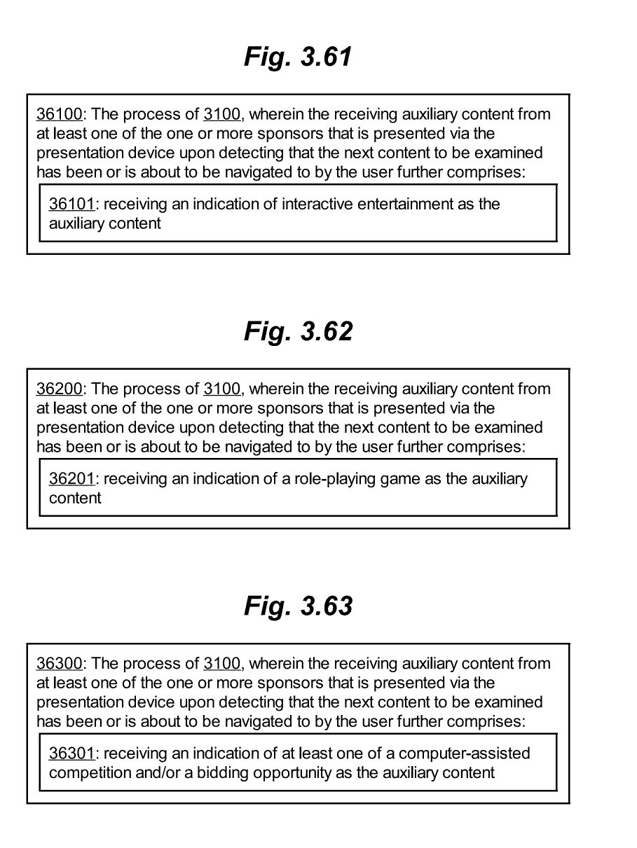

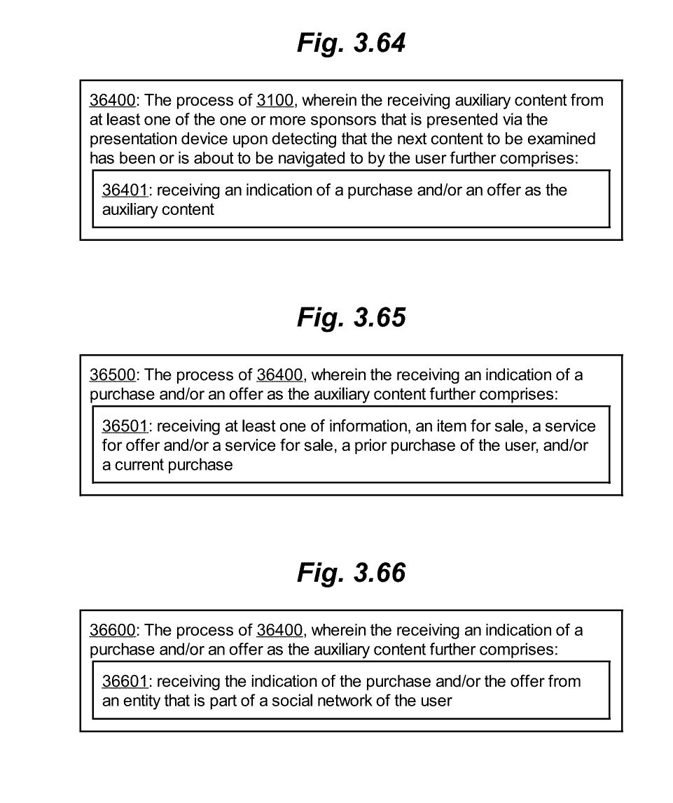

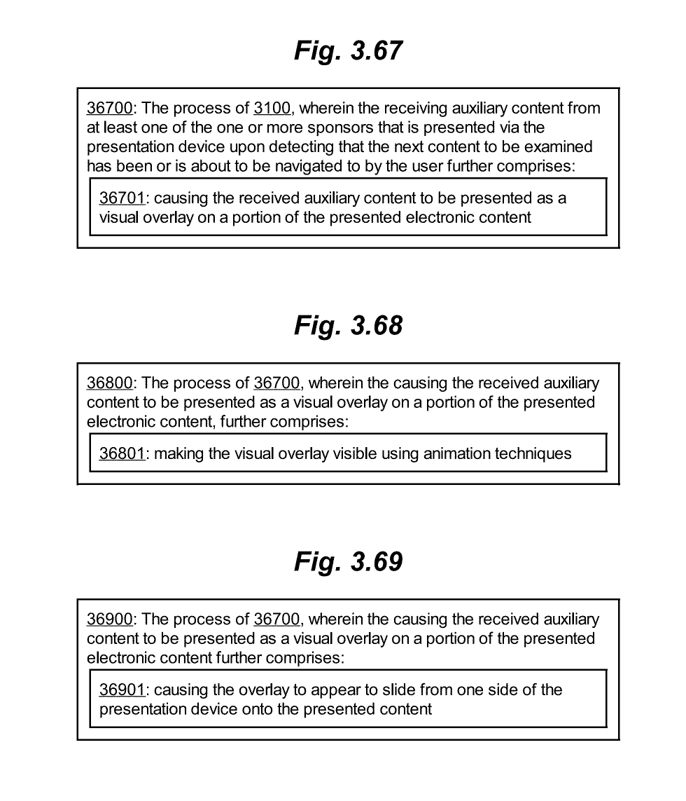

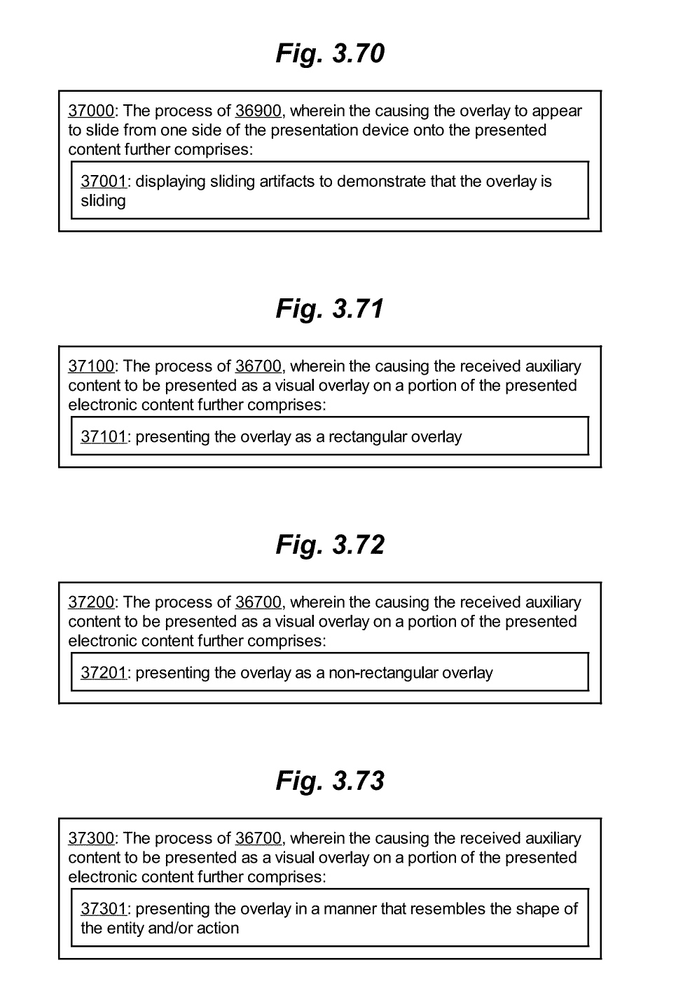

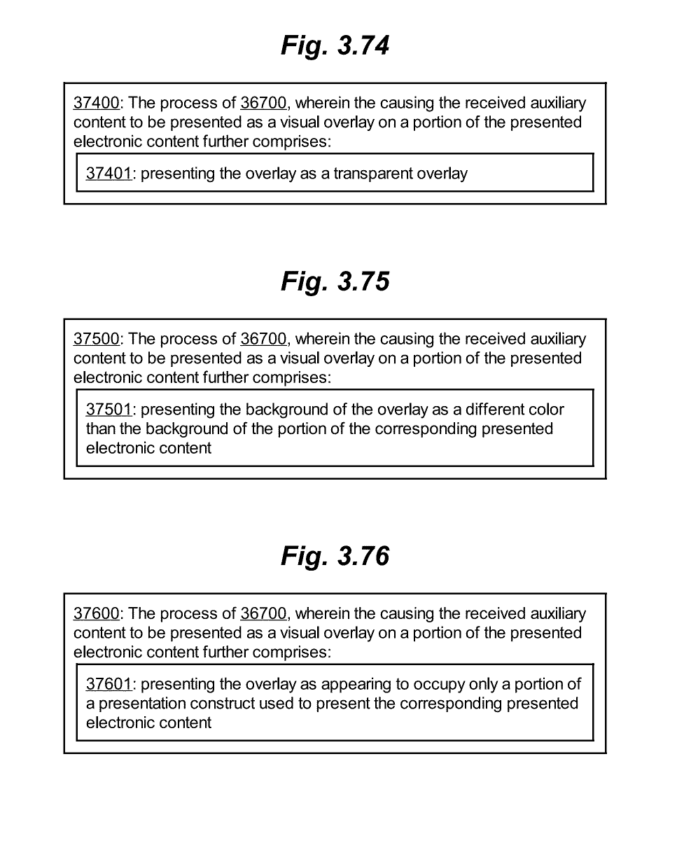

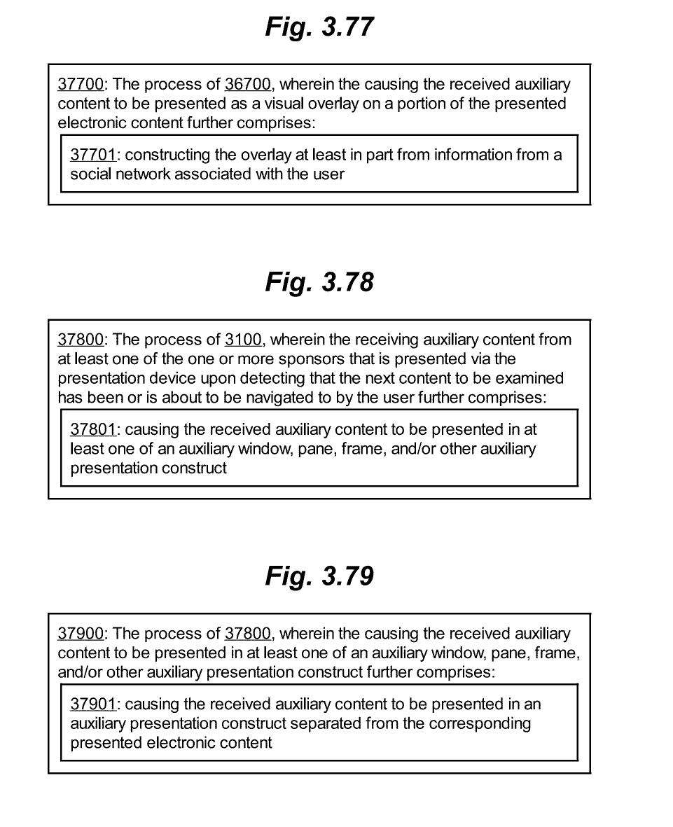

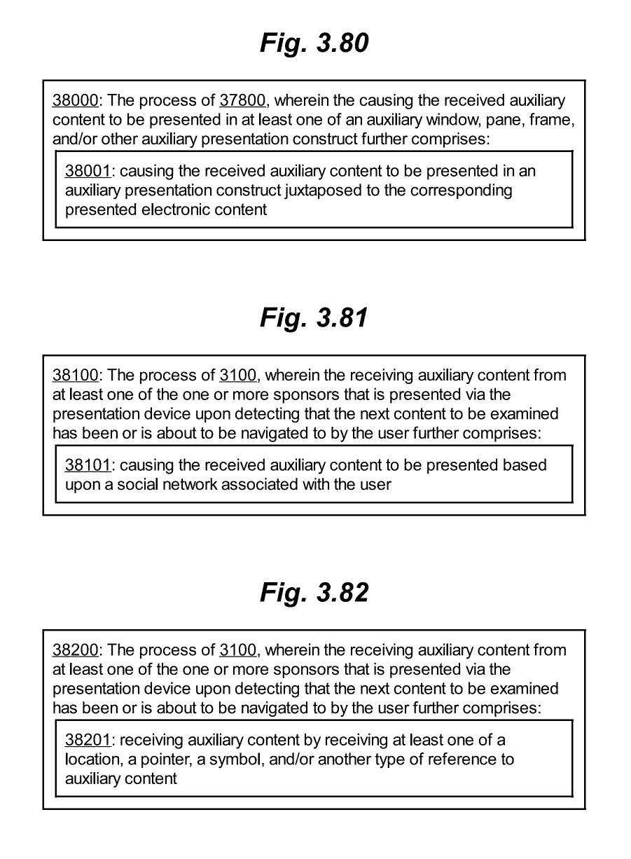

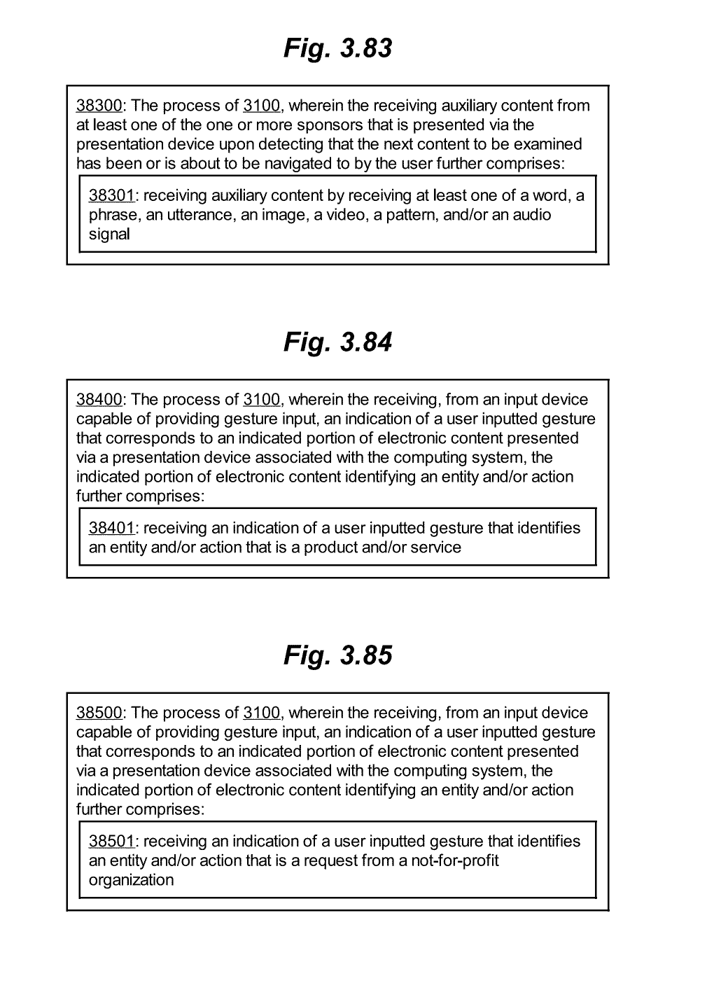

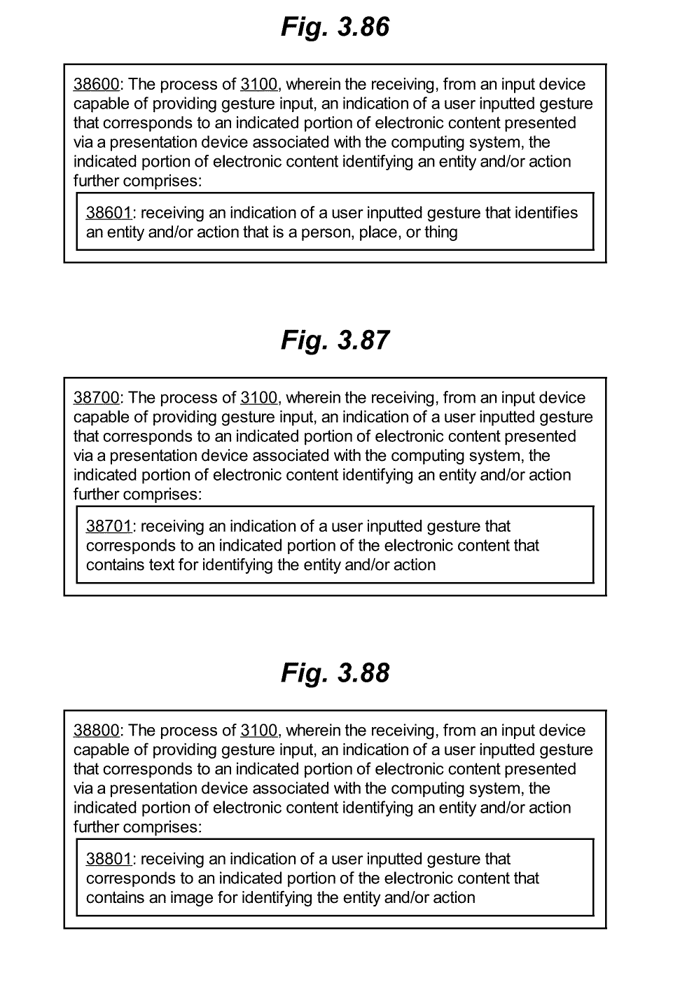

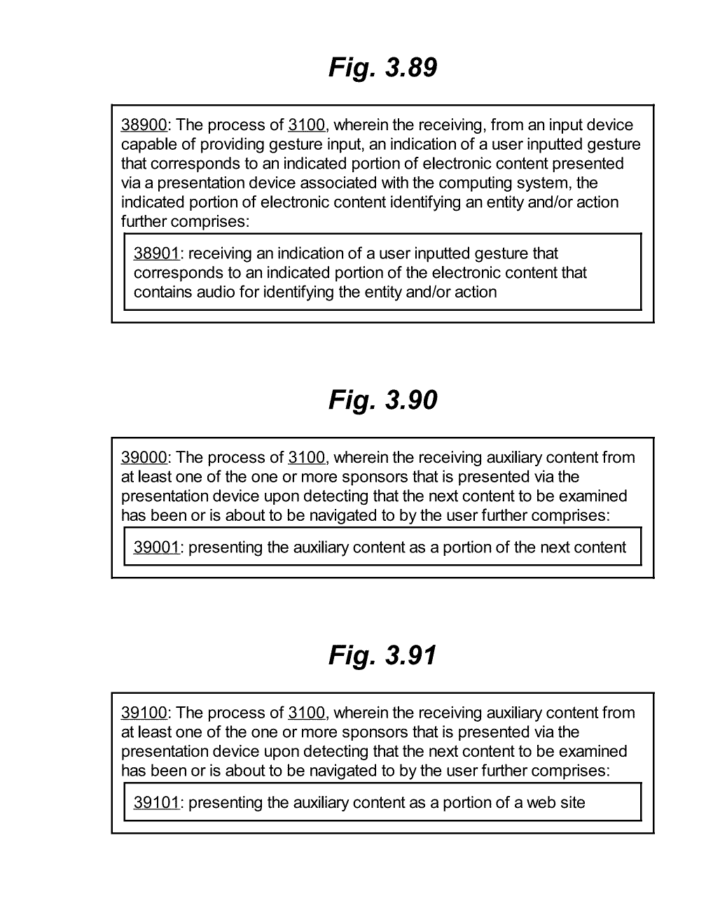

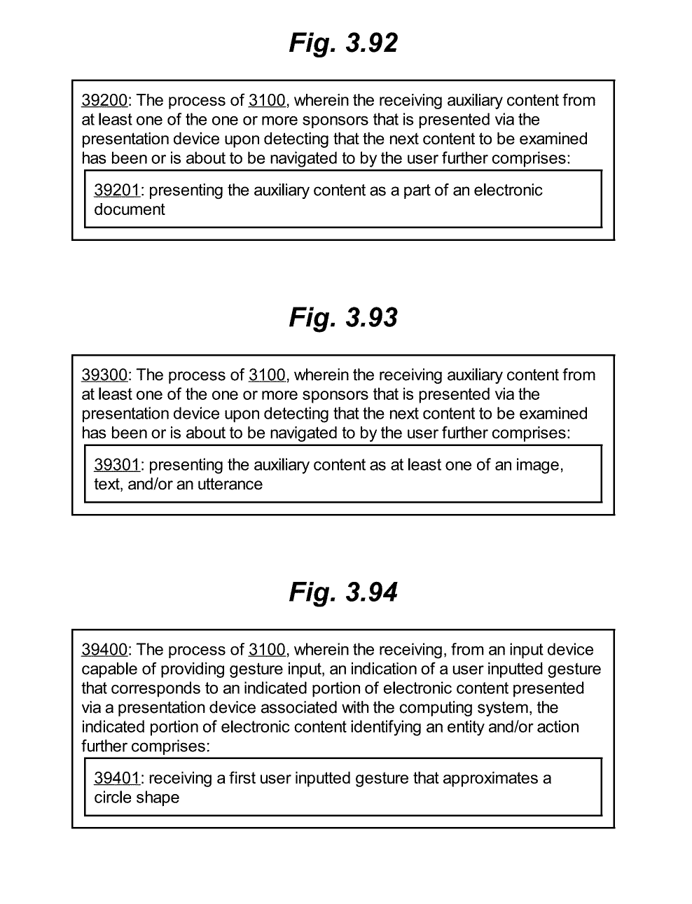

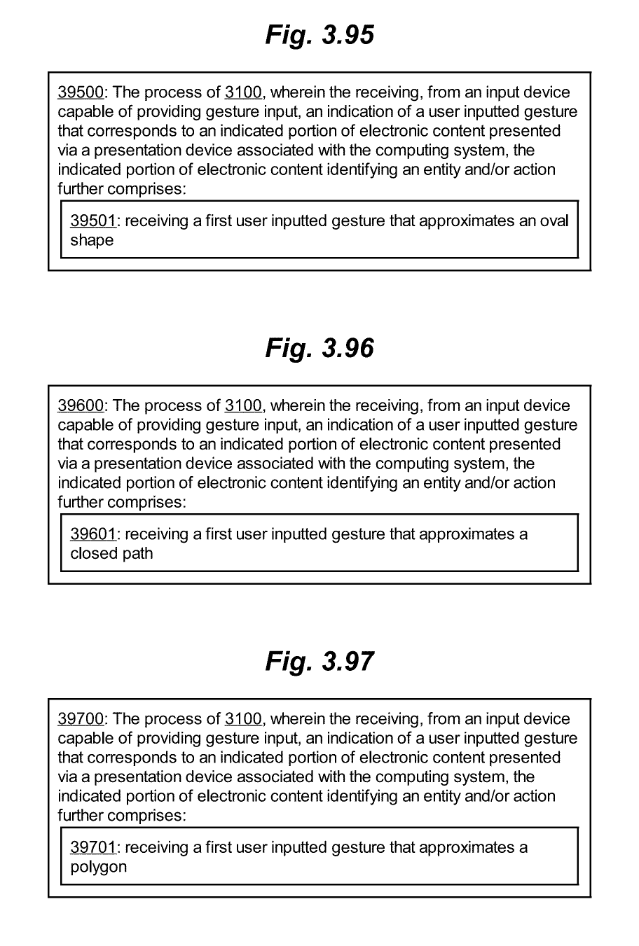

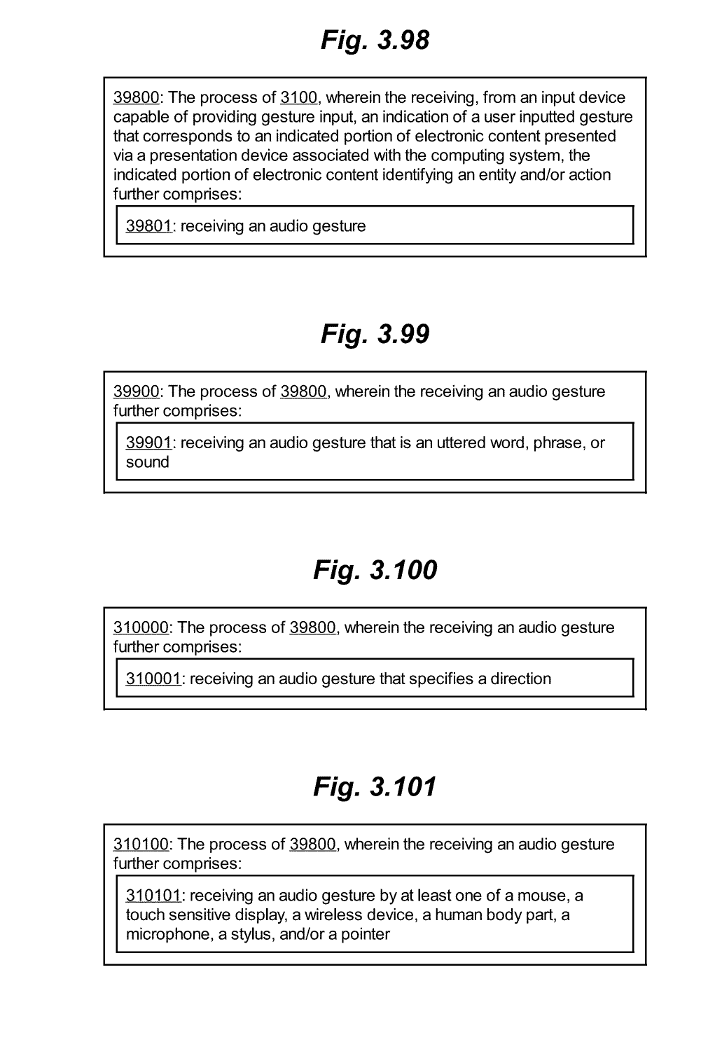

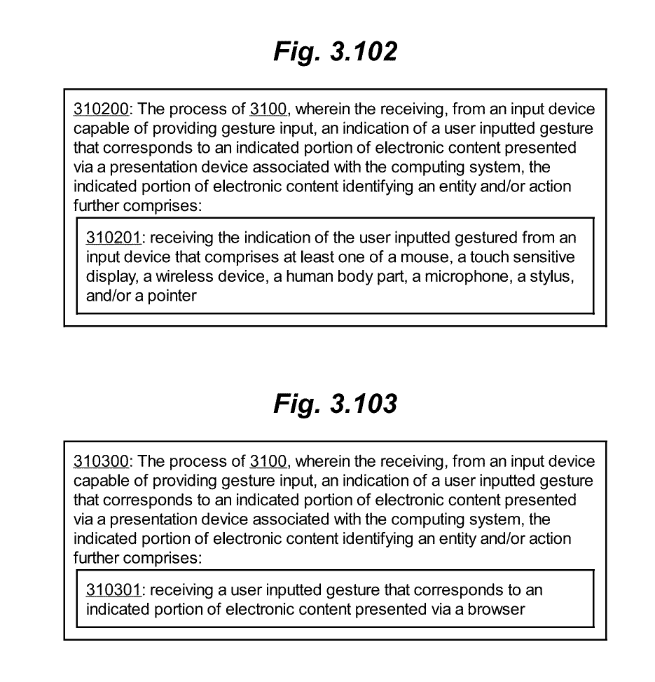

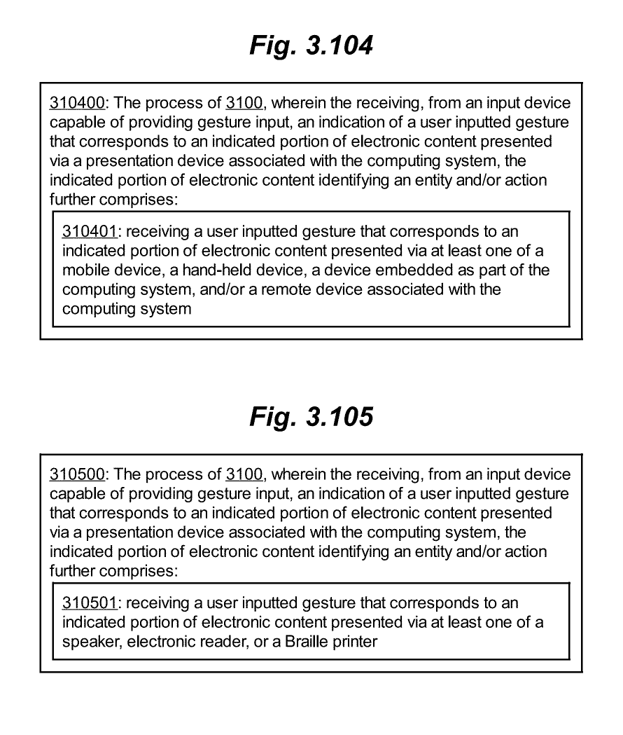

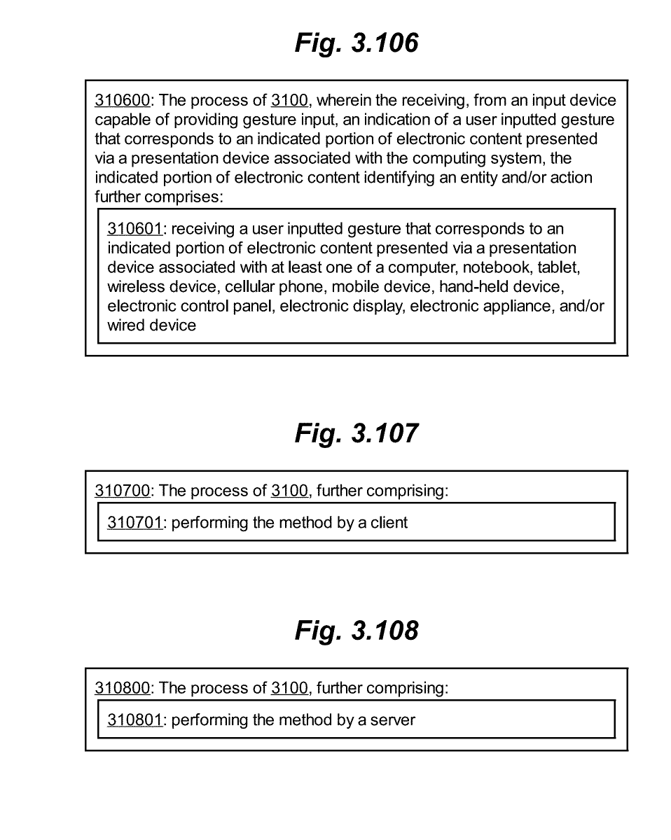

FIGS. 3.1-3.108 are example flow diagrams of various example logic that may be used to implement embodiments of a Gesture Based Content Presentation System (GBCPS). The example logic will be described with respect to the example components of example embodiments of a GBCPS as described above with respect to FIGS. 1A-2. However, it is to be understood that the flows and logic may be executed in a number of other environments, systems, and contexts, and/or in modified versions of those described. In addition, various logic blocks (e.g., operations, events, activities, or the like) may be illustrated in a “box-within-a-box” manner. Such illustrations may indicate that the logic in an internal box may comprise an optional example embodiment of the logic illustrated in one or more (containing) external boxes. However, it is to be understood that internal box logic may be viewed as independent logic separate from any associated external boxes and may be performed in other sequences or concurrently.

FIG. 3.1 is an example flow diagram of example logic in a computing system for analyzing browsing futures associated with gestured-based input. More particularly, FIG. 3.1 illustrates a process 3100 that includes operations performed by or at the following block(s).

At block 3101, the process performs receiving, from an input device capable of providing gesture input, an indication of a user inputted gesture that corresponds to an indicated portion of electronic content presented via a presentation device associated with the computing system, the indicated portion of electronic content identifying an entity and/or action. This logic may be performed, for example, by the input module 111 of the GBCPS 110 described with reference to FIG. 2 by receiving (e.g., obtaining, getting, extracting, and so forth), from an input device capable of providing gesture input (e.g., devices 20*), an indication of a user inputted gesture that corresponds to an indicated portion (e.g., indicated portion 25) on electronic content presented via a presentation device (e.g., 20*) associated with the computing system 100. Different logic of the gesture input detection and resolution module 210, such as the audio handling logic, graphics handling logic, natural language processing, and/or gesture identification and attribute processing logic may be used to assist in this receiving block. In addition, specific device handlers 212 of the input module 111 of the GBCPS 110 described with reference to FIG. 2 may be used to determine the gestured portion. The indicated portion may be formed from contiguous or composed of separate non-contiguous parts, for example, a title with a disconnected sentence with or without a picture, or the like. In addition, the indicated portion may represent the entire body of electronic content presented to the user or a part. Also as described elsewhere, the gestural input may be of different forms, including, for example, a circle, an oval, a closed path, a polygon, and the like. The gesture may be from a pointing device, for example, a mouse, laser pointer, a body part, and the like, or from a source of auditory input. The identified entity and/or action may include any type of representation, including textual, auditory, images, or the like.

At block 3102, the process performs determining a next content to be examined by the user based upon the entity and/or action identified by the user inputted gesture and/or a set of factors. This logic may be performed, for example, by the analytics module 115 of the GBCPS 110 described with reference to FIG. 2. Then analytics module 115 determines using one of a variety of mechanisms described elsewhere, including for example, prediction, statistical modeling, look up, collaborative filtering and the like, what is the next likely content that the user is going to consider (e.g. to navigate, browse, examine, explore, etc.). This determination may be based upon the gestured entity and/or action and may also consider one of any number of factors that provide contextual information. For example, if the entity and/or action is a product and the GBCPS 110 determines that the user is likely to want to go to a website to purchase it, then the user's prior navigation history and prior purchase history may be used to determine which website the user is likely to visit to purchase the product.

At block 3103, the process performs distributing information regarding the determined next content to one or more sponsors of auxiliary content. This logic may be performed, for example, by the analytics module 115 of the GBCPS 110 described with reference to FIG. 2. The analytics module 115 may use a factor determination module 113 to determine a set of factors to use (e.g., the context of the gesture, the user, or of the identified entity and/or action, prior history associated with the user or the system, attributes of the gestures, associations of auxiliary content stored by the GBCPS 110 and the like), in addition to determining what entity and/or action has been identified by the gesture, in distributing information (e.g., which content, url, values of the one or more factors, etc.) relating to the next content to be navigated to (e.g., browsed, explored, viewed, heard, etc.) by the user. A sponsor may be any provider of content that is supplemental to that already being presented. The sponsor may be the same entity as the entity that is providing the content being presented. As is explained elsewhere, the sponsors themselves may derive the auxiliary content from other third parties. For example, if the auxiliary content is an advertisement supplied by a manufacturer, at least a portion of the information used in the advertisement may be provided by an ad server. The ad server may be primed to take into account some of the set of factors (such as the gender or country of residence of the user) to generate content aimed at the user.

At block 3104, the process performs receiving auxiliary content from at least one of the one or more sponsors that is presented via the presentation device upon detecting that the next content to be examined has been or is about to be navigated to by the user. This logic may be performed, for example, by the auxiliary content determination module 112 of the of the GBCPS 110 described with reference to FIG. 2. The auxiliary content determination module 112 of the of the GBCPS 110 described with reference to FIG. 2 may receive auxiliary content from one or more of the sponsors. The auxiliary content typically relates to the next content to be browsed (e.g., navigated to, explored, viewed, heard, etc.) by the user but isn't required to be. The auxiliary content may be anything, including, for example, an advertisement, a bidding opportunity, a game that results in funds (or the equivalent) exchanged, additional (e.g., supplemental) information, fun facts, or the like. As described in detail elsewhere, the next content may include any type of content that can be shown to or navigated to by the user. For example, the next content may include advertising, web pages, code, images, audio clips, video clips, speech, or other types of content that may be presented to the user. Once the GBCPS 110 detects that the user has navigated to the next content, then the auxiliary content may be presented (e.g., shown, displayed, played back, outputted, rendered, illustrated, or the like) as overlaid content or juxtaposed to the already presented electronic content, using additional presentation constructs (e.g., windows, frames, panes, dialog boxes, or the like) or within already presented constructs. In some cases, the user is navigated to the auxiliary content being presented by, for example, changing the user's focus point on the presentation device. In some embodiments at least a portion (e.g., some or all) of the originally presented content (from which the gesture was made) is also presented in order to provide visual and/or auditory context. For example, some indication of gestured text may be shown at the same time as the auxiliary content in order to show the user a correspondence between the gestured content, the next content and the auxiliary content. FIGS. 1B-1F show different examples of the many ways of presenting the next content and/or the auxiliary content in conjunction with the corresponding electronic content to maintain context.

FIG. 3.2 is an example flow diagram of example logic illustrating an example embodiment of process 3100 of FIG. 3.1. More particularly, FIG. 3.2 illustrates a process 3200 that includes the process 3100, wherein the determining a next content to be examined by the user based upon the entity and/or action identified by the user inputted gesture and/or a set of factors further comprises operations performed by or at one or more of the following block(s).

At block 3201, the process performs determining a next content by at least one of predicting based upon historical data, by looking up information, and/or based upon a statistical model. This logic may be performed, for example, by the analytics module 115 of the GBCPS 110 described with reference to FIG. 2. The GBCPS 110 may determine a next content by looking at historical data of, for example, the user, other users, the system, and the like; by looking up information, for example, stored in a persistent repository such as a data base, file, cloud storage, and the like; and/or by using any kind of statistical modeling including those that provide classifiers for interpreting new data based upon known data.

FIG. 3.3 is an example flow diagram of example logic illustrating an example embodiment of process 3200 of FIG. 3.2. More particularly, FIG. 3.3 illustrates a process 3300 that includes the process 3200, wherein the determining a next content to be examined by the user based upon the entity and/or action identified by the user inputted gesture and/or a set of factors further comprises operations performed by or at one or more of the following block(s).

At block 3301, the process performs determining a next content by predicting based upon historical data that includes at least one of user data, navigation data, data from other users similarly situated, related entity data, and/or values of the one or more of the set of factors. The GBCPS 110 may determine a next content by making predictions based upon historical data of users, navigation of the user and other users, usage, navigation, and purchase (and other) data of other users that are similar to this user, for example, those that are in the social network of the user, share the same gender, location, age, etc. In addition, the GBCPS 110 may predict a next content based upon any of the set of factors, described further elsewhere, that provide contextual information including, for example, prior history of the user, presentation device characteristics, characteristics of the gesture, etc.

FIG. 3.4 is an example flow diagram of example logic illustrating an example embodiment of process 3200 of FIG. 3.2. More particularly, FIG. 3.4 illustrates a process 3400 that includes the process 3200, wherein the determining a next content to be examined by the user based upon the entity and/or action identified by the user inputted gesture and/or a set of factors further comprises operations performed by or at one or more of the following block(s).

At block 3401, the process performs determining a next content by looking up information including at least one of user data, navigation data, data from other users similarly situated, related entity data, and/or values of the one or more of the set of factors. The GBCPS 110 may determine a next content by looking up historical data of users, navigation of the user and other users, usage, navigation, and purchase (and other) data of other users that are similar to this user, for example, those that are in the social network of the user, share the same gender, location, age, etc. In addition, the GBCPS 110 may predict a next content by looking up values any of the set of factors, described further elsewhere, that provide contextual information including, for example, prior history of the user, presentation device characteristics, characteristics of the gesture, etc.

FIG. 3.5 is an example flow diagram of example logic illustrating an example embodiment of process 3200 of FIG. 3.2. More particularly, FIG. 3.5 illustrates a process 3500 that includes the process 3200, wherein the determining a next content to be examined by the user based upon the entity and/or action identified by the user inputted gesture and/or a set of factors further comprises operations performed by or at one or more of the following block(s).

At block 3501, the process performs determining a next content by using a statistical model that indicates a likelihood of at least one of where the user is likely to navigate to, a next entity to explore based upon the identified identity, and/or a next action to perform based upon the identified action. The GBCPS 110 may determine a next content by using a statistical model of historical data of users, navigation of the user and other users, usage, navigation, and purchase (and other) data of other users that are similar to this user, for example, those that are in the social network of the user, share the same gender, location, age, etc. In addition, the GBCPS 110 may statistically determine a next content based upon any of the set of factors, described further elsewhere, that provide contextual information including, for example, prior history of the user, presentation device characteristics, characteristics of the gesture, etc.

FIG. 3.6 is an example flow diagram of example logic illustrating an example embodiment of process 3500 of FIG. 3.5. More particularly, FIG. 3.6 illustrates a process 3600 that includes the process 3500, wherein the determining a next content by using a statistical model that indicates a likelihood of at least one of where the user is likely to navigate to, a next entity to explore based upon the identified identity, and/or a next action to perform based upon the identified action further comprises operations performed by or at one or more of the following block(s).

At block 3601, the process performs determining a next content using a predictive statistical model that includes at least one of a decision tree, neural network, or Bayesian network. In some embodiments, the GBCPS 110 uses decision trees, neural networks, or Bayesian networks as a statistical model to predict the next content the user will navigate to.

FIG. 3.7 is an example flow diagram of example logic illustrating an example embodiment of process 3100 of FIG. 3.1. More particularly, FIG. 3.7 illustrates a process 3700 that includes the process 3100, wherein the determining a next content to be examined by the user based upon the entity and/or action identified by the user inputted gesture and/or a set of factors further comprises operations performed by or at one or more of the following block(s).

At block 3701, the process performs determining a next content by examination of navigation history of the user and comparing the navigation history of the user with the navigation history of other users to determine one or more likely next locations the user will navigate to. In some embodiments, the GBCPS 110 determines the next content of the user by looking at similarly situated users, based upon comparing the navigation history of this user with the navigation history of other users. For example, if some amount of other users (say a majority or over some threshold would navigate to a particular content from the current content, then the GBCPS 110 may determine that the particular content has a “x” chance of being the correct next content for this user.

FIG. 3.8 is an example flow diagram of example logic illustrating an example embodiment of process 3700 of FIG. 3.7. More particularly, FIG. 3.8 illustrates a process 3800 that includes the process 3700, wherein the determining a next content by examination of navigation history of the user and comparing the navigation history of the user with the navigation history of other users to determine one or more likely next locations the user will navigate to further comprises operations performed by or at one or more of the following block(s).

At block 3801, the process performs ranking the determined one or more likely next locations the user will navigate to in order to determine a next content. In some embodiments it is the case that more than one likely next content is determined by the GBCPS 110. In this case, it can be helpful for the GBCPS 110 to rank these by likelihood to communicate that information to possible sponsors in the next step.

FIG. 3.9 is an example flow diagram of example logic illustrating an example embodiment of process 3100 of FIG. 3.1. More particularly, FIG. 3.9 illustrates a process 3900 that includes the process 3100, wherein the determining a next content to be examined by the user based upon the entity and/or action identified by the user inputted gesture and/or a set of factors further comprises operations performed by or at one or more of the following block(s).

At block 3901, the process performs determining before receiving an indication of a subsequent gestured input by the user indicating a next content to be examined. This logic may be performed, for example, by the analytics module 115 of the GBCPS 110 described with reference to FIG. 2. The GBCPS 110 may determine the next content to be examined by the user at various times. For example, In some embodiments, the GBCPS 110 determines the next content sometime before receiving gestured input indicating the next content. Thus, the next content may be determined at times unrelated to when gestures occur. For example, the GBCPS 110 may determine that when a user indicates a product with a gesture, the next content will always be navigation to “Amazon.com” or “eBay” to purchase the product.

FIG. 3.10 is an example flow diagram of example logic illustrating an example embodiment of process 3100 of FIG. 3.1. More particularly, FIG. 3.10 illustrates a process 31000 that includes the process 3100, wherein the determining a next content to be examined by the user based upon the entity and/or action identified by the user inputted gesture and/or a set of factors further comprises operations performed by or at one or more of the following block(s).

At block 31001, the process performs determining a next content to be examined in near real-time. This logic may be performed, for example, by the analytics module 115 of the GBCPS 110 described with reference to FIG. 2. The GBCPS 110 may determine the next content to be examined by the user at various times. For example, In some embodiments, the GBCPS 110 determines the next content in near real-time, for example, as soon as it receives a gesture indicating the entity and/or action.

FIG. 3.11 is an example flow diagram of example logic illustrating an example embodiment of process 31000 of FIG. 3.10. More particularly, FIG. 3.11 illustrates a process 31100 that includes the process 31000, wherein the distributing information regarding the determined next content to one or more sponsors of auxiliary content further comprises operations performed by or at one or more of the following block(s).

At block 31101, the process performs offering the distributed information about the next content to be examined for sale or for bid. This logic may be performed, for example, by the analytics module 115 of the GBCPS 110 described with reference to FIG. 2. Especially when the next content is determined in near real-time, the GBCPS 110 may off the distributed information for sale or for bid to one or more sponsors that can near instantaneously provide auxiliary content. Pricing may be commensurate with the knowledge that the sponsor's auxiliary content is likely to be presented.

FIG. 3.12 is an example flow diagram of example logic illustrating an example embodiment of process 31100 of FIG. 3.11. More particularly, FIG. 3.12 illustrates a process 31200 that includes the process 31100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 31201, the process performs receiving an indication of a sale or bid from a selected one of the one or more sponsors. When a near real-time determination of next content takes place, and an offer for sale or bid is made to one or more sponsors ready to take advantage of the opportunity, the GBCPS 110 receives some kind of indication from one or more of the sponsors that the sale or bid is accepted, is closed, is about to close, etc.

At block 31202, the process performs determining auxiliary content associated with the indicated sale or bid. In some embodiments, the GBCPS 110 may determine the auxiliary content from those sponsors in near real-time or can consult a library of content made available at some other time by the “accepting” sponsor.

At block 31203, the process performs presenting the received auxiliary content associated with the sale or bid before the next content is about to be navigated to by the user. In any case, the GBCPS 110 can present the received auxiliary content right before the next content is about to be navigated to by the user, thereby effectuating a “just in time” type of auxiliary content sale. This might be particularly effective when the auxiliary content is an advertisement because the possible targeting could be more accurate when done in near real-time.

FIG. 3.13 is an example flow diagram of example logic illustrating an example embodiment of process 31200 of FIG. 3.12. More particularly, FIG. 3.13 illustrates a process 31300 that includes the process 31200, wherein the determining auxiliary content associated with the indicated sale or bid further comprises operations performed by or at one or more of the following block(s).

At block 31301, the process performs determining auxiliary content from a stored repository of auxiliary content received prior to the receiving the indication of the sale or bid. In some embodiments, the GBCPS 110 may determine the auxiliary content from a library of content made available at some other time by the sponsor who indicated the sale or a bid. As described elsewhere, any data structure for storage of such content may be used including a database, file, cloud storage, and the like.

FIG. 3.14 is an example flow diagram of example logic illustrating an example embodiment of process 31200 of FIG. 3.12. More particularly, FIG. 3.14 illustrates a process 31400 that includes the process 31200, wherein the presenting the received auxiliary content associated with the sale or bid before the next content is about to be navigated to by the user further comprises operations performed by or at one or more of the following block(s).

At block 31401, the process performs causing content associated with an opportunity for commercialization to be presented to the user as a just-in-time opportunity for commercialization that is presented nearly simultaneously with the gestured input. In any case, the GBCPS 110 can present the received auxiliary content right before the next content is about to be navigated to by the user, almost immediately after the gestured input, thereby effectuating a “just in time” type of opportunity for commercialization. This might be particularly effective when the opportunity for commercialization is an advertisement because the targeting could be more accurate when done in near real-time.

FIG. 3.15 is an example flow diagram of example logic illustrating an example embodiment of process 31200 of FIG. 3.12. More particularly, FIG. 3.15 illustrates a process 31500 that includes the process 31200, wherein the presenting the received auxiliary content associated with the sale or bid before the next content is about to be navigated to by the user further comprises operations performed by or at one or more of the following block(s).

At block 31501, the process performs causing an advertisement to be presented to the user as a just-in-time advertisement that is presented nearly simultaneously with the gestured input. The GBCPS 110 can present the advertisement right before the next content is about to be navigated to by the user, almost immediately after the gestured input, thereby effectuating a “just in time” type of advertising. This might be particularly effective because the targeting could be more accurate when done in near real-time.

FIG. 3.16 is an example flow diagram of example logic illustrating an example embodiment of process 31200 of FIG. 3.12. More particularly, FIG. 3.16 illustrates a process 31600 that includes the process 31200, wherein the presenting the received auxiliary content associated with the sale or bid before the next content is about to be navigated to by the user further comprises operations performed by or at one or more of the following block(s).

At block 31601, the process performs causing the received auxiliary content to be presented before an action occurs in a live event. In some embodiments, the auxiliary content can be presented right before the next content is about to be navigated to by the user, which is an action in a live event. For example, if a sports game is being displayed, and the next content is the moderator talking about one of the players, then the GBCPS 110 can present auxiliary content regarding something interesting about the player.

FIG. 3.17 is an example flow diagram of example logic illustrating an example embodiment of process 31600 of FIG. 3.16. More particularly, FIG. 3.17 illustrates a process 31700 that includes the process 31600, wherein the causing the received auxiliary content to be presented before an action occurs in a live event further comprises operations performed by or at one or more of the following block(s).

At block 31701, the process performs causing the received auxiliary content to be presented right before an action in a sports event, a competition, a game, a pre-recorded live event, and/or a simultaneous transmission of a live event. In some embodiments, the auxiliary content can be presented right before the next content is about to be navigated to by the user, which is an action in any number of current evolving situations such as a sports even, a competition (like a trivia game online), a game, a pre-recorded live event (e.g., a recording of a sports game or a concert) and/or a simultaneous transmission of a live event (e.g., a sports event, competition, concert, etc.). This allows the GBCPS 110 can to present auxiliary content of something interesting regarding the action that is about to occur.

FIG. 3.18 is an example flow diagram of example logic illustrating an example embodiment of process 3100 of FIG. 3.1. More particularly, FIG. 3.18 illustrates a process 31800 that includes the process 3100, wherein the determining a next content to be examined by the user based upon the entity and/or action identified by the user inputted gesture and/or a set of factors further comprises operations performed by or at one or more of the following block(s).

At block 31801, the process performs determining a next content based upon a set of factors including similar gestured input history of one or more other users. This logic may be performed, for example, by the analytics module 115 of the GBCPS 110 described with reference to FIG. 2 in conjunction with the factor determination module 113 of the GBCPS 110 described with reference to FIG. 2 to determine (e.g., predict, analyze, examine, evaluate, retrieve, designate, resolve, etc.) a next content based upon other users' gestured input history. For example, other users with similar profiles may have a history of navigating to a particular portal every time a product is gestured.

FIG. 3.19 is an example flow diagram of example logic illustrating an example embodiment of process 3100 of FIG. 3.1. More particularly, FIG. 3.19 illustrates a process 31900 that includes the process 3100, wherein the determining a next content to be examined by the user based upon the entity and/or action identified by the user inputted gesture and/or a set of factors further comprises operations performed by or at one or more of the following block(s).

At block 31901, the process performs determining a next content based upon a set of factors including context of other text, graphics, and/or objects within the corresponding presented content. This logic may be performed, for example, by the analytics module 115 of the GBCPS 110 described with reference to FIG. 2 in conjunction with the current context determination module 233 of the factor determination module 113 of the GBCPS 110 described with reference to FIG. 2 to determine (e.g., predict, analyze, examine, evaluate, retrieve, designate, resolve, etc.) a next content based upon context related information from the currently presented content, including other text, audio, graphics, and/or objects.

FIG. 3.20 is an example flow diagram of example logic illustrating an example embodiment of process 3100 of FIG. 3.1. More particularly, FIG. 3.20 illustrates a process 32000 that includes the process 3100, wherein the determining a next content to be examined by the user based upon the entity and/or action identified by the user inputted gesture and/or a set of factors further comprises operations performed by or at one or more of the following block(s).

At block 32001, the process performs determining a next content based upon a set of factors including an attribute of the gesture. This logic may be performed, for example, by the analytics module 115 of the GBCPS 110 described with reference to FIG. 2 in conjunction with the gesture attributes determination module 237 of the factor determination module 113 of the GBCPS 110 described with reference to FIG. 2 to determine (e.g., predict, analyze, examine, evaluate, retrieve, designate, resolve, etc.) a next content based upon attributes of the gesture itself (e.g., color, size, direction, shape, and so forth).

FIG. 3.21 is an example flow diagram of example logic illustrating an example embodiment of process 32000 of FIG. 3.20. More particularly, FIG. 3.21 illustrates a process 32100 that includes the process 32000, wherein the determining a next content based upon a set of factors including an attribute of the gesture, further comprises operations performed by or at one or more of the following block(s).

At block 32101, the process performs determining a next content based upon a set of factors including a size of the gesture. Size of the gesture may include, for example, width and/or length, and other measurements appropriate to the input device 20*.

FIG. 3.22 is an example flow diagram of example logic illustrating an example embodiment of process 32000 of FIG. 3.20. More particularly, FIG. 3.22 illustrates a process 32200 that includes the process 32000, wherein the determining a next content based upon a set of factors including an attribute of the gesture, further comprises operations performed by or at one or more of the following block(s).

At block 32201, the process performs determining a next content based upon a set of factors including a direction of the gesture. Direction of the gesture may include, for example, up or down, east or west, and other measurements or commands appropriate to the input device 20*.

FIG. 3.23 is an example flow diagram of example logic illustrating an example embodiment of process 32000 of FIG. 3.20. More particularly, FIG. 3.23 illustrates a process 32300 that includes the process 32000, wherein the determining a next content based upon a set of factors including an attribute of the gesture, further comprises operations performed by or at one or more of the following block(s).

At block 32301, the process performs determining a next content based upon a set of factors including a color of the gesture. Color of the gesture may include, for example, a pen and/or ink color as well as other measurements appropriate to the input device 20*.

FIG. 3.24 is an example flow diagram of example logic illustrating an example embodiment of process 32000 of FIG. 3.20. More particularly, FIG. 3.24 illustrates a process 32400 that includes the process 32000, wherein the determining a next content based upon a set of factors including an attribute of the gesture, further comprises operations performed by or at one or more of the following block(s).

At block 32401, the process performs determining a next content based upon a set of factors including a measure of steering of the gesture. Steering of the gesture may occur when, for example, an initial gesture is indicated (e.g., on a mobile device) and the user desires to correct or nudge it in a certain direction.

FIG. 3.25 is an example flow diagram of example logic illustrating an example embodiment of process 32400 of FIG. 3.24. More particularly, FIG. 3.25 illustrates a process 32500 that includes the process 32400, wherein the determining a next content based upon a set of factors including a measure of steering of the gesture, further comprises operations performed by or at one or more of the following block(s).

At block 32501, the process performs determining a next content based upon a steering of the gesture including smudging the input device. Smudging of the gesture may occur when, for example, an initial gesture is indicated (e.g., on a mobile device) and the user desires to correct or nudge it in a certain direction by, for example smudging the gesture using for example, a finger. This type of action may be particularly useful on a touch screen input device.

FIG. 3.26 is an example flow diagram of example logic illustrating an example embodiment of process 32400 of FIG. 3.24. More particularly, FIG. 3.26 illustrates a process 32600 that includes the process 32400, wherein the determining a next content based upon a set of factors including a measure of steering of the gesture, further comprises operations performed by or at one or more of the following block(s).

At block 32601, the process performs determining a next content based upon steering of the gesture as performed by a handheld gaming accessory. In this case the steering is performed by a handheld gaming accessory such as a particular type of input device 20*. For example, the gaming accessory may include a joy stick, a handheld controller, or the like.

FIG. 3.27 is an example flow diagram of example logic illustrating an example embodiment of process 32000 of FIG. 3.20. More particularly, FIG. 3.27 illustrates a process 32700 that includes the process 32000, wherein the determining a next content based upon a set of factors including an attribute of the gesture, further comprises operations performed by or at one or more of the following block(s).

At block 32701, the process performs determining a next content based upon a set of factors including an adjustment of the gesture. Once a gesture has been made, it may be adjusted (e.g., modified, extended, smeared, smudged, redone) by any mechanism, including, for example, adjusting the gesture itself, or, for example, by modifying what the gesture indicates, for example, using a context menu, selecting a portion of the indicated gesture, and so forth.

FIG. 3.28 is an example flow diagram of example logic illustrating an example embodiment of process 3100 of FIG. 3.1. More particularly, FIG. 3.28 illustrates a process 32800 that includes the process 3100, wherein the determining a next content to be examined by the user based upon the entity and/or action identified by the user inputted gesture and/or a set of factors further comprises operations performed by or at one or more of the following block(s).

At block 32801, the process performs determining a next content based upon a set of factors including presentation device capabilities. This logic may be performed, for example, by the analytics module 115 of the GBCPS 110 described with reference to FIG. 2 in conjunction with the system attributes determination module 234 of the factor determination module 113 of the GBCPS 110 described with reference to FIG. 2 to determine a next content based upon presentation device capabilities. Presentation device capabilities may include, for example, whether the device is connected to speakers or a network such as the Internet, the size, whether the device supports color, is a touch screen, and so forth.

FIG. 3.29 is an example flow diagram of example logic illustrating an example embodiment of process 32800 of FIG. 3.28. More particularly, FIG. 3.29 illustrates a process 32900 that includes the process 32800, wherein the determining a next content based upon a set of factors including presentation device capabilities, further comprises operations performed by or at one or more of the following block(s).

At block 32901, the process performs determining a next content based upon presentation device capabilities including the size of the presentation device. This logic may be performed, for example, by the analytics module 115 of the GBCPS 110 described with reference to FIG. 2 in conjunction with the system attributes determination module 234 of the factor determination module 113 of the GBCPS 110 described with reference to FIG. 2 to determine a next content based upon presentation device capabilities. Presentation device capabilities may include, for example, whether the device is connected to speakers or a network such as the Internet, the size of the device, whether the device supports color, is a touch screen, and so forth.

FIG. 3.30 is an example flow diagram of example logic illustrating an example embodiment of process 32800 of FIG. 3.28. More particularly, FIG. 3.30 illustrates a process 33000 that includes the process 32800, wherein the determining a next content based upon a set of factors including presentation device capabilities, further comprises operations performed by or at one or more of the following block(s).

At block 33001, the process performs determining a next content based upon presentation device capabilities including determining whether text or audio is being presented. This logic may be performed, for example, by the analytics module 115 of the GBCPS 110 described with reference to FIG. 2 in conjunction with the system attributes determination module 234 of the factor determination module 113 of the GBCPS 110 described with reference to FIG. 2 to determine a next content based upon presentation device capabilities. In addition to determining whether text or audio is being presented, presentation device capabilities may include, for example, whether the device is connected to speakers or a network such as the Internet, the size of the device, whether the device supports color, is a touch screen, and so forth.

FIG. 3.31 is an example flow diagram of example logic illustrating an example embodiment of process 3100 of FIG. 3.1. More particularly, FIG. 3.31 illustrates a process 33100 that includes the process 3100, wherein the determining a next content to be examined by the user based upon the entity and/or action identified by the user inputted gesture and/or a set of factors further comprises operations performed by or at one or more of the following block(s).

At block 33101, the process performs determining a next content based upon a set of factors including prior history associated with the user. This logic may be performed, for example, by the analytics module 115 of the GBCPS 110 described with reference to FIG. 2 in conjunction with the prior history determination module 232 of the factor determination module 113 of the GBCPS 110 described with reference to FIG. 2 to determine a next content based upon prior history associated with the user. In some embodiments, prior history may be associated with (e.g., coincident with, related to, appropriate to, etc.) the user, for example, prior purchase, navigation, or search history or demographic information.

FIG. 3.32 is an example flow diagram of example logic illustrating an example embodiment of process 33100 of FIG. 3.31. More particularly, FIG. 3.32 illustrates a process 33200 that includes the process 33100, wherein the determining a next content based upon a set of factors including prior history associated with the user, further comprises operations performed by or at one or more of the following block(s).

At block 33201, the process performs determining a next content based upon prior history including prior search history associated with the user. This logic may be performed, for example, by the analytics module 115 of the GBCPS 110 described with reference to FIG. 2 in conjunction with the prior history determination module 232 of the factor determination module 113 of the GBCPS 110 described with reference to FIG. 2 to determine a next content based upon prior search history. Factors such as what content or purchase opportunities the user has reviewed and looked for may be considered. Other factors may be considered as well.

FIG. 3.33 is an example flow diagram of example logic illustrating an example embodiment of process 33100 of FIG. 3.31. More particularly, FIG. 3.33 illustrates a process 33300 that includes the process 33100, wherein the determining a next content based upon a set of factors including prior history associated with the user, further comprises operations performed by or at one or more of the following block(s).

At block 33301, the process performs determining a next content based upon prior history including prior navigation history associated with the user. This logic may be performed, for example, by the analytics module 115 of the GBCPS 110 described with reference to FIG. 2 in conjunction with the prior history determination module 232 of the factor determination module 113 of the GBCPS 110 described with reference to FIG. 2 to determine a next content based upon prior navigation history. Factors such as what content or purchase opportunities the user has navigated to may be considered. Other factors may be considered as well.

FIG. 3.34 is an example flow diagram of example logic illustrating an example embodiment of process 33100 of FIG. 3.31. More particularly, FIG. 3.34 illustrates a process 33400 that includes the process 33100, wherein the determining a next content based upon a set of factors including prior history associated with the user, further comprises operations performed by or at one or more of the following block(s).

At block 33401, the process performs determining a next content based upon prior history including prior purchase history associated with the user. This logic may be performed, for example, by the analytics module 115 of the GBCPS 110 described with reference to FIG. 2 in conjunction with the prior history determination module 232 of the factor determination module 113 of the GBCPS 110 described with reference to FIG. 2 to determine a next content based upon prior purchase history. Factors such as what products and/or services the user has bought or considered buying (determined, for example, by what the user has viewed) may be considered. Other factors may be considered as well.

FIG. 3.35 is an example flow diagram of example logic illustrating an example embodiment of process 33100 of FIG. 3.31. More particularly, FIG. 3.35 illustrates a process 33500 that includes the process 33100, wherein the determining a next content based upon a set of factors including prior history associated with the user, further comprises operations performed by or at one or more of the following block(s).

At block 33501, the process performs determining a next content based upon prior history including demographic information associated with the user. This logic may be performed, for example, by the analytics module 115 of the GBCPS 110 described with reference to FIG. 2 in conjunction with the prior history determination module 232 of the factor determination module 113 of the GBCPS 110 described with reference to FIG. 2 to determine a next content based upon the demographic history associated with the user. Factors such as what the age, gender, location, citizenship, religious preferences (if specified) may be considered. Other factors may be considered as well.

FIG. 3.36 is an example flow diagram of example logic illustrating an example embodiment of process 33500 of FIG. 3.35. More particularly, FIG. 3.36 illustrates a process 33600 that includes the process 33500, wherein the determining a next content based upon prior history including demographic information associated with the user, further comprises operations performed by or at one or more of the following block(s).

At block 33601, the process performs determining a next content based upon demographic information including at least one of age, gender, a location associated with the user, and/or contact information associated with the user. This logic may be performed, for example, by the analytics module 115 of the GBCPS 110 described with reference to FIG. 2 in conjunction with the prior history determination module 232 of the factor determination module 113 of the GBCPS 110 described with reference to FIG. 2 to determine a next content based upon demographic information. Demographic information may include an indication of age, gender, location (known information about the user, access information about the computing system, etc.) and other contact information available, for example, from a user profile, the user's computing system, social network, etc.

FIG. 3.37 is an example flow diagram of example logic illustrating an example embodiment of process 3100 of FIG. 3.1. More particularly, FIG. 3.37 illustrates a process 33700 that includes the process 3100, wherein the determining a next content to be examined by the user based upon the entity and/or action identified by the user inputted gesture and/or a set of factors further comprises operations performed by or at one or more of the following block(s).

At block 33701, the process performs determining a next content based upon a set of factors including prior device communication history. This logic may be performed, for example, by the analytics module 115 of the GBCPS 110 described with reference to FIG. 2 in conjunction with the system attributes determination module 234 of the factor determination module 113 of the GBCPS 110 described with reference to FIG. 2 to determine a next content based device communication history. Prior device communication history may include aspects such as how often the computing system running the GBCPS 110 has been connected to the Internet, whether multiple client devices are connected to it—some times, at all times, etc., and how often the computing system is connected with various remote search capabilities.

FIG. 3.38 is an example flow diagram of example logic illustrating an example embodiment of process 3100 of FIG. 3.1. More particularly, FIG. 3.38 illustrates a process 33800 that includes the process 3100, wherein the determining a next content to be examined by the user based upon the entity and/or action identified by the user inputted gesture and/or a set of factors further comprises operations performed by or at one or more of the following block(s).

At block 33801, the process performs determining a next content based upon a set of factors including time of day. This logic may be performed, for example, by the analytics module 115 of the GBCPS 110 described with reference to FIG. 2 in conjunction with the factor determination module 113 of the GBCPS 110 described with reference to FIG. 2 to determine a next content based upon time of day. Time of day may include any type of measurement, for example, mins, hours, shifts, day, night, or the like.

FIG. 3.39 is an example flow diagram of example logic illustrating an example embodiment of process 3100 of FIG. 3.1. More particularly, FIG. 3.39 illustrates a process 33900 that includes the process 3100, wherein the determining a next content to be examined by the user based upon the entity and/or action identified by the user inputted gesture and/or a set of factors further comprises operations performed by or at one or more of the following block(s).

At block 33901, the process performs determining a next content based upon a set of factors, taking into consideration a weight associated with each factor. This logic may be performed, for example, by the analytics module 115 of the GBCPS 110 described with reference to FIG. 2 in conjunction with the factor determination module 113 of the GBCPS 110 described with reference to FIG. 2 to determine a next content based upon one or more of a set of factors. For example, In some embodiments some attributes of the gesture may be more important, hence weighted more heavily, than other attributes, such as the prior purchase history of the user. In other embodiments, other factors may have more importance that others, hence weighted more heavily. Any form of weighting, whether explicit or implicit (e.g., numeric, discreet values, adjectives, or the like) may be used.

FIG. 3.40 is an example flow diagram of example logic illustrating an example embodiment of process 3100 of FIG. 3.1. More particularly, FIG. 3.40 illustrates a process 34000 that includes the process 3100, wherein the distributing information regarding the determined next content to one or more sponsors of auxiliary content further comprises operations performed by or at one or more of the following block(s).

At block 34001, the process performs associating a confidence factor with the distributed information. This logic may be performed, for example, by the analytics module 115 of the GBCPS 110 described with reference to FIG. 2. In some embodiments, the GBCPS 110 distributes various information regarding the next content to be examined. As explained elsewhere, more than one next content may be determined, or the GBCPS 110 may have limited confidence of correctness of the prediction. In such instances, it is helpful for the GBCPS 110 to associate a confidence factor with the distributed information.

FIG. 3.41 is an example flow diagram of example logic illustrating an example embodiment of process 3100 of FIG. 3.1. More particularly, FIG. 3.41 illustrates a process 34100 that includes the process 3100, wherein the distributing information regarding the determined next content to one or more sponsors of auxiliary content further comprises operations performed by or at one or more of the following block(s).

At block 34101, the process performs distributing information that is one or more of a link, a resource descriptor, a URI, a description of the content or type of content, information regarding the user, an organization, or an event, information associated with a web site or browser. This logic may be performed, for example, by the analytics module 115 of the GBCPS 110 described with reference to FIG. 2. The GBCPS 110 may distribute information regarding the next content in any number of a variety of ways including as a link or uniform resource descriptor (URI or URL), some other type of resource descriptor (e.g., a file name or network id, a description of the content of the next content or a categorization, information regarding the user (for example, gender, age, other demographics), an organization (e.g., who is the publisher of the current content), or an event (such as the name and type of event, event specifics), and/or information associated with a web site or browser (e.g., the url, type of browser, publisher of website, etc.).

FIG. 3.42 is an example flow diagram of example logic illustrating an example embodiment of process 3100 of FIG. 3.1. More particularly, FIG. 3.42 illustrates a process 34200 that includes the process 3100, wherein the distributing information regarding the determined next content to one or more sponsors of auxiliary content further comprises operations performed by or at one or more of the following block(s).

At block 34201, the process performs distributing the information in exchange for compensation. This logic may be performed, for example, by the analytics module 115 of the GBCPS 110 described with reference to FIG. 2. In some embodiments, the GBCPS 110 distributes information for money, further reservations of time or presentation opportunities, other types of barter, or other types of compensation.

FIG. 3.43 is an example flow diagram of example logic illustrating an example embodiment of process 34200 of FIG. 3.42. More particularly, FIG. 3.43 illustrates a process 34300 that includes the process 34200, wherein the distributing the information in exchange for compensation further comprises operations performed by or at one or more of the following block(s).

At block 34301, the process performs distributing the information in exchange for compensation that comprises at least one of money, services, and/or barter. In some embodiments, the GBCPS 110 distributes information for money, further reservations of time or presentation opportunities, other types of barter, or other types of compensation.

FIG. 3.44 is an example flow diagram of example logic illustrating an example embodiment of process 3100 of FIG. 3.1. More particularly, FIG. 3.44 illustrates a process 34400 that includes the process 3100, and which further includes operations performed by or at the following block(s).

At block 34401, the process performs charging based upon a likelihood that the determined next content to be examined will be examined by the user. This logic may be performed, for example, by the analytics module 115 of the GBCPS 110 described with reference to FIG. 2. In some embodiments, the GBCPS 110 also charges the one or more sponsors it is distributing information to based upon presentation of auxiliary content associated with the sponsor, or based upon some other metric.

FIG. 3.45 is an example flow diagram of example logic illustrating an example embodiment of process 3100 of FIG. 3.1. More particularly, FIG. 3.45 illustrates a process 34500 that includes the process 3100, wherein the distributing information regarding the determined next content to one or more sponsors of auxiliary content further comprises operations performed by or at one or more of the following block(s).

At block 34501, the process performs offering the distributed information about the next content to be examined for sale or for bid. This logic may be performed, for example, by the analytics module 115 of the GBCPS 110 described with reference to FIG. 2. In some embodiments, the GBCPS 110 offers the distributed information as described elsewhere for sale to the sponsors or for bid.

FIG. 3.46 is an example flow diagram of example logic illustrating an example embodiment of process 3100 of FIG. 3.1. More particularly, FIG. 3.46 illustrates a process 34600 that includes the process 3100, wherein the distributing information regarding the determined next content to one or more sponsors of auxiliary content further comprises operations performed by or at one or more of the following block(s).

At block 34601, the process performs distributing information to an entity that provides the auxiliary content. This logic may be performed, for example, by the analytics module 115 of the GBCPS 110 described with reference to FIG. 2. In some embodiments the GBCPS 110 distributes information to a an entity (e.g., a publisher, website, manufacture, document provider, etc. or representative of same) who supplies auxiliary content via, for example, cloud storage 44, 3rd party auxiliary content 43, another device 45.

FIG. 3.47 is an example flow diagram of example logic illustrating an example embodiment of process 3100 of FIG. 3.1. More particularly, FIG. 3.47 illustrates a process 34700 that includes the process 3100, wherein the distributing information regarding the determined next content to one or more sponsors of auxiliary content further comprises operations performed by or at one or more of the following block(s).

At block 34701, the process performs distributing information to a sponsor representing an entity that provides the auxiliary content. This logic may be performed, for example, by the analytics module 115 of the GBCPS 110 described with reference to FIG. 2. In some embodiments the GBCPS 110 distributes information to a sponsor that represents a publisher, website, manufacture, document provider, etc. who supplies auxiliary content via, for example, cloud storage 44, 3rd party auxiliary content 43, another device 45.

FIG. 3.48 is an example flow diagram of example logic illustrating an example embodiment of process 3100 of FIG. 3.1. More particularly, FIG. 3.48 illustrates a process 34800 that includes the process 3100, wherein the distributing information regarding the determined next content to one or more sponsors of auxiliary content further comprises operations performed by or at one or more of the following block(s).

At block 34801, the process performs distributing information to a sponsor that receives auxiliary content from a third party. This logic may be performed, for example, by the analytics module 115 of the GBCPS 110 described with reference to FIG. 2. In some embodiments the GBCPS 110 distributes information to a sponsor that is an entity (e.g., a manufacturer, advertiser, publisher, etc.) interested in presenting the opportunity for commercialization but may not have complete access to all of the needed or desired content, or may desire content specific and/or available from a third party such an advertising server. The sponsor is responsible for receiving the auxiliary content from the third party for example through third party auxiliary content 43.

FIG. 3.49 is an example flow diagram of example logic illustrating an example embodiment of process 34800 of FIG. 3.48. More particularly, FIG. 3.49 illustrates a process 34900 that includes the process 34800, wherein the distributing information to a sponsor that receives auxiliary content from a third party further comprises operations performed by or at one or more of the following block(s).

At block 34901, the process performs receiving from the third party one or more of advertising content, a game, interactive entertainment, a computer-assisted competition, a bidding opportunity, a documentary, help text, an indication of price, textual content, an image, a video, and/or auditory content. The third party content may be advertising content, a game, interactive entertainment, a computer-assisted competition, a bidding opportunity, a documentary, help text, an indication of price, textual content, an image, a video, and/or auditory content as available via cloud storage 44, 3rd party auxiliary content 43, another device 45, and the like.

FIG. 3.50 is an example flow diagram of example logic illustrating an example embodiment of process 3100 of FIG. 3.1. More particularly, FIG. 3.50 illustrates a process 35000 that includes the process 3100, wherein the distributing information regarding the determined next content to one or more sponsors of auxiliary content further comprises operations performed by or at one or more of the following block(s).

At block 35001, the process performs distributing information to a sponsor that receives auxiliary content from a third party via a programming interface for accessing context specific content. This logic may be performed, for example, by the analytics module 115 of the GBCPS 110 described with reference to FIG. 2. In some embodiments the GBCPS 110 distributes information to a sponsor that is an entity (e.g., a manufacturer, advertiser, publisher, etc.) interested in presenting the opportunity for commercialization but may not have complete access to all of the needed or desired content, or may desire content specific and/or available from a third party such an advertising server. In this case, the sponsor may access the content through an interface such as an application programming interface.

FIG. 3.51 is an example flow diagram of example logic illustrating an example embodiment of process 35000 of FIG. 3.50. More particularly, FIG. 3.51 illustrates a process 35100 that includes the process 35000, wherein the distributing information to a sponsor that receives auxiliary content from a third party via a programming interface for accessing context specific further comprises operations performed by or at one or more of the following block(s).

At block 35101, the process performs distributing information to a sponsor that receives context specific content from a third party based at least in part on values of one or more of the set of factors. This logic may be performed, for example, by the analytics module 115 of the GBCPS 110 described with reference to FIG. 2. In some embodiments the GBCPS 110 distributes information to a sponsor that receives auxiliary content (e.g., text, images, sound, or the like that is based upon context, such as context of the user, the presentation device, the input device, the gesture, the underlying presented content, nearby sentences, phrases, words, images, sounds, or the like. In some embodiments, this context is represented by values (numeric or discrete) of one or more factors of the set of factors.

FIG. 3.52 is an example flow diagram of example logic illustrating an example embodiment of process 35000 of FIG. 3.50. More particularly, FIG. 3.52 illustrates a process 35200 that includes the process 35000, wherein the distributing information to a sponsor that receives auxiliary content from a third party via a programming interface for accessing context specific further comprises operations performed by or at one or more of the following block(s).

At block 35201, the process performs distributing information to a sponsor that receives auxiliary content from at least one of an advertising server, an advertising system, a dictionary, an encyclopedia, and/or a translation tool. This logic may be performed, for example, by the analytics module 115 of the GBCPS 110 described with reference to FIG. 2. In some embodiments the sponsor is an entity (e.g., a manufacturer, advertiser, publisher, etc.) interested in presenting the opportunity for commercialization but may not have complete access to all of the needed or desired content, or may desire content specific and/or available from a third party. The third party may be an advertising server or advertising system (e.g., a system targeted to deliver ads electronically, perhaps based upon different parameters), a dictionary, an encyclopedia or a translation tool.

FIG. 3.53 is an example flow diagram of example logic illustrating an example embodiment of process 3100 of FIG. 3.1. More particularly, FIG. 3.53 illustrates a process 35300 that includes the process 3100, wherein the distributing information regarding the determined next content to one or more sponsors of auxiliary content further comprises operations performed by or at one or more of the following block(s).

At block 35301, the process performs distributing information to one or more entities that are separate from an entity that provides the presented electronic content in order to present competing auxiliary content. This logic may be performed, for example, by the analytics module 115 of the GBCPS 110 described with reference to FIG. 2. Distributing (e.g., sending, forwarding, communicating, etc.) information to a sponsor may include distributing to two or more entities (e.g., a publishers of content, providers, advertisers, manufacturers, or the like) that compete with each other or with the entity that is the one responsible for the initial presented content. In some embodiments, the entity associated with the presented electronic content may be, for example, GBCPS 110 and the competing entity may be, for example, a third party or a competitor entity whose content is accessible through third party auxiliary content 43.

FIG. 3.54 is an example flow diagram of example logic illustrating an example embodiment of process 3100 of FIG. 3.1. More particularly, FIG. 3.54 illustrates a process 35400 that includes the process 3100, wherein the distributing information regarding the determined next content to one or more sponsors of auxiliary content further comprises operations performed by or at one or more of the following block(s).

At block 35401, the process performs distributing information to one or more sponsors that are competitors. This logic may be performed, for example, by the analytics module 115 of the GBCPS 110 described with reference to FIG. 2. Distributing (e.g., sending, forwarding, communicating, etc.) information to a sponsor may include distributing to two or more entities (e.g., a publishers of content, providers, advertisers, manufacturers, or the like) that compete with each other or with the entity that is the one responsible for the initial presented content. In some embodiments, the entity associated with the presented electronic content may be, for example, GBCPS 110 and the competing entity may be, for example, a third party or a competitor entity whose content is accessible through third party auxiliary content 43.

FIG. 3.55 is an example flow diagram of example logic illustrating an example embodiment of process 35400 of FIG. 3.54. More particularly, FIG. 3.55 illustrates a process 35500 that includes the process 35400, wherein the receiving auxiliary content from at least one of the one or more sponsors that is presented via the presentation device upon detecting that the next content to be examined has been or is about to be navigated to by the user further comprises operations performed by or at one or more of the following block(s).

At block 35501, the process performs receiving auxiliary content that provides a best match to the determined next content. This logic may be performed, for example, by the auxiliary content determination module 112 of the of the GBCPS 110 described with reference to FIG. 2. In some embodiments, the GBCPS 110 may determine what received auxiliary content provides a best match (e.g., closest in topic, location, use, price, etc.) to the determined next content.

FIG. 3.56 is an example flow diagram of example logic illustrating an example embodiment of process 35500 of FIG. 3.55. More particularly, FIG. 3.56 illustrates a process 35600 that includes the process 35500, wherein the receiving auxiliary content that provides a best match to the determined next content further comprises operations performed by or at one or more of the following block(s).

At block 35601, the process performs receiving auxiliary content that provides information that is at least one of closest in location, cheapest in price, and/or most similar in content to the determined next content. This logic may be performed, for example, by the auxiliary content determination module 112 of the of the GBCPS 110 described with reference to FIG. 2. In some embodiments, the GBCPS 110 may determine which sponsor and/or which auxiliary content offers a competing product or service that is the best match to the entity and/or action or the next content.

FIG. 3.57 is an example flow diagram of example logic illustrating an example embodiment of process 3100 of FIG. 3.1. More particularly, FIG. 3.57 illustrates a process 35700 that includes the process 3100, wherein the distributing information regarding the determined next content to one or more sponsors of auxiliary content further comprises operations performed by or at one or more of the following block(s).

At block 35701, the process performs distributing information to a sponsor that is an entity separate from an entity that provided the presented electronic content. This logic may be performed, for example, by the analytics module 115 of the GBCPS 110 described with reference to FIG. 2. Distributing (e.g., sending, forwarding, communicating, etc.) information to a sponsor may include distributing it to some other entity (e.g., a publisher of content, provider, advertiser, manufacturer, or the like) other than the one responsible for the initial presented content. In some embodiments, the entity associated with the presented electronic content may be, for example, GBCPS 110 and the sponsor may be to an entity that provides, for example, an advertisement from the auxiliary content 40. The entity separate from the entity that provided (or published) the presented electronic content may be, for example, a third party or a competitor entity whose content is accessible through third party auxiliary content 43. In some embodiments the GBCPS 110 sponsors a kind of “bidding” system whereby third party entities may vie for the information from the GBCPS 110.

FIG. 3.58 is an example flow diagram of example logic illustrating an example embodiment of process 3100 of FIG. 3.1. More particularly, FIG. 3.58 illustrates a process 35800 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 35801, the process performs receiving an indication of at least one advertisement as the auxiliary content. This logic may be performed, for example, by the auxiliary content determination module 112 of the of the GBCPS 110 described with reference to FIG. 2. In some embodiments the advertisement may be provided by a remote tool or application connected via the network 30 to the GBCPS 110 such as a third party advertising system (e.g. system 43) or server. The advertisement may be any type of electronic advertisement including for example, text, images, sound, etc. Advertisements may be supplied directly or indirectly as indicators to advertisements that can be served by server computing systems.

FIG. 3.59 is an example flow diagram of example logic illustrating an example embodiment of process 35800 of FIG. 3.58. More particularly, FIG. 3.59 illustrates a process 35900 that includes the process 35800, wherein the receiving an indication of at least one advertisement as the auxiliary content further comprises operations performed by or at one or more of the following block(s).

At block 35901, the process performs receiving a selection of the at least one advertisement from a plurality of advertisements as the auxiliary content. This logic may be performed, for example, by the auxiliary content determination module 112 of the of the GBCPS 110 described with reference to FIG. 2. The advertisement may be a direct or indirect indication of an advertisement that is somehow related to the entity and/or action indicated by the indicated portion of the gesture. When a third party server, such as a third party advertising system, is used to supply the auxiliary content, a plurality of advertisements may be delivered (e.g., forwarded, sent, communicated, etc.) to the GBCPS 110 before being presented by the GBCPS 110.

FIG. 3.60 is an example flow diagram of example logic illustrating an example embodiment of process 35800 of FIG. 3.58. More particularly, FIG. 3.60 illustrates a process 36000 that includes the process 35800, wherein the receiving an indication of at least one advertisement as the auxiliary content further comprises operations performed by or at one or more of the following block(s).

At block 36001, the process performs receiving an advertisement that comprises textual, image, and/or auditory content. This logic may be performed, for example, by the auxiliary content determination module 112 of the of the GBCPS 110 described with reference to FIG. 2. For example, In some embodiments, the receiving an indication of at least one advertisement as the auxiliary content may be an image with or without text, a video, a data stream of any sort, or audio clips.

FIG. 3.61 is an example flow diagram of example logic illustrating an example embodiment of process 3100 of FIG. 3.1. More particularly, FIG. 3.61 illustrates a process 36100 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 36101, the process performs receiving an indication of interactive entertainment as the auxiliary content. This logic may be performed, for example, by the auxiliary content determination module 112 of the of the GBCPS 110 described with reference to FIG. 2. The interactive entertainment may include, for example, a computer game, an on-line quiz show, a lottery, a movie to watch, and so forth.

FIG. 3.62 is an example flow diagram of example logic illustrating an example embodiment of process 3100 of FIG. 3.1. More particularly, FIG. 3.62 illustrates a process 36200 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 36201, the process performs receiving an indication of a role-playing game as the auxiliary content. This logic may be performed, for example, by the auxiliary content determination module 112 of the of the GBCPS 110 described with reference to FIG. 2. A role-playing game may include, for example, an online multi-player role playing game.

FIG. 3.63 is an example flow diagram of example logic illustrating an example embodiment of process 3100 of FIG. 3.1. More particularly, FIG. 3.63 illustrates a process 36300 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 36301, the process performs receiving an indication of at least one of a computer-assisted competition and/or a bidding opportunity as the auxiliary content. This logic may be performed, for example, by the auxiliary content determination module 112 of the of the GBCPS 110 described with reference to FIG. 2. The bidding opportunity, for example, a competition or gambling event, etc., may be computer based, computer-assisted, and/or manual. For example, In some embodiments, the GBCPS 110 may offer a mechanism whereby one or more entities can bid on particular product and/or service indicated by keywords similar to opportunities offered by search engines, or by gesturelets. In the latter case, a opportunity for commercialization may be associated with a given gesturelet based upon some kind of “best match” algorithm. In other embodiments, bidding may be implemented by matching a opportunity for commercialization to an image or audio representation using, for example, pattern matching.

FIG. 3.64 is an example flow diagram of example logic illustrating an example embodiment of process 3100 of FIG. 3.1. More particularly, FIG. 3.64 illustrates a process 36400 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 36401, the process performs receiving an indication of a purchase and/or an offer as the auxiliary content. The purchase or offer may take any form, for example, a book advertisement, or a web page, and may be for products and/or services.

FIG. 3.65 is an example flow diagram of example logic illustrating an example embodiment of process 36400 of FIG. 3.64. More particularly, FIG. 3.65 illustrates a process 36500 that includes the process 36400, wherein the receiving an indication of a purchase and/or an offer as the auxiliary content further comprises operations performed by or at one or more of the following block(s).

At block 36501, the process performs receiving at least one of information, an item for sale, a service for offer and/or a service for sale, a prior purchase of the user, and/or a current purchase. Any type of information, item, or service (online or offline, machine generated or human generated) can be offered and/or purchased in this manner. If human generated, the advertisement may be to a computer representation of the human generated service, for example, a contract or a calendar entry, or the like.

FIG. 3.66 is an example flow diagram of example logic illustrating an example embodiment of process 36400 of FIG. 3.64. More particularly, FIG. 3.66 illustrates a process 36600 that includes the process 36400, wherein the receiving an indication of a purchase and/or an offer as the auxiliary content further comprises operations performed by or at one or more of the following block(s).

At block 36601, the process performs receiving the indication of the purchase and/or the offer from an entity that is part of a social network of the user. The purchase may be related to (e.g., associated with, directed to, mentioned by, a contact directly or indirectly related to, etc.) someone that belongs to a social network associated with the user, for example through the one or more networks 30.

FIG. 3.67 is an example flow diagram of example logic illustrating an example embodiment of process 3100 of FIG. 3.1. More particularly, FIG. 3.67 illustrates a process 36700 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 36701, the process performs causing the received auxiliary content to be presented as a visual overlay on a portion of the presented electronic content. This logic may be performed, for example, by the presentation module 114 of the GBCPS 110 described with reference to FIG. 2. The overlay may be in any form including a pane, window, menu, dialog, frame, etc. and may partially or totally obscure the underlying presented content.

FIG. 3.68 is an example flow diagram of example logic illustrating an example embodiment of process 36700 of FIG. 3.67. More particularly, FIG. 3.68 illustrates a process 36800 that includes the process 36700, wherein the causing the received auxiliary content to be presented as a visual overlay on a portion of the presented electronic content, further comprises operations performed by or at one or more of the following block(s).

At block 36801, the process performs making the visual overlay visible using animation techniques. This logic may be performed, for example, by the presentation module 114 of the GBCPS 110 described with reference to FIG. 2. Animation techniques may include any type of animation technique appropriate for the presentation, including, for example, moving a presentation construct from one portion of a presentation device to another, zooming, wiggling, vibrating, giving the appearance of flying, other types of movement, and the like. The animation techniques may include leaving trailing footprint information (e.g., artifacts) for the user to enhance the detection and/or appearance of the animation, may be of varying speeds, involve different shapes, sounds, color, or the like.

FIG. 3.69 is an example flow diagram of example logic illustrating an example embodiment of process 36700 of FIG. 3.67. More particularly, FIG. 3.69 illustrates a process 36900 that includes the process 36700, wherein the causing the received auxiliary content to be presented as a visual overlay on a portion of the presented electronic content further comprises operations performed by or at one or more of the following block(s).

At block 36901, the process performs causing the overlay to appear to slide from one side of the presentation device onto the presented content. This logic may be performed, for example, by the presentation module 114 of the GBCPS 110 described with reference to FIG. 2. The overlay may be a window, frame, popup, dialog box, or any other presentation construct that may be made gradually more visible as it is moved into the visible presentation area. FIGS. 1D1-1D8 and 1E1-1E2 show examples of such animation. Once there, the presentation construct may obscure, not obscure, or partially obscure the other presented content. Sliding may include moving smoothly or not. The side of the presentation device may be the physical edge or a virtual edge.

FIG. 3.70 is an example flow diagram of example logic illustrating an example embodiment of process 36900 of FIG. 3.69. More particularly, FIG. 3.70 illustrates a process 37000 that includes the process 36900, wherein the causing the overlay to appear to slide from one side of the presentation device onto the presented content further comprises operations performed by or at one or more of the following block(s).

At block 37001, the process performs displaying sliding artifacts to demonstrate that the overlay is sliding. This logic may be performed, for example, by the presentation module 114 of the GBCPS 110 described with reference to FIG. 2. In some embodiments the process includes showing artifacts as the overlay is sliding into place in order to illustrate movement. Artifacts may be portions or edges of the overlay, repeated as the overlay is moved, such as those shown in FIGS. 1C and 1D1-1D8.

FIG. 3.71 is an example flow diagram of example logic illustrating an example embodiment of process 36700 of FIG. 3.67. More particularly, FIG. 3.71 illustrates a process 37100 that includes the process 36700, wherein the causing the received auxiliary content to be presented as a visual overlay on a portion of the presented electronic content further comprises operations performed by or at one or more of the following block(s).

At block 37101, the process performs presenting the overlay as a rectangular overlay. This logic may be performed, for example, by the presentation module 114 of the GBCPS 110 described with reference to FIG. 2. In some embodiments the overlay is shaped as a rectangle.

FIG. 3.72 is an example flow diagram of example logic illustrating an example embodiment of process 36700 of FIG. 3.67. More particularly, FIG. 3.72 illustrates a process 37200 that includes the process 36700, wherein the causing the received auxiliary content to be presented as a visual overlay on a portion of the presented electronic content further comprises operations performed by or at one or more of the following block(s).

At block 37201, the process performs presenting the overlay as a non-rectangular overlay. This logic may be performed, for example, by the presentation module 114 of the GBCPS 110 described with reference to FIG. 2. In some embodiments the overlay is shaped as a rectangle.

FIG. 3.73 is an example flow diagram of example logic illustrating an example embodiment of process 36700 of FIG. 3.67. More particularly, FIG. 3.73 illustrates a process 37300 that includes the process 36700, wherein the causing the received auxiliary content to be presented as a visual overlay on a portion of the presented electronic content further comprises operations performed by or at one or more of the following block(s).

At block 37301, the process performs presenting the overlay in a manner that resembles the shape of the entity and/or action. This logic may be performed, for example, by the presentation module 114 of the GBCPS 110 described with reference to FIG. 2. In some embodiments the overlay is shaped to approximately or partially follow the contour of the gestured representation of the product and/or service. For example, if the representation is a product image, the overlay may have edges that follow the contour of product displayed in the image.

FIG. 3.74 is an example flow diagram of example logic illustrating an example embodiment of process 36700 of FIG. 3.67. More particularly, FIG. 3.74 illustrates a process 37400 that includes the process 36700, wherein the causing the received auxiliary content to be presented as a visual overlay on a portion of the presented electronic content further comprises operations performed by or at one or more of the following block(s).

At block 37401, the process performs presenting the overlay as a transparent overlay. This logic may be performed, for example, by the presentation module 114 of the GBCPS 110 described with reference to FIG. 2. In some embodiments the overlay is implemented to be transparent so that some portion or all of the content under the overlay shows through. Transparency techniques such as bitblt filters may be used.

FIG. 3.75 is an example flow diagram of example logic illustrating an example embodiment of process 36700 of FIG. 3.67. More particularly, FIG. 3.75 illustrates a process 37500 that includes the process 36700, wherein the causing the received auxiliary content to be presented as a visual overlay on a portion of the presented electronic content further comprises operations performed by or at one or more of the following block(s).

At block 37501, the process performs presenting the background of the overlay as a different color than the background of the portion of the corresponding presented electronic content. This logic may be performed, for example, by the presentation module 114 of the GBCPS 110 described with reference to FIG. 2. In some embodiments the background (e.g., what lies beneath and around the image or text displayed in the overlay) is a different color so that is potentially easier to distinguish from the presented content, such as the indication of the gestured input.

FIG. 3.76 is an example flow diagram of example logic illustrating an example embodiment of process 36700 of FIG. 3.67. More particularly, FIG. 3.76 illustrates a process 37600 that includes the process 36700, wherein the causing the received auxiliary content to be presented as a visual overlay on a portion of the presented electronic content further comprises operations performed by or at one or more of the following block(s).

At block 37601, the process performs presenting the overlay as appearing to occupy only a portion of a presentation construct used to present the corresponding presented electronic content. This logic may be performed, for example, by the presentation module 114 of the GBCPS 110 described with reference to FIG. 2. The portion occupied may be a small or large area of the presentation construct (e.g., window, frame, pane, or dialog box) and may be some or all of the presentation construct.

FIG. 3.77 is an example flow diagram of example logic illustrating an example embodiment of process 36700 of FIG. 3.67. More particularly, FIG. 3.77 illustrates a process 37700 that includes the process 36700, wherein the causing the received auxiliary content to be presented as a visual overlay on a portion of the presented electronic content further comprises operations performed by or at one or more of the following block(s).

At block 37701, the process performs constructing the overlay at least in part from information from a social network associated with the user. This logic may be performed, for example, by the presentation module 114 of the GBCPS 110 described with reference to FIG. 2. For example, the overlay may be colored, shaped, or the type of overlay or layout chosen based upon preferences of the user noted in the user's social network or preferred by the user's contacts in the user's social network.

FIG. 3.78 is an example flow diagram of example logic illustrating an example embodiment of process 3100 of FIG. 3.1. More particularly, FIG. 3.78 illustrates a process 37800 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 37801, the process performs causing the received auxiliary content to be presented in at least one of an auxiliary window, pane, frame, and/or other auxiliary presentation construct. This logic may be performed, for example, by the presentation module 114 of the GBCPS 110 described with reference to FIG. 2. Once generated, the auxiliary presentation construct may be presented in an animated fashion, overlaid upon other content, placed non-contiguously or juxtaposed to other content. See, for example, FIG. 1F.

FIG. 3.79 is an example flow diagram of example logic illustrating an example embodiment of process 37800 of FIG. 3.78. More particularly, FIG. 3.79 illustrates a process 37900 that includes the process 37800, wherein the causing the received auxiliary content to be presented in at least one of an auxiliary window, pane, frame, and/or other auxiliary presentation construct further comprises operations performed by or at one or more of the following block(s).

At block 37901, the process performs causing the received auxiliary content to be presented in an auxiliary presentation construct separated from the corresponding presented electronic content. For example, the auxiliary content may be presented in a separate window or frame to enable the user to see the original content in addition to the auxiliary content (such as an advertisement). See, for example, FIG. 1F. The separate construct may be overlaid or completely distant and distinct from the presented electronic content.

FIG. 3.80 is an example flow diagram of example logic illustrating an example embodiment of process 37800 of FIG. 3.78. More particularly, FIG. 3.80 illustrates a process 38000 that includes the process 37800, wherein the causing the received auxiliary content to be presented in at least one of an auxiliary window, pane, frame, and/or other auxiliary presentation construct further comprises operations performed by or at one or more of the following block(s).

At block 38001, the process performs causing the received auxiliary content to be presented in an auxiliary presentation construct juxtaposed to the corresponding presented electronic content. For example, the auxiliary content may be presented in a separate window or frame to enable the user to see the original content alongside the auxiliary content (such as an advertisement). See, for example, FIG. 1F.

FIG. 3.81 is an example flow diagram of example logic illustrating an example embodiment of process 3100 of FIG. 3.1. More particularly, FIG. 3.81 illustrates a process 38100 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 38101, the process performs causing the received auxiliary content to be presented based upon a social network associated with the user. This logic may be performed, for example, by the presentation module 114 of the GBCPS 110 described with reference to FIG. 2. For example, the type and or content presentation may be selected based upon preferences of the user noted in the user's social network or those preferred by the user's contacts in the user's social network. For example, if the user's “friends” insist on all advertisements being shown in separate windows, then the auxiliary content presented to this user may be shown (by default) that way as well.

FIG. 3.82 is an example flow diagram of example logic illustrating an example embodiment of process 3100 of FIG. 3.1. More particularly, FIG. 3.82 illustrates a process 38200 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 38201, the process performs receiving auxiliary content by receiving at least one of a location, a pointer, a symbol, and/or another type of reference to auxiliary content. This logic may be performed, for example, by the auxiliary content determination module 112 of the of the GBCPS 110 described with reference to FIG. 2. The logic may be performed by any one of the submodules. In this case, the indication is one of a location, a pointer, a symbol, (e.g., an absolute or relative location, a location in memory locally or remotely, or the like) intended to enable the GBNS to find, obtain, or locate the opportunity for commercialization in order to cause it to be presented.

FIG. 3.83 is an example flow diagram of example logic illustrating an example embodiment of process 3100 of FIG. 3.1. More particularly, FIG. 3.83 illustrates a process 38300 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 38301, the process performs receiving auxiliary content by receiving at least one of a word, a phrase, an utterance, an image, a video, a pattern, and/or an audio signal. The logic may be performed by any one of the modules of the GBCPS 110. For example, the auxiliary content determination module 112 of the of the GBCPS 110 described with reference to FIG. 2 may determine the opportunity for commercialization (e.g., an advertisement, web page, or the like) and return an indication in the form of a word, phrase, utterance (e.g., a sound not necessarily comprehensible as a word), image, video, pattern, or audio signal.

FIG. 3.84 is an example flow diagram of example logic illustrating an example embodiment of process 3100 of FIG. 3.1. More particularly, FIG. 3.84 illustrates a process 38400 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 38401, the process performs receiving an indication of a user inputted gesture that identifies an entity and/or action that is a product and/or service. This logic may be performed, for example, by the input module 111 of the GBCPS 110 described with reference to FIG. 2. For example, the indicated portion may identify a product or service that can be used to determine to what next content the user may browse.

FIG. 3.85 is an example flow diagram of example logic illustrating an example embodiment of process 3100 of FIG. 3.1. More particularly, FIG. 3.85 illustrates a process 38500 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 38501, the process performs receiving an indication of a user inputted gesture that identifies an entity and/or action that is a request from a not-for-profit organization. This logic may be performed, for example, by the input module 111 of the GBCPS 110 described with reference to FIG. 2. In some embodiments, the entity and/or action may be a request from a not-for-profit organization such as a church, charity, club, etc. For example, the entity and/or action may be a request for a donation, invitation to membership, or the like.

FIG. 3.86 is an example flow diagram of example logic illustrating an example embodiment of process 3100 of FIG. 3.1. More particularly, FIG. 3.86 illustrates a process 38600 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 38601, the process performs receiving an indication of a user inputted gesture that identifies an entity and/or action that is a person, place, or thing. This logic may be performed, for example, by the input module 111 of the GBCPS 110 described with reference to FIG. 2. For example, the indicated portion may identify any type of person (e.g., alive or dead), any type of place (e.g., location), or any type of thing (e.g., a named or unnamed object).

FIG. 3.87 is an example flow diagram of example logic illustrating an example embodiment of process 3100 of FIG. 3.1. More particularly, FIG. 3.87 illustrates a process 38700 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 38701, the process performs receiving an indication of a user inputted gesture that corresponds to an indicated portion of the electronic content that contains text for identifying the entity and/or action. This logic may be performed, for example, by the input module 111 of the GBCPS 110 described with reference to FIG. 2. For example, the indicated portion may include a picture of a product or service along with a description of the good and/or service, including for example, a price, location, quantity, descriptors (e.g., color, size, etc.), or the like.

FIG. 3.88 is an example flow diagram of example logic illustrating an example embodiment of process 3100 of FIG. 3.1. More particularly, FIG. 3.88 illustrates a process 38800 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 38801, the process performs receiving an indication of a user inputted gesture that corresponds to an indicated portion of the electronic content that contains an image for identifying the entity and/or action. This logic may be performed, for example, by the input module 111 of the GBCPS 110 described with reference to FIG. 2. For example, the indicated portion may include a picture that shows attributes of the product and/or service such as color, size, location, brand, availability, rating, and the like.

FIG. 3.89 is an example flow diagram of example logic illustrating an example embodiment of process 3100 of FIG. 3.1. More particularly, FIG. 3.89 illustrates a process 38900 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 38901, the process performs receiving an indication of a user inputted gesture that corresponds to an indicated portion of the electronic content that contains audio for identifying the entity and/or action. This logic may be performed, for example, by the input module 111 of the GBCPS 110 described with reference to FIG. 2. For example, the indicated portion may include an audio clip related to the product for example, an explanation of the product and/or service such as how to use it, testimonials, or the like.

FIG. 3.90 is an example flow diagram of example logic illustrating an example embodiment of process 3100 of FIG. 3.1. More particularly, FIG. 3.90 illustrates a process 39000 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 39001, the process performs presenting the auxiliary content as a portion of the next content. This logic may be performed, for example, by the presentation module 114 of the GBCPS 110 described with reference to FIG. 2. In some embodiments the GBCPS 110 presents the auxiliary content within the context of the next content so that the auxiliary content appears to be integrated. For example, the auxiliary content may be presented as part of a document, image, web site, audio recording, etc.

FIG. 3.91 is an example flow diagram of example logic illustrating an example embodiment of process 3100 of FIG. 3.1. More particularly, FIG. 3.91 illustrates a process 39100 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 39101, the process performs presenting the auxiliary content as a portion of a web site. This logic may be performed, for example, by the presentation module 114 of the GBCPS 110 described with reference to FIG. 2. In some embodiments the GBCPS 110 presents the auxiliary content within the context of a website, so that the auxiliary content appears to be associated with the web site.

FIG. 3.92 is an example flow diagram of example logic illustrating an example embodiment of process 3100 of FIG. 3.1. More particularly, FIG. 3.92 illustrates a process 39200 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 39201, the process performs presenting the auxiliary content as a part of an electronic document. This logic may be performed, for example, by the presentation module 114 of the GBCPS 110 described with reference to FIG. 2. In some embodiments the GBCPS 110 presents the auxiliary content within the context of a document, so that the auxiliary content appears to be associated with the document.

FIG. 3.93 is an example flow diagram of example logic illustrating an example embodiment of process 3100 of FIG. 3.1. More particularly, FIG. 3.93 illustrates a process 39300 that includes the process 3100, wherein the receiving auxiliary content from at least one of the one or more sponsors that is presented via the presentation device upon detecting that the next content to be examined has been or is about to be navigated to by the user further comprises operations performed by or at one or more of the following block(s).

At block 39301, the process performs presenting the auxiliary content as at least one of an image, text, and/or an utterance. This logic may be performed, for example, by the presentation module 114 of the GBCPS 110 described with reference to FIG. 2. For example, the auxiliary content may include a picture of a product or service along with a description of the good and/or service, including for example, a price, location, quantity, descriptors (e.g., color, size, etc.), or the like. Also, the auxiliary content may include a picture that shows attributes of the product and/or service such as color, size, location, brand, availability, rating, and the like. Or, auxiliary content may include an audio clip related to the product for example, an explanation of the product and/or service such as how to use it, testimonials, or the like.

FIG. 3.94 is an example flow diagram of example logic illustrating an example embodiment of process 3100 of FIG. 3.1. More particularly, FIG. 3.94 illustrates a process 39400 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 39401, the process performs receiving a first user inputted gesture that approximates a circle shape. This logic may be performed, for example, by the device handlers 212 of the input module 111 of the GBCPS 110 described with reference to FIG. 2 to detect whether a received gesture is in a form that approximates a circle shape.

FIG. 3.95 is an example flow diagram of example logic illustrating an example embodiment of process 3100 of FIG. 3.1. More particularly, FIG. 3.95 illustrates a process 39500 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 39501, the process performs receiving a first user inputted gesture that approximates an oval shape. This logic may be performed, for example, by the device handlers 212 of the input module 111 of the GBCPS 110 described with reference to FIG. 2 to detect whether a received gesture is in a form that approximates an oval shape

FIG. 3.96 is an example flow diagram of example logic illustrating an example embodiment of process 3100 of FIG. 3.1. More particularly, FIG. 3.96 illustrates a process 39600 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 39601, the process performs receiving a first user inputted gesture that approximates a closed path. This logic may be performed, for example, by the device handlers 212 of the input module 111 of the GBCPS 110 described with reference to FIG. 2 to detect whether a received gesture is in a form that approximates a closed path of points and/or line segments.

FIG. 3.97 is an example flow diagram of example logic illustrating an example embodiment of process 3100 of FIG. 3.1. More particularly, FIG. 3.97 illustrates a process 39700 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 39701, the process performs receiving a first user inputted gesture that approximates a polygon. This logic may be performed, for example, by the device handlers 212 of the input module 111 of the GBCPS 110 described with reference to FIG. 2 to detect whether a received gesture is in a form that approximates a polygon.

FIG. 3.98 is an example flow diagram of example logic illustrating an example embodiment of process 3100 of FIG. 3.1. More particularly, FIG. 3.98 illustrates a process 39800 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 39801, the process performs receiving an audio gesture. This logic may be performed, for example, by the gesture input detection and resolution module 210 of the input module 111 of the GBCPS 110 described with reference to FIG. 2 to detect whether a received gesture is an audio gesture, such as received via audio device, microphone 20b.

FIG. 3.99 is an example flow diagram of example logic illustrating an example embodiment of process 39800 of FIG. 3.98. More particularly, FIG. 3.99 illustrates a process 39900 that includes the process 39800, wherein the receiving an audio gesture further comprises operations performed by or at one or more of the following block(s).

At block 39901, the process performs receiving an audio gesture that is an uttered word, phrase, or sound. This logic may be performed, for example, by the gesture input detection and resolution module 210 of the input module 111 of the GBCPS 110 described with reference to FIG. 2 to detect whether a received audio gesture, such as received via audio device, microphone 20b, indicates (e.g., designates or otherwise selects) a word or phrase indicating some portion of the presented content.

FIG. 3.100 is an example flow diagram of example logic illustrating an example embodiment of process 39800 of FIG. 3.98. More particularly, FIG. 3.100 illustrates a process 310000 that includes the process 39800, wherein the receiving an audio gesture further comprises operations performed by or at one or more of the following block(s).

At block 310001, the process performs receiving an audio gesture that specifies a direction. This logic may be performed, for example, by the gesture input detection and resolution module 210 of the input module 111 of the GBCPS 110 described with reference to FIG. 2 to detect whether a direction received from an audio input device, such as audio input device 20b. The direction may be a single letter, number, word, phrase, or any type of instruction or indication of where to move a cursor or locator device.

FIG. 3.101 is an example flow diagram of example logic illustrating an example embodiment of process 39800 of FIG. 3.98. More particularly, FIG. 3.101 illustrates a process 310100 that includes the process 39800, wherein the receiving an audio gesture further comprises operations performed by or at one or more of the following block(s).

At block 310101, the process performs receiving an audio gesture by at least one of a mouse, a touch sensitive display, a wireless device, a human body part, a microphone, a stylus, and/or a pointer. This logic may be performed, for example, by the gesture input detection and resolution module 210 of the input module 111 of the GBCPS 110 described with reference to FIG. 2 to detect and resolve audio gesture input from, for example, devices 20*.

FIG. 3.102 is an example flow diagram of example logic illustrating an example embodiment of process 3100 of FIG. 3.1. More particularly, FIG. 3.102 illustrates a process 310200 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 310201, the process performs receiving the indication of the user inputted gestured from an input device that comprises at least one of a mouse, a touch sensitive display, a wireless device, a human body part, a microphone, a stylus, and/or a pointer. This logic may be performed, for example, by the specific device handlers 212 of the input module 111 of the GBCPS 110 described with reference to FIG. 2 to detect and resolve gesture input from, for example, devices 20*. Other input devices may also be accommodated. Wireless devices may include devices such as cellular phones, notebooks, mobile devices, tablets, computers, remote controllers, and the like. Human body parts may include, for example, a head, a finger, an arm, a leg, and the like, especially useful for those challenged to provide gestures by other means. Touch sensitive displays may include, for example, touch sensitive screens that are part of other devices (e.g., in a computer or in a phone) or that are standalone devices.

FIG. 3.103 is an example flow diagram of example logic illustrating an example embodiment of process 3100 of FIG. 3.1. More particularly, FIG. 3.103 illustrates a process 310300 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 310301, the process performs receiving a user inputted gesture that corresponds to an indicated portion of electronic content presented via a browser. This logic may be performed, for example, by the specific device handlers 212 of the input module 111 of the GBCPS 110 described with reference to FIG. 2.

FIG. 3.104 is an example flow diagram of example logic illustrating an example embodiment of process 3100 of FIG. 3.1. More particularly, FIG. 3.104 illustrates a process 310400 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 310401, the process performs receiving a user inputted gesture that corresponds to an indicated portion of electronic content presented via at least one of a mobile device, a hand-held device, a device embedded as part of the computing system, and/or a remote device associated with the computing system. This logic may be performed, for example, by the specific device handlers 212 of the input module 111 of the GBCPS 110 described with reference to FIG. 2.

FIG. 3.105 is an example flow diagram of example logic illustrating an example embodiment of process 3100 of FIG. 3.1. More particularly, FIG. 3.105 illustrates a process 310500 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 310501, the process performs receiving a user inputted gesture that corresponds to an indicated portion of electronic content presented via at least one of a speaker, electronic reader, or a Braille printer. This logic may be performed, for example, by the specific device handlers 212 of the input module 111 of the GBCPS 110 described with reference to FIG. 2.

FIG. 3.106 is an example flow diagram of example logic illustrating an example embodiment of process 3100 of FIG. 3.1. More particularly, FIG. 3.106 illustrates a process 310600 that includes the process 3100, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises operations performed by or at one or more of the following block(s).

At block 310601, the process performs receiving a user inputted gesture that corresponds to an indicated portion of electronic content presented via a presentation device associated with at least one of a computer, notebook, tablet, wireless device, cellular phone, mobile device, hand-held device, electronic control panel, electronic display, electronic appliance, and/or wired device. This logic may be performed, for example, by the input module 111 of the GBCPS 110 described with reference to FIG. 2. In some embodiments, the electronic control panel, display, or appliance may include interfaces provided on house-hold type appliances such as a refrigerator or television, or work type appliances such as a copier, scanner, etc.

FIG. 3.107 is an example flow diagram of example logic illustrating an example embodiment of process 3100 of FIG. 3.1. More particularly, FIG. 3.107 illustrates a process 310700 that includes the process 3100, and which further includes operations performed by or at the following block(s).

At block 310701, the process performs performing the method by a client. As described elsewhere, a client may be hardware, software, or firmware, physical or virtual, and may be part or the whole of a computing system. A client may be an application or a device.

FIG. 3.108 is an example flow diagram of example logic illustrating an example embodiment of process 3100 of FIG. 3.1. More particularly, FIG. 3.108 illustrates a process 310800 that includes the process 3100, and which further includes operations performed by or at the following block(s).

At block 310801, the process performs performing the method by a server. As described elsewhere, a server may be hardware, software, or firmware, physical or virtual, and may be part or the whole of a computing system. A server may be service as well as a system.

### Example Computing System

FIG. 4 is an example block diagram of an example computing system for practicing embodiments of a Gesture Based Content Presentation System as described herein. Note that a general purpose or a special purpose computing system suitably instructed may be used to implement an GBCPS, such as GBCPS 110 of FIG. 1G. Further, the GBCPS may be implemented in software, hardware, firmware, or in some combination to achieve the capabilities described herein.

The computing system 100 may comprise one or more server and/or client computing systems and may span distributed locations. In addition, each block shown may represent one or more such blocks as appropriate to a specific embodiment or may be combined with other blocks. Moreover, the various blocks of the GBCPS 110 may physically reside on one or more machines, which use standard (e.g., TCP/IP) or proprietary interprocess communication mechanisms to communicate with each other.

In the embodiment shown, computer system 100 comprises a computer memory (“memory”) 101, a display 402, one or more Central Processing Units (“CPU”) 403, Input/Output devices 404 (e.g., keyboard, mouse, CRT or LCD display, etc.), other computer-readable media 405, and one or more network connections 406. The GBCPS 110 is shown residing in memory 101. In other embodiments, some portion of the contents, some of, or all of the components of the GBCPS 110 may be stored on and/or transmitted over the other computer-readable media 405. The components of the GBCPS 110 preferably execute on one or more CPUs 403 and manage providing auxiliary content, as described herein. Other code or programs 430 and potentially other data stores, such as data repository 420, also reside in the memory 101, and preferably execute on one or more CPUs 403. Of note, one or more of the components in FIG. 4 may not be present in any specific implementation. For example, some embodiments embedded in other software may not provide means for user input or display.

In a typical embodiment, the GBCPS 110 includes one or more input modules 111, one or more auxiliary content determination modules 112, one or more factor determination modules 113, and one or more presentation modules 114. In at least some embodiments, some data is provided external to the GBCPS 110 and is available, potentially, over one or more networks 30. Other and/or different modules may be implemented. In addition, the GBCPS 110 may interact via a network 30 with application or client code 455 that can absorb auxiliary content results or indicated gesture information, for example, for other purposes, one or more client computing systems or client devices 20*, and/or one or more third-party content provider systems 465, such as third party advertising systems or other purveyors of auxiliary content. Also, of note, the history data repository 44 may be provided external to the GBCPS 110 as well, for example in a knowledge base accessible over one or more networks 30.

In an example embodiment, components/modules of the GBCPS 110 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an GBCPS implementation.

In addition, programming interfaces to the data stored as part of the GBCPS 110 (e.g., in the data repositories 44 and 41) can be available by standard means such as through C, C++, C#, Visual Basic.NET and Java APIs; libraries for accessing files, databases, or other data repositories; through scripting languages such as XML; or through Web servers, FTP servers, or other types of servers providing access to stored data. The repositories 44 and 41 may be implemented as one or more database systems, file systems, or any other method known in the art for storing such information, or any combination of the above, including implementation using distributed computing techniques.

Also the example GBCPS 110 may be implemented in a distributed environment comprising multiple, even heterogeneous, computer systems and networks. Different configurations and locations of programs and data are contemplated for use with techniques of described herein. In addition, the server and/or client components may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an GBCPS.

Furthermore, in some embodiments, some or all of the components of the GBCPS 110 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, are incorporated herein by reference, in their entireties.

From the foregoing it will be appreciated that, although specific embodiments have been described herein for purposes of illustration, various modifications may be made without deviating from the spirit and scope of the claims. For example, the methods and systems for providing browsing or navigation futures for presenting auxiliary content in a gesture-based user interface discussed herein are applicable to other architectures other than a windowed or client-server architecture. Also, the methods and systems discussed herein are applicable to differing protocols, communication media (optical, wireless, cable, etc.) and devices (such as wireless handsets, electronic organizers, personal digital assistants, tablets, portable email machines, game machines, televisions, settop boxes, pagers, navigation devices such as GPS receivers, etc.).

1. A method in a computing system for analyzing browsing futures associated with gestured-based input, the method comprising:
receiving, from an input device capable of providing gesture input, an indication of a user inputted gesture that corresponds to an indicated portion of electronic content presented via a presentation device associated with the computing system, the indicated portion of electronic content identifying an entity and/or action;
determining a next content to be examined by the user based upon the entity and/or action identified by the user inputted gesture and/or a set of factors;
distributing information regarding the determined next content to one or more sponsors of auxiliary content; and
receiving auxiliary content from at least one of the one or more sponsors that is presented via the presentation device upon detecting that the next content to be examined has been or is about to be navigated to by the user.

2. The method of claim 1, wherein the determining a next content to be examined by the user based upon the entity and/or action identified by the user inputted gesture and/or a set of factors further comprises:
determining a next content by at least one of predicting based upon historical data, by looking up information, and/or based upon a statistical model.

3. The method of claim 2, wherein the determining a next content to be examined by the user based upon the entity and/or action identified by the user inputted gesture and/or a set of factors further comprises:
determining a next content by predicting based upon historical data that includes at least one of user data, navigation data, data from other users similarly situated, related entity data, and/or values of the one or more of the set of factors.

4. The method of claim 2, wherein the determining a next content to be examined by the user based upon the entity and/or action identified by the user inputted gesture and/or a set of factors further comprises:
determining a next content by looking up information including at least one of user data, navigation data, data from other users similarly situated, related entity data, and/or values of the one or more of the set of factors.

5. The method of claim 2, wherein the determining a next content to be examined by the user based upon the entity and/or action identified by the user inputted gesture and/or a set of factors further comprises:
determining a next content by using a statistical model that indicates a likelihood of at least one of where the user is likely to navigate to, a next entity to explore based upon the identified identity, and/or a next action to perform based upon the identified action.

6. The method of claim 5, wherein the determining a next content by using a statistical model that indicates a likelihood of at least one of where the user is likely to navigate to, a next entity to explore based upon the identified identity, and/or a next action to perform based upon the identified action further comprises:
determining a next content using a predictive statistical model that includes at least one of a decision tree, neural network, or Bayesian network.

7. The method of claim 1, wherein the determining a next content to be examined by the user based upon the entity and/or action identified by the user inputted gesture and/or a set of factors further comprises:
determining a next content by examination of navigation history of the user and comparing the navigation history of the user with the navigation history of other users to determine one or more likely next locations the user will navigate to.

8. The method of claim 7, wherein the determining a next content by examination of navigation history of the user and comparing the navigation history of the user with the navigation history of other users to determine one or more likely next locations the user will navigate to further comprises:
ranking the determined one or more likely next locations the user will navigate to in order to determine a next content.

9. The method of claim 1, wherein the determining a next content to be examined by the user based upon the entity and/or action identified by the user inputted gesture and/or a set of factors further comprises:
determining before receiving an indication of a subsequent gestured input by the user indicating a next content to be examined.

10. The method of claim 1, wherein the determining a next content to be examined by the user based upon the entity and/or action identified by the user inputted gesture and/or a set of factors further comprises:
determining a next content to be examined in near real-time.

11. The method of claim 10, wherein the distributing information regarding the determined next content to one or more sponsors of auxiliary content further comprises:
offering the distributed information about the next content to be examined for sale or for bid.

12. The method of claim 11, wherein the receiving auxiliary content from at least one of the one or more sponsors that is presented via the presentation device upon detecting that the next content to be examined has been or is about to be navigated to by the user further comprises:
receiving an indication of a sale or bid from a selected one of the one or more sponsors;
determining auxiliary content associated with the indicated sale or bid; and
presenting the received auxiliary content associated with the sale or bid before the next content is about to be navigated to by the user.

13. The method of claim 12, wherein the determining auxiliary content associated with the indicated sale or bid further comprises:
determining auxiliary content from a stored repository of auxiliary content received prior to the receiving the indication of the sale or bid.

14. The method of claim 12, wherein the presenting the received auxiliary content associated with the sale or bid before the next content is about to be navigated to by the user further comprises:
causing content associated with an opportunity for commercialization to be presented to the user as a just-in-time opportunity for commercialization that is presented nearly simultaneously with the gestured input.

15. The method of claim 12, wherein the presenting the received auxiliary content associated with the sale or bid before the next content is about to be navigated to by the user further comprises:
causing an advertisement to be presented to the user as a just-in-time advertisement that is presented nearly simultaneously with the gestured input.

16. The method of claim 12, wherein the presenting the received auxiliary content associated with the sale or bid before the next content is about to be navigated to by the user further comprises:
causing the received auxiliary content to be presented before an action occurs in a live event.

17. The method of claim 16, wherein the causing the received auxiliary content to be presented before an action occurs in a live event further comprises:
causing the received auxiliary content to be presented right before an action in a sports event, a competition, a game, a pre-recorded live event, and/or a simultaneous transmission of a live event.

18. The method of claim 1, wherein the determining a next content to be examined by the user based upon the entity and/or action identified by the user inputted gesture and/or a set of factors further comprises:
determining a next content based upon a set of factors including at least one of similar gestured input history of one or more other users, context of other text, graphics, and/or objects within the corresponding presented content, an attribute of the gesture, presentation device capabilities, prior history associated with the user.

19.-39. (canceled)

40. The method of claim 1, wherein the distributing information regarding the determined next content to one or more sponsors of auxiliary content further comprises:
associating a confidence factor with the distributed information.

41. The method of claim 1, wherein the distributing information regarding the determined next content to one or more sponsors of auxiliary content further comprises:
distributing information that is one or more of a link, a resource descriptor, a URI, a description of the content or type of content, information regarding the user, an organization, or an event, information associated with a web site or browser.

42. The method of claim 1, wherein the distributing information regarding the determined next content to one or more sponsors of auxiliary content further comprises:
distributing the information in exchange for compensation.

43. The method of claim 42, wherein the distributing the information in exchange for compensation further comprises:
distributing the information in exchange for compensation that comprises at least one of money, services, and/or barter.

44. The method of claim 1, further comprising: charging based upon a likelihood that the determined next content to be examined will be examined by the user.

45. The method of claim 1, wherein the distributing information regarding the determined next content to one or more sponsors of auxiliary content further comprises:
offering the distributed information about the next content to be examined for sale or for bid.

46. The method of claim 1, wherein the distributing information regarding the determined next content to one or more sponsors of auxiliary content further comprises:
distributing information to an entity that provides the auxiliary content.

47. The method of claim 1, wherein the distributing information regarding the determined next content to one or more sponsors of auxiliary content further comprises:
distributing information to a sponsor representing an entity that provides the auxiliary content.

48. The method of claim 1, wherein the distributing information regarding the determined next content to one or more sponsors of auxiliary content further comprises:
distributing information to a sponsor that receives auxiliary content from a third party.

49. The method of claim 48, wherein the distributing information to a sponsor that receives auxiliary content from a third party further comprises:
receiving from the third party one or more of advertising content, a game, interactive entertainment, a computer-assisted competition, a bidding opportunity, a documentary, help text, an indication of price, textual content, an image, a video, and/or auditory content.

50. The method of claim 1, wherein the distributing information regarding the determined next content to one or more sponsors of auxiliary content further comprises:
distributing information to a sponsor that receives auxiliary content from a third party via a programming interface for accessing context specific content.

51. The method of claim 50, wherein the distributing information to a sponsor that receives auxiliary content from a third party via a programming interface for accessing context specific further comprises:
distributing information to a sponsor that receives context specific content from a third party based at least in part on values of one or more of the set of factors.

52. The method of claim 50, wherein the distributing information to a sponsor that receives auxiliary content from a third party via a programming interface for accessing context specific further comprises:
distributing information to a sponsor that receives auxiliary content from at least one of an advertising server, an advertising system, a dictionary, an encyclopedia, and/or a translation tool.

53. The method of claim 1, wherein the distributing information regarding the determined next content to one or more sponsors of auxiliary content further comprises:
distributing information to one or more entities that are separate from an entity that provides the presented electronic content in order to present competing auxiliary content.

54. The method of claim 1, wherein the distributing information regarding the determined next content to one or more sponsors of auxiliary content further comprises:
distributing information to one or more sponsors that are competitors.

55.-56. (canceled)

57. The method of claim 1, wherein the distributing information regarding the determined next content to one or more sponsors of auxiliary content further comprises:
distributing information to a sponsor that is an entity separate from an entity that provided the presented electronic content.

58. The method of claim 1, wherein the receiving auxiliary content from at least one of the one or more sponsors that is presented via the presentation device upon detecting that the next content to be examined has been or is about to be navigated to by the user further comprises:
receiving an indication of at least one of an advertisement, interactive entertainment, a role-playing game, a computer-assisted competition, a bidding opportunity, an indication of a purchase, and/or an indication of an offer as the auxiliary content.

59.-66. (canceled)

67. The method of claim 1, wherein the receiving auxiliary content from at least one of the one or more sponsors that is presented via the presentation device upon detecting that the next content to be examined has been or is about to be navigated to by the user further comprises:
causing the received auxiliary content to be presented as a visual overlay on a portion of the presented electronic content or in at least one of an auxiliary window, pane, frame, and/or other auxiliary presentation construct.

68.-80. (canceled)

81. The method of claim 1, wherein the receiving auxiliary content from at least one of the one or more sponsors that is presented via the presentation device upon detecting that the next content to be examined has been or is about to be navigated to by the user further comprises:
causing the received auxiliary content to be presented based upon a social network associated with the user.

82. The method of claim 1, wherein the receiving auxiliary content from at least one of the one or more sponsors that is presented via the presentation device upon detecting that the next content to be examined has been or is about to be navigated to by the user further comprises:
receiving auxiliary content by receiving at least one of a location, a pointer, a symbol, a word, a phrase, an utterance, an image, a video, a pattern, an audio signal, and/or another type of reference to auxiliary content.

83. (canceled)

84. The method of claim 1, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises:
receiving an indication of a user inputted gesture that identifies an entity and/or action that is a product and/or service, is a request from a not-for-profit organization, or that is a person, place, or thing.

85.-86. (canceled)

87. The method of claim 1, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises:
receiving an indication of a user inputted gesture that corresponds to an indicated portion of the electronic content that contains text an image, or audio for identifying the entity and/or action.

88.-89. (canceled)

90. The method of claim 1, wherein the receiving auxiliary content from at least one of the one or more sponsors that is presented via the presentation device upon detecting that the next content to be examined has been or is about to be navigated to by the user further comprises:
presenting the auxiliary content as at least one of a portion of the next content, a portion of a web site, as part of an electronic document, an image, text, and/or an utterance.

91.-93. (canceled)

94. The method of claim 1, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises:
receiving a user inputted gesture that approximates a at least one of a circle shape, an oval shape, a closed path, and/or a polygon.

95.-97. (canceled)

98. The method of claim 1, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises:
receiving an audio gesture.

99.-101. (canceled)

102. The method of claim 1, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises:
receiving the indication of the user inputted gestured from an input device that comprises at least one of a mouse, a touch sensitive display, a wireless device, a human body part, a microphone, a stylus, and/or a pointer.

103. (canceled)

104. The method of claim 1, wherein the receiving, from an input device capable of providing gesture input, an indication of a user inputted gesture that corresponds to an indicated portion of electronic content presented via a presentation device associated with the computing system, the indicated portion of electronic content identifying an entity and/or action further comprises:
receiving a user inputted gesture that corresponds to an indicated portion of electronic content presented via at least one of a browser, speaker, electronic reader, Braille printer, mobile device, a hand-held device, a device embedded as part of the computing system, and/or a remote device associated with the computing system and/or presented via a presentation device associated with at least one of a computer, notebook, tablet, wireless device, cellular phone, mobile device, hand-held device, electronic control panel, electronic display, electronic appliance, and/or wired device.

105. (canceled)

106. (canceled)

107. The method of claim 1, further comprising: performing the method by a client or by a server.

108.-324. (canceled)
